(19) United States
(12) Patent Application Publication
(10) Pub. No.: US 2024/0261607 A1
(43) Pub. Date: Aug. 8, 2024

(54) OVERLAND CONDUIT SYSTEM AND METHODS WITH APPLICATIONS IN WILDFIRE MITIGATION

(71) Applicant: WILDFIRE ROBOTICS INC., Calgary (CA)

(72) Inventor: Allan Stewart RICHARDSON, The Woodlands, TX (US)

(21) Appl. No.: 18/565,497

(22) PCT Filed: Jun. 1, 2022
(86) PCT No.: PCT/CA2022/050874

§ 371 Date: Nov. 29, 2023

Related U.S. Application Data
(60) Provisional application No. 63/195,549, filed on Jun. 1, 2021.

(51) Int. Cl. A62C 3/02; A62C 33/04; F16L 1/024; F16L 1/10

(52) U.S. Cl. CPC A62C 3/0264; F16L 1/0243; F16L 1/10; A62C 33/04

(57) ABSTRACT

Methods and apparatus for extending lines for carrying fluids or signals are provided. The lines may be used to deliver fluids, signals and/or power. A wide range of applications include fighting wildfires, fire prevention, providing telecommunications and providing power. The apparatus for deploying a line can include an elongated carried part and a plurality of ground contacting parts that are coupled to and movable relative to the carried part. A plurality of actuators distributed along a length of the carried part are operable to move the ground contacting parts relative to one another and/or move the carried part relative to the ground contacting parts. The actuators are distributed over a length of the carried part. The ground contacting parts may, for example be arranged end to end or arranged in a parallel side-by side relationship.

### CROSS-REFERENCE TO RELATED APPLICATIONS

This application claims priority from U.S. application No. 63/195,549 filed 1 Jun. 2021 and entitled OVERLAND CONDUIT SYSTEM AND METHODS WITH APPLICATIONS IN WILDFIRE MITIGATION which is hereby incorporated herein by reference for all purposes. For purposes of the United States of America, this application claims the benefit under 35 U.S.C. § 119 of U.S. application No. 63/195,549 filed 1 Jun. 2021 and entitled OVERLAND CONDUIT SYSTEM AND METHODS WITH APPLICATIONS IN WILDFIRE MITIGATION which is hereby incorporated herein by reference for all purposes.

### FIELD

This invention relates to methods and apparatus for extending long structures from a starting location. The invention has example application to deploying conduits or cables or other services over the ground, in trenches or tunnels or under water. The conduits may, for example, be useful for delivering fluids and/or communications signals and/or electrical power. An example application of the apparatus is fire mitigation, for example by creating fire breaks, fire escape corridors and/or de-energizing fires.

### BACKGROUND

There are various applications for which it would be beneficial to have a way to deploy an elongated structure such as a conduit or cable. These applications include overland or underwater cable-laying, deploying pipes overland or into trenches, deploying hoses for firefighting as well as many others.

Wildfires pose significant risks to people, wild animals, communities and buildings in many parts of the world. Approaches for controlling wildfires include creating fire breaks, usually by using heavy equipment to remove flammable material from a corridor. Creating a firebreak can be time consuming. In some places the terrain makes it impractical to create a firebreak. These traditional methods involve substantial risks to personnel.

The occurrence of severe wild fires that affect populated areas is increasing.

There is a need for practical and effective ways to create firebreaks.

### SUMMARY

The present technology has a large variety of applications in diverse fields including forestry, agriculture, military, infrastructure maintenance, and others. Applications include, without limitation:
fire mitigation and firefighting especially fighting wildfires;
creating fire breaks;
deploying permanent or temporary utilities (e.g. electrical power cables, water lines, fuel lines) overland or in trenches;
deploying underwater cables;
delivering fertilizer to forests or agricultural crops;
providing presence in hazardous areas (hostage situations, accident sites, damaged buildings, etc.) and inspecting hazardous locations;
deploying sensor systems (e.g. to detect animals, trespassers, fires, environmental conditions);
deploying permanent or temporary transportation corridors (e.g. rails, roadways, etc), providing trackways for transporting people, goods or materials into or out of an area;
delivering power, communication, water, fuel, signals into an area;
sensing conditions in an area;
surveillance of an area, detecting personnel, vehicles, animals or the like in an area;
deploying antennas, sensor arrays and the like;
detecting seismic signals (e.g. in seismic exploration);
monitoring sewer or other piping networks;
deploying weapons systems;
applying fertilizers or pesticides or the like, especially in hard to access areas;
running cables through confined spaces;
laying pipe, cables, conduits or the like, in trenches or underwater;
etc.

The present technology facilitates deployment of long slender lines from a starting location. Such lines may be extended into areas into which it is dangerous, difficult, undesirable or impossible for humans to go.

Apparatus according to some embodiments provides lines that are operable to deploy along sinuous paths. Such apparatus may be constructed in a such a way that the line tends to follow a path once that path has been established. According to some aspects of the technology a line includes one or more longitudinally extending flexible members and plural ground contacting parts that are movable longitudinally to advance (or retract the line along the path). Such lines may be controlled so that the ground contacting parts are moved at different times such that as one ground contacting part is being moved, one or more other ones of the ground contacting parts are static. The static ground contacting parts hold at least one of the flexible members to follow the path. Those flexible members serve as a guide for the ground contacting parts that are being moved. In some embodiments the line is extended from a base and the base has functionality (e.g. one or more grippers) that hold proximal ends of those of the one or more flexible member(s) that are currently serving as a guide in place, thus stabilizing the path of the line from the base toward the distal end of the line.

In some embodiments a conduit or other carried part may serve as the one or more flexible members and may serve as a guide as different sets of one or more ground contacting portions are moved longitudinally along the line. In some embodiments the one or more flexible members are provided by plural ground contacting portions. For example the line may include two laterally spaced apart ground contacting portions or runners that are moved in alternation. The one of the runners that is not being moved relative to the ground may serve as a guide for other parts of the line (including the other runner that is being moved). Each of the runners may serve as a static guide and as the runner that is being moved along the path in alternation.

Some further non-limiting aspects of the invention may be summarized as follows. Other aspects of the invention will be apparent upon reviewing the drawings and reading the following detailed description.

One example aspect of the invention provides a system for creating a firebreak along a desired path. The system comprises: a conduit having a plurality of nozzles longitudinally spaced apart between a free distal end and an opposing proximal end of the conduit, the nozzles in fluid communication with an carried part of the conduit; a base supporting a propulsion unit, the propulsion unit operable to push the conduit away from the base in a direction longitudinal to the conduit and along the desired path; and a pump operable to deliver a fluid through the carried part to the nozzles. A steering device may be coupled to the free end of the conduit and controllable from the base to steer the free end of the conduit in a desired direction and/or to follow a desired path.

Another example aspect of the invention provides apparatus for delivering a fluid into an area. The apparatus comprises an elongated conduit, a base comprising a propulsion unit operative to push a part of the conduit away from the base in a direction longitudinal to the conduit; and a steering unit at a distal end of the elongated conduit, the steering unit operative to steer the distal end of the conduit to follow a desired path as the conduit is advanced.

In some embodiments a segmented part which, in some embodiments comprises a casing that surrounds at least a portion of the conduit extends from the base. The casing may be configured to define a passage that extends longitudinally along the casing such that the conduit is slidable longitudinally along the passage. In some embodiments the casing comprises a plurality of elements coupled together end to end by couplings. The couplings may be configured to allow flex of the casing at the couplings.

Another example aspect of the invention provides an elongated system for fluid spray distribution along a desired path extending from a first location. The system comprises a plurality of propulsion units distributed along a length of the system, each of the propulsion units operable to longitudinally advance or retract a respective portion of the system along the desired path, a conduit supported by the propulsion units, the conduit including a plurality of ports distributed along at least a portion of the length of the conduit, and a plurality of nozzles, each nozzle of the plurality of nozzles in communication with one of the plurality of ports and aimed to direct a spray of fluid in a direction extending radially from the conduit; and a pressurized fluid supply located at the first location and in fluid communication with the conduit. The conduit may include a plurality of valves each operable to open or close respective ones of the plurality of ports.

In a further example aspect, the system includes one or more rotary actuators operable to rotate the conduit about a longitudinal axis. In another further example aspect, the system includes one or more longitudinal actuators operable to move the conduit relative to the propulsion units. In another further example aspect, the conduit is supplied on a reel at the first location, the reel operable to extend the conduit as the system advances along the desired path. In another further example aspect, the system includes a launcher located at the first location, the launcher operable to couple additional propulsion units to a proximal end of the system as a distal end of the system advances along the desired path. The conduit may include a plurality of conduit segments and the launcher is operable to couple additional conduit segments to a proximal end of the conduit as the system advances along the desired path.

In another further example aspect, the plurality of propulsion units each include a first and second ground contacting portion and a remote actuator coupled between the first and second ground contacting portion operable to move either the first or second ground contacting portion while the second or first ground contacting portion remains stationary. The first and second ground contacting portions may be longitudinally spaced apart end-to-end and the remote actuator may be coupled between adjacent ends of the first and second ground contacting portions. The remote actuator may be operable to extend or retract the first ground contacting portion relative to the second ground contacting portion or vice versa. The first and second ground members may each include a plurality of ground contacting segments coupled together longitudinally end-to-end. The system may include a launcher located at the starting location, the launcher operable to couple additional ground contacting segments onto the first and second ground contacting portions as the system advances along the desired path. The ground contacting segments may each include an interior bore through which the conduit passes. Alternatively, the ground contacting segments may each include a channel for supporting the conduit.

Another aspect of the invention provides a fire mitigation system deployable from a starting location to extend along a path, the system comprising: a slender line comprising at least one fluid conduit, the line elongated in a longitudinal direction and slender in a transverse direction, a plurality of nozzles spaced apart along the fluid conduit; a plurality of driver units distributed along a length of the line, each of the driver units operable to move a respective portion of the line relative to the ground in a direction that is substantially along the path; and controls operable to control the driver units to move the line along the path.

In some embodiments, the line includes a steering unit operable to flex a respective local portion of the line laterally and/or in an up and down direction.

In some embodiments, the steering unit is one of a plurality of steering units that are distributed at different positions along the line, each of the plurality of steering units being operable to flex a respective local portion of the line laterally and/or in an up and down direction.

In some embodiments, one of the plurality of steering units is a lead steer unit disposed on an end of the line distal to the starting location, the lead steer unit operable to direct the distal end of the line along the path as the driver units advance the line.

In some embodiments, the lead steer unit includes at least one camera and the system includes a display at a location remote from the lead steer unit and operable to display images acquired by the camera.

In some embodiments, the line includes at the distal end a bent leader and the lead steer unit includes a remote actuator operable to rotate the bent leader about a longitudinal axis.

In some embodiments, the bent leader is disposed on the fluid conduit and the remote actuator is operable to rotate at least a distal portion of the fluid conduit about the longitudinal axis.

In some embodiments, the line includes at least one flexible member that extends longitudinally and follows the path as the line is deployed; the line comprises a plurality of ground contacting portions, each of the ground contacting portions being coupled to move longitudinally along a corresponding one of the at least one flexible-non-extensible member; each of the driver units comprises at least one actuator operable to move a corresponding one of the ground contacting portions longitudinally along the line relative to at least one other one of the ground contacting portions.

In some embodiments, the at least one flexible member is provided by the conduit.

In some embodiments, the at least one flexible member is provided by one of the ground contacting portions.

In some embodiments, the driver units and ground contacting portions are arranged so that the driver units are operable to: hold one or more of the ground contacting portions stationary relative to the ground and one of the at least one flexible member, thereby resisting deviation from the path by the one of the at least one flexible member; and move one or more other ones of the ground contacting portions longitudinally along the line, wherein the one or more other ones of the ground contacting portions are guided to follow the path by the one of the at least one flexible member.

In some embodiments, the controls are configured to operate the driver units in a sequence, the sequence including steps of: operating the driver units to hold a first set of one or more of the ground contacting portions stationary relative to the ground and to hold the conduit stationary relative to the first set of ground contacting portions while moving a second set of one or more of the ground contacting portions along the line guided by the conduit.

In some embodiments, the system comprises a base positionable at the starting location from which the line is extendable, the base comprising at least one gripper operable to selectively hold one or more of the fluid conduit and at least one of the ground contacting portions against axial movement.

In some embodiments, the base includes a launcher operable to advance or retract the proximal end of the line along the path.

In some embodiments, the launcher is operable to selectively hold one or more of the ground contacting portions of the line against axial movement.

In some embodiments, the launcher comprises a conveyor configured to engage the ground contacting portions as the line is extended or retracted.

In some embodiments, the plurality of ground contacting portions are arranged in a parallel side-by-side relationship along the line, each ground contacting portion movable longitudinally relative to a respective laterally adjacent ground contacting portion.

In some embodiments, each ground contacting portion serves as the corresponding at least one flexible member for the laterally adjacent ground contacting portion.

In some embodiments, the driver units are operable to, in alternation: move a first one of the laterally adjacent ground contacting portions in an axial direction while holding a second one of the laterally adjacent ground contacting portions stationary; and move the second one of the laterally adjacent ground contacting portions in the axial direction while holding the first one of the laterally adjacent ground contacting portions stationary.

In some embodiments, the system comprises a base positionable at the starting location from which the line is extendable, the base comprising a holding mechanism operable to selectively hold a first one of the parallel side-by-side ground contacting portions against axial movement or to hold a second one of the parallel side-by-side ground contacting portions that is laterally adjacent to the first one of the parallel side-by-side ground contacting portions against axial movement.

In some embodiments, the base includes a launcher operable to advance or retract the proximal end of the line along the path.

In some embodiments, the launcher comprises a first conveyor configured to engage the first one of the parallel side-by-side ground contacting portions and a second conveyor configured to engage the second one of the parallel side-by-side ground contacting portions as the line is extended or retracted.

In some embodiments, the system is configured to operate the holding mechanism to hold the first one of the parallel side-by-side ground contacting portions against axial movement while the driver units are moving the second one of the parallel side-by-side ground contacting portions and to operate the holding mechanism to hold the second one of the parallel side-by-side ground contacting portions against axial movement while the driver units are moving the first one of the parallel side-by-side ground contacting portions.

In some embodiments, each of the ground contacting portions is supplied from a reel at the starting location.

In some embodiments, each driver unit includes a remote actuator operable to longitudinally move at least one of the ground contacting portions relative to the other.

In some embodiments, the fluid conduit is provided by at least one of the ground contacting portions.

In some embodiments, the line comprises a plurality of first cross members fixedly coupled to the first ground contacting portion and slidingly coupled to the second ground contacting portion, and a plurality of second cross members fixedly coupled to the second ground contacting portion and slidingly coupled to the first ground contacting portion.

In some embodiments, for each of the driver units the remote actuator is coupled between one of the first cross members and one of the second cross members.

In some embodiments, the system includes one or more third cross members wherein the one or more third cross members are each movable along the line relative to each of the one of the first cross members and the one of the second cross members.

In some embodiments, the one or more third cross members are slidingly coupled to each of the first and second ground contacting portions.

In some embodiments, for each of the driver units the remote actuator comprises at least one of the third cross members located between the one of the first cross members and the one of the second cross members and the at least one of the third cross members serves to connect two or more actuators that operate directly or indirectly to apply forces between the one of the first cross members and the one of the second cross members.

In some embodiments, for each of the driver units the remote actuator comprises at least two of the third cross members located between the one of the first cross members and the one of the second cross members to provide one or more pairs of adjacent third cross members between the one of the first cross members and the one of the second cross members; and a plurality of linear actuators, the plurality of linear actuators including: at least one linear actuator coupled between the one first cross member and one of the third cross members, at least one linear actuator coupled between the one second cross member and the one of the third cross members, and at least one linear actuator coupled between each of the one or more pairs of the third cross members.

In some embodiments, for each of the driver units, a plurality of remote actuator units are pivotally connected longitudinally in series and are coupled between one of the first cross members and one of the second cross members and wherein the pivotal connections between the plurality of remote actuator units are slidingly guided relative to the line.

In some embodiments, the driver units are operable to move the ground contacting portions after the system has deployed along a path portion having a net arc angle of at least 270 degrees.

In some embodiments, the controls comprise manual controls.

In some embodiments, the manual controls are located at the starting location.

In some embodiments, the controls comprise an automatic controller.

In some embodiments, the automatic controller is configured to operate the driver units in a sequence comprising a series of steps, wherein, in each of the steps one or more ground contacting portions is moved longitudinally relative to the ground by one or more of the driver units while one or more others of the ground contacting portions is held stationary relative to the ground.

In some embodiments, the automatic controller is configured to oscillate all or a portion of a conduit through a selected angular range.

In some embodiments, the automatic controller is configured to reciprocate the fluid conduit axially through a desired range of motion.

In some embodiments, the system comprises image acquisition and

processing components that are configured to detect obstacles in the way of the line and the automatic controller is configured to automatically control advance of the line to select a path that avoids the obstacles.

In some embodiments, the automatic controller is configured to calculate a net curvature of all or a portion of the line and to limit the stroke of actuators of the driver units based on the calculated net curvature.

In some embodiments, the automatic controller is configured to control movement of the fluid conduit and/or the line to move the nozzles axially and/or with rotational movements while controlling valves to release fluid from selected ones of the nozzles.

In some embodiments, the system comprises a wireless data communication link connected to carry control signals from the controls to the line.

In some embodiments, the line comprises a plurality of ground contacting portions and each driver unit includes a remote actuator coupled between longitudinally adjacent ones of the ground contacting portions, the remote actuator operable to move the adjacent ones of the ground contacting portions toward or away from one another.

In some embodiments, the controls include an automated controller configured to move an individual ground contacting portion relative to first and second adjacent stationary ground contacting portions by extending a first remote actuator unit coupled between the individual ground contacting portion and the first adjacent stationary ground contacting portion while simultaneously retracting a second remote actuator unit coupled between the individual ground contacting portion and the second adjacent stationary ground contacting portion.

In some embodiments, each of the ground contacting portions is configured to surround at least a portion of the conduit, the ground contacting portion defining a passage that extends longitudinally along the ground contacting portion and extends at least partially circumferentially around the conduit wherein the conduit is movable longitudinally along the passage.

In some embodiments, each of the ground contacting portions comprises a plurality of elements coupled together end to end by couplings.

In some embodiments, the couplings are configured to allow flex of the ground contacting portion at the couplings.

In some embodiments, each of the elements comprises plural elongated segments arranged to open as a clamshell and close around the conduit.

In some embodiments, the elongated segments comprise latch mechanisms operable to lock the elongated segments around the conduit.

In some embodiments, wherein the fluid conduit is supplied from a reel at the starting location.

In some embodiments, the system comprises a base positionable at the starting location from which the line is extendable, the base comprising at least one gripper operable to selectively hold one or more of the fluid conduit and at least one against axial movement.

In some embodiments, the base includes a launcher operable to advance or retract the proximal end of the line along the path.

In some embodiments, the launcher is operable to selectively hold ground one or more ground contacting portions of the line against axial movement.

In some embodiments, the launcher is operable to guide additional ground contacting portions onto the line as the line is advanced along the path.

In some embodiments, the launcher comprises a conveyor configured to carry a ground contacting portion on a trajectory that brings the ground contacting portion into engagement with the fluid conduit as the fluid conduit is advanced.

In some embodiments, the system comprises a plurality of backstop mechanisms spaced apart along the line wherein the backstop mechanisms are each operable to resist motion of an associated ground contacting portion in a first longitudinal direction and permit movement of the associated ground contacting portion in in a second longitudinal direction opposite to the first longitudinal direction.

In some embodiments, the backstop mechanisms are configurable in a first mode which resists motion of an associated ground contacting portion in a reverse direction and permits free movement of the associated ground contacting portion in a forward direction and a second mode which resists motion of the associated ground contacting portion in the forward direction and permits free movement of the associated ground contacting portion in the reverse direction.

In some embodiments, the backstop mechanisms each comprise a first pivotable dog operable to engage with the ground to resist motion in a reverse longitudinal direction.

In some embodiments, the backstop mechanisms each includes a second pivotable dog operable to engage with the ground to resist motion in a forward longitudinal direction.

In some embodiments, each of the backstop mechanisms is configurable in a mode where the backstop mechanism does not resist motion of the associated ground contacting portion in either of the first longitudinal direction and the second longitudinal direction.

In some embodiments, the line includes one or more pipe propulsion units distributed along the length of the line and operable to move the fluid conduit longitudinally relative to the line.

In some embodiments, each of the one or more pipe propulsion units includes a gripper operable to selectively grip or release the fluid conduit and a linear actuator operable to move the gripper in the longitudinal direction.

In some embodiments, the gripper comprises a pipe clamp.

In some embodiments, the gripper includes a plurality of inflatable bladders disposed around the fluid conduit.

In some embodiments, the linear actuators of the pipe propulsion units comprise pneumatic or hydraulic cylinders.

In some embodiments, the line includes one or more pipe torsion units distributed along the length of the line and operable to rotate the fluid conduit about a longitudinal axis of the fluid conduit.

In some embodiments, at least one of the one or more pipe torsion units includes a worm gear coupled to the fluid conduit and a worm meshing with the worm gear and operable to rotate the worm gear.

In some embodiments, at least one of the one or more pipe torsion units includes a carrier coupled to the fluid conduit, a helical track disposed on or in the carrier, and a linearly actuated traveler engaged with the track, wherein linear movement of the traveler causes the carrier to rotate.

In some embodiments, the fluid conduit comprising a plurality of valves, each of the valves operable to block or allow flow of a fluid to a respective one or more of the plurality of spaced apart nozzles.

In some embodiments, the controls are operable to control the valves to vary which ones of the nozzles allow flow of the fluid at any given time.

In some embodiments, the controls comprise an automated controller configured to control the valves to deliver fluid to each of plural groups of the nozzles intermittently.

In some embodiments, the system comprises one or more pressure sensors connected to measure a fluid pressure within the conduit wherein the automated controller is configured to control the valves based in part on feedback from the one or more pressure sensors to deliver a desired volume of fluid at a desired pressure by one or more of the nozzles.

In some embodiments, the fluid conduit has a working pressure rating of at least 1000 psi.

In some embodiments, the fluid conduit has a working pressure rating of at least 2000 psi.

In some embodiments, the line is navigable along a path having a minimum radius of curvature of 12 metres with no more than a 20% reduction in working pressure.

In some embodiments, the line is navigable along a path having a minimum radius of curvature of 6 metres with no more than a 20% reduction in working pressure.

In some embodiments, the system includes a pressurized fluid supply in fluid communication with the fluid conduit at the starting location.

In some embodiments, the pressurized fluid supply includes one or more pumps connected to draw fluid from a fluid source and to deliver the fluid into the conduit.

In some embodiments, the pump has an output pressure of at least 1000 psi.

In some embodiments, the pump has an output pressure of at least 2000 psi.

In some embodiments, the line is a first line and the fluid conduit is a first fluid conduit and wherein the system includes a second line deployable from the starting location to the fluid reservoir and wherein a second fluid conduit associated with the second line is connected to supply the fluid from the fluid reservoir to the pump.

In some embodiments, the fluid reservoir is a body of water.

In some embodiments, the line includes a plurality of fire detection sensor units distributed along the line, each fire detection sensor unit comprising one or more of a camera, an infrared camera, and a thermal sensor.

In some embodiments, said plurality of fire detection units communicates with the automatic controller.

In some embodiments, a monitor associated with the controls displays data from the plurality of fire detection sensor units.

In some embodiments, the line is deployable along the path at an average rate of at least 200 meters per hour.

In some embodiments, the line is deployable along the path at an average rate of at least 1 kilometers per hour.

Another aspect of the invention provides a fire mitigation method comprising: from a starting location deploying an elongated slender line comprising a fluid conduit along a path that extends away from the starting location using plural remotely controlled driver units distributed along a length of the line; with the line deployed, supplying a pressurized fluid into the fluid conduit and expelling the pressurized fluid through nozzles spaced apart along at least a portion of the fluid conduit to provide sprays of pressurized fluid directed radially away from the fluid conduit.

In some embodiments, the path is a winding path and deploying the line comprises curving the line to follow the winding path.

In some embodiments, deploying the line comprises steering a distal end portion of the line to establish the path and causing the rest of the line to substantially follow the path taken by the distal end portion of the line.

In some embodiments, the fluid conduit is deployed along the path for a length of at least 1000 m.

In some embodiments, the line includes at least one flexible [non-extensible] member that extends longitudinally and follows the path as the line is deployed and a plurality of ground contacting portions, each of the ground contacting portions being coupled to move longitudinally along a corresponding one of the at least one flexible-non-extensible member, and the method includes: moving the ground contacting portions in a sequence such that at each step in the sequence one or more of the ground contacting portions is stationary relative to the ground and one of the at least one flexible member, thereby constraining the one of the at least one flexible member against deviation from the path while moving another one or more of the ground contacting portions longitudinally along the line guided to follow the path by the one of the at least one flexible member.

In some embodiments, the at least one flexible member is provided by the fluid conduit.

In some embodiments, the at least one flexible member is provided by one of the ground contacting portions.

In some embodiments, deploying the line comprises a sequence that comprises the steps of: operating a plurality of driver units to hold a first set of one or more ground contacting portions stationary relative to the ground and to hold the at least one flexible stationary relative to the first set of ground contacting portions while moving a second set of one or more of the ground contacting portions along the line guided by the at least one flexible member.

In some embodiments, the plurality of ground contacting portions are arranged in a parallel side-by-side relationship along the line, and the method includes steps of: in alternation, moving ones of the plurality of ground contacting portions while holding the respective laterally adjacent ground contacting portions stationary.

In some embodiments, the method includes applying an equal motive force to laterally adjacent ground contacting portions between stationary points on the line.

In some embodiments, deploying the line comprises operating a launcher to advance the line from the starting location.

In some embodiments, deploying the line comprises performing a repeating sequence of steps that includes: coupling a driver unit to the fluid conduit at the launcher; and advancing the fluid conduit further along the path using the driver unit(s) and/or the launcher.

In some embodiments, deploying the line comprises feeding the fluid conduit to a launcher from a coil, and using a conveyor, to carry, in sequence a plurality of the driver units along a trajectory that brings the driver units up to the fluid conduit and coupling the driver units to the fluid conduit.

In some embodiments, each of the driver units comprises a remote actuator coupled between two ground contacting portions and deploying the line comprises steps including synchronously actuating adjacent remote actuators to move respective ground contacting portions while holding other ground contacting portions stationary.

In some embodiments, the series of steps comprises, a step of advancing the conduit relative to the ground contacting portions.

In some embodiments, the line comprises parallel ground contacting portions and deploying the line comprises advancing the ground contacting portions in alternation.

In some embodiments, the method comprises holding the parallel ground contacting portions against backsliding.

In some embodiments, the ground contacting portions comprise tubular members and deploying the line comprises feeding out the tubular members from coils.

In some embodiments, the fluid conduit comprises one of the parallel ground contacting parts.

In some embodiments, the method comprises: after deploying the line, retracting the line while leaving at least a distal portion of the conduit deployed along the path.

In some embodiments, the method comprises selectively blocking flow of the fluid to individual ones of the nozzles and thereby increasing a pressure and flow rate of the fluid at other ones of the nozzles.

In some embodiments, the method comprises with the fluid conduit deployed along the path, rotating all or part of the fluid conduit about a longitudinal axis of the conduit and thereby altering angles of some or all of the nozzles.

In some embodiments, the method comprises performing the rotation of the fluid conduit, while expelling the pressurized fluid from some or all of the nozzles.

In some embodiments, the method comprises with the fluid conduit deployed along the path moving the fluid conduit back and forth longitudinally, thereby moving locations of the nozzles back and forth along the path.

In some embodiments, the method comprises performing the moving of the fluid conduit back and forth in the longitudinal direction while expelling the pressurized fluid from some or all of the nozzles.

In some embodiments, the method includes detecting, by a plurality of imaging and/or thermal sensor units distributed along the line, a position of the fire, and performing one or more of selectively rotating, moving back and forth, and allowing flow to ones of nozzles of the portion of the conduit adjacent to the position of the fire.

In some embodiments, the plurality of thermal sensor units include one or more of a camera, an infrared camera, and a temperature sensor.

In some embodiments, the method comprises a fire burning adjacent to the path and the method includes rotating at least a portion of the fluid conduit adjacent to the fire to discharge the pressurized fluid into air flowing into the fire.

In some embodiments, rotating the fluid conduit comprises orienting the nozzles in the portion of the fluid conduit adjacent to the fire to face toward the fire at an angle of 30 degrees or less from horizontal.

In some embodiments, the pressurized fluid has a pressure of at least 1000 psi when introduced into the fluid conduit.

In some embodiments, the pressurized fluid has a pressure of at least 2000 psi when introduced into the fluid conduit.

In some embodiments, the pressurized fluid includes water.

In some embodiments, the pressurized fluid includes fire retardant.

Another aspect of the invention comprises an apparatus for deploying an elongated carried part from a base, the apparatus comprising: an elongated carried part; a plurality of ground contacting parts; a plurality of first actuators operable to move the carried part relative to the ground contacting parts, the first actuators distributed along a length of the carried part; a plurality of second actuators each operable to move one or more of the plurality of ground contacting parts relative to other ones of the plurality of ground contacting parts, the second actuators distributed along the length of the carried part.

In some embodiments, the plurality of ground contacting parts are arranged end to end.

In some embodiments, the carried part is received in bores and/or channels that extend longitudinally through the plurality of ground contacting parts.

In some embodiments, the ground contacting portions comprise first and second runners arranged in a parallel side-by side relationship.

In some embodiments, the apparatus comprises cross members extending between the first and second runners.

In some embodiments, some of the cross members are longitudinally fixed to the first runner and slidably coupled to the second runner.

In some embodiments, some of the cross members are longitudinally fixed to the second runner and slidably coupled to the first runner.

In some embodiments, the first and second runners each comprise a flexible pipe.

In some embodiments, the apparatus comprises a plurality of backstop mechanisms spaced apart along the apparatus.

In some embodiments, the backstop mechanisms are configurable in a first mode which resists motion of an associated ground contacting portion in a reverse direction and permits free movement of the associated ground contacting portion in a forward direction and a second mode which resists motion of the associated ground contacting portion in the forward direction and permits free movement of the associated ground contacting portion in the reverse direction.

In some embodiments, the carried part comprises a fluid conduit and the apparatus comprises a pump coupled to deliver a fluid through the fluid conduit.

In some embodiments, the apparatus comprises a plurality of nozzles spaced apart along the fluid conduit.

In some embodiments, each of the plurality of nozzles is associated with a corresponding one of a plurality of valves that is operable to turn on or off a flow of fluid from the conduit into the nozzle.

In some embodiments, the first actuators include actuators configured to move the carried part axially relative to the ground contacting portions.

In some embodiments, the first actuators include actuators configured to rotate the carried part.

Another aspect of the invention comprises an apparatus for delivering fluid into an area, the apparatus comprising: an elongated conduit; a base comprising a propulsion unit operative to push a part of the conduit away from the base in a direction longitudinal to the conduit; and a steering unit at a distal end of the elongated conduit, the steering unit operative to steer the distal end of the conduit to follow a desired path as the conduit is advanced.

In some embodiments, the apparatus comprises a casing surrounding at least a portion of the conduit that extends from the base, the casing defining a passage that extends longitudinally along the casing wherein the conduit is slidable longitudinally along the passage.

In some embodiments, the casing comprises a plurality of elements coupled together end to end by couplings.

In some embodiments, the couplings are configured to allow flex of the casing at the couplings.

In some embodiments, a plurality of the casing elements comprise casing segments that each comprises first and second longitudinally extending parts joined together by a latching mechanism wherein the first and second parts jointly define a portion of the passage extending through the casing segment.

In some embodiments, the casing comprises a plurality of casing shift units coupled inline with the casing, each of the casing shift units comprising an actuator operable to move the casing shift unit between a retracted configuration and an extended configuration wherein a distance between the couplings at opposing ends of the casing shift unit is greater in the extended configuration than in the retracted configuration.

In some embodiments, the apparatus comprises a control system configured to coordinate operation of first and second ones of the casing shift units to longitudinally shift a span of the casing extending between the first and second casing shift units by operating the actuator of the first one of the casing shift units to move the first one of the casing shift units toward the extended configuration and simultaneously operating the actuator of the second one of the casing shift units to move the second one of the casing shift units toward the retracted configuration.

In some embodiments, the casing comprises a plurality of pipe propulsion units coupled inline with the casing, each of the pipe propulsion units comprising a gripper operable to selectively grip or ungrip the conduit and an actuator operable to move the gripper longitudinally in a range between ends of the pipe propulsion unit.

In some embodiments, the apparatus comprises a controller configured to coordinate operation of the pipe propulsion units to advance the conduit relative to the casing by operating the grippers to grip the conduit and operating the actuators to move the grippers toward the distal end of the conduit.

In some embodiments, the casing comprises a pipe torsion unit connected inline with the casing, the pipe torsion unit comprising a gripper operable to selectively grip and ungrip the conduit and an actuator connected to drive rotation of the gripper relative to a housing of the pipe torsion unit.

In some embodiments, the steering unit comprises a bent leader projecting axially at the distal end of the conduit and an actuator connected to rotate the bent leader.

In some embodiments, the conduit comprises a plurality of longitudinally spaced apart nozzles.

In some embodiments, the apparatus comprises a pump connected to supply a fluid at a proximal end of the conduit.

In some embodiments, the pump has an output pressure of at least 3000 psi (200 bar).

Another aspect of the invention comprises a system for creating a firebreak along a desired path, the system comprising: a conduit having a plurality of nozzles longitudinally spaced apart between a free end and an opposing proximal end of the conduit, the nozzles in fluid communication with an carried part of the conduit; a base supporting a propulsion unit, the propulsion unit operable to push the conduit away from the base in a direction longitudinal to the conduit and along the desired path; and a pump operable to deliver a fluid through the carried part to the nozzles.

In some embodiments, the system comprises a steering device coupled to the free end of the conduit and controllable from the base to steer the free end of the conduit in a desired direction.

In some embodiments, the system comprises a reel storing a coiled part of the carried part.

In some embodiments, the system comprises a segmented casing installed around an exterior of the carried part.

In some embodiments, the casing comprises plural elongated segments arranged to open as a clamshell and close around the conduit.

In some embodiments, the segments comprise latch mechanisms operable to lock the elongated parts around the conduit.

In some embodiments, the method comprises installing a second segment onto the carried part at the accessible location and advancing the second segment along the carried part towards the free end after the first casing segment has advanced far enough along the carried part to provide space for the second casing segment.

One example aspect of the invention provides apparatus for deploying a line comprising an elongated carried part from a base. The apparatus comprises: the elongated carried part; a plurality of ground contacting parts; a plurality of first actuators operable to move the carried part relative to the ground contacting parts, the first actuators distributed along a length of the carried part; and a plurality of second actuators each operable to move one or more of the plurality of ground contacting parts relative to other ones of the plurality of ground contacting parts, the second actuators distributed along the length of the carried part. In some embodiments the plurality of ground contacting parts are arranged end to end. In some embodiments the ground contacting portions comprise first and second runners arranged in a parallel side-by side relationship.

Another aspect of the invention comprises a method for deploying a conduit along a desired path, the method comprising: providing a base at an accessible location; advancing an carried part of the conduit away from the base; steering a free end of the carried part along the desired path as the carried part is advanced away from the base; gripping the carried part at the base after the carried part has advanced over a desirable length; installing a segment onto the carried part at the accessible location; and advancing the segment along the carried part toward the free end.

Another example aspect of the invention provides a system deployable from a starting location along a desired path. The system comprises an elongated line having a steering unit disposed in a distal end portion of the system distal to the starting location and operable to direct the system along the desired path, one or more first ground contacting portions, one or more second ground contacting portions spaced apart from the first ground contacting portions, one or more first remote actuator units distributed along a length of the line, each of the one or more first remote actuator units coupled between adjacent first and second ground contacting portions and operable to move at least one of the first ground contacting portions along the desired path while at least one of the one or more second ground contacting portions remain stationary, and one or more second remote actuator units distributed along the length of the line, each of the one or more second remote actuator units coupled between adjacent first and second ground contacting portions and operable to move at least one of the second ground contacting portions along the desired path while the one or more first ground contacting portions remain stationary.

Another example aspect of the invention provides a method for providing access to services along a desired path from an accessible location. The method comprises providing a system at the accessible location, the system including an elongated line having a steering unit disposed in a distal end section of the line, one or more first ground contacting portions, one or more second ground contacting portions spaced apart from the first ground contacting portions, one or more first remote actuator units distributed along a length of the system, each of the one or more first remote actuator units coupled between adjacent first and second ground contacting portions; and one or more second remote actuator units distributed along the length of the system, each of the one or more second remote actuator units coupled between adjacent first and second ground contacting portions, operating the steering unit to direct the first end of the system along the desired path while operating the first and second remote actuator units to advance the system along the path by steps including moving at least one of the one or more first ground contacting portions along the desired path while keeping at least one of the one or more second ground contacting portions stationary; and moving at least one second ground contacting portion of the one or more second ground contacting portions along the desired path while keeping at least one first ground contacting portion of the one or more first ground contacting portions stationary, thereby deploying the system along the desired path.

Another example aspect of the invention provides a method for deploying a line comprising an elongated carried part from a base. The method comprises: providing a plurality of actuators each operable to move one or more of the plurality of ground contacting parts relative to other ones of the plurality of ground contacting parts, the actuators distributed along the length of the carried part; operating the actuators in a sequence to advance the ground contacting parts wherein in the sequence some of the ground contacting parts are moved while others of the ground contacting parts are stationary relative to the carried part.

In some embodiments the method comprises providing another plurality of actuators operable to move the carried part relative to a plurality of ground contacting parts that are distributed along a length of the carried part and operating the another plurality of actuators to move the carried part longitudinally relative to the ground contacting parts.

In some embodiments the method comprises causing a distal end of the carried part to follow a desired path, which may include curves. Interaction between the carried part and the ground contacting parts may cause following parts of the carried part to follow the path.

Another example aspect of the invention provides a method for deploying a conduit along a desired path. The method comprises: providing a base at an accessible location; advancing an carried part of the conduit away from the base; steering a free end of the carried part along the desired path as the carried part is advanced away from the base; gripping the carried part at the base after the carried part has advanced over a desirable length; installing a segment onto the carried part at the accessible location; and advancing the segment along the carried part toward the free end.

Another example aspect of the invention provides a system deployable from a starting location to extend along a path. The system comprises a slender line that is elongated in a longitudinal direction and slender in a transverse direction. The line comprises a plurality of ground contacting portions distributed along a length of the line, the plurality of ground contacting parts are arranged in a parallel side-by-side relationship along the line, and a plurality of remote actuators distributed along the length of line, each of the remote actuators operable to move one or more of the ground contacting portions relative to other ones of the ground contacting portions in the longitudinal direction. The system further comprises a controller configured to operate the remote actuators to advance or retract the line along the path by moving the ground contacting parts in a sequence comprising a series of steps, wherein, in each of the steps one or more of the ground contacting portions are moved longitudinally relative to the ground while others of the ground contacting portions are stationary relative to the ground. The ground contacting portions may carry backstops which are configurable to resist motion of the ground contacting portion in a first longitudinal direction and to permit motion of the ground contacting portion in a second longitudinal direction opposite to the first direction.

In a further example aspect, the line includes a steering unit operable to flex a respective local portion of the line laterally and/or in an up and down direction. The steering unit may be one of a plurality of steering units that are distributed along the line, each of the plurality of steering units being operable to flex a respective local portion of the line laterally and/or in an up and down direction.

One of the plurality of steering units may be a lead steer unit disposed on an end of the line distal to the starting location, the lead steer unit operable to direct the distal end of the line along the path as the driver units advance the line. The lead steer unit may include a camera in communication with the controls. In some embodiments the line includes at the distal end a bent leader and the lead steer unit may include a remote actuator operable to rotate the bent leader about a longitudinal axis. The bent leader may be disposed on the carried part and the remote actuator may be operable to rotate at least a distal portion of the carried part.

In another further example aspect, the line includes at least one flexible member that extends longitudinally and follows the path as the line is deployed. The at least one flexible member may be provided by the carried part. The at least one flexible member may be provided by one of the ground contacting portions. The at least one flexible member may be provided alternately by one of the ground contacting portion for the respective laterally adjacent ground contacting portion. The remote actuators and ground contacting portions may be arranged so that each of a first set of the remote actuators is operable to hold the respective ground contacting portion stationary relative to the ground and one of the at least one flexible member, thereby resisting the one of the at least one flexible member against deviation from the path while another set of the remote actuators, is operable to move the respective ground contacting portion longitudinally along the line guided to follow the path by the one of the at least one flexible member. The remote actuators may be operable to move the ground contacting portions with system has deployed along a path having a net arc angle of 270 degrees or more.

The at least one flexible member may, for example, comprise one or more of: a conduit operable to convey a fluid along the line; and a cable configured to convey signals and/or electrical power along the line.

In another further example aspect, the carried part may comprise one or more of: a conduit operable to convey a fluid, a cable configured to convey signals and/or electrical power, one or more tracks or rails on which cargo or passenger cars may travel, a roadway, and a bridge or boardwalk.

In another further example aspect, the ground contacting portions may comprise first and second runners. The ground contacting portions may include a plurality of first cross members fixedly coupled to the first runner and slidingly coupled to the second runner and a plurality of second cross members slidingly coupled to the first runner and fixedly coupled to the second runner. The remote actuators may be coupled between ones of the first cross member and ones of the second cross members.

In some embodiments the remote actuators comprise a series of two or more linear actuators coupled in series with one another. Couplings between adjacent ones of the linear actuators may be made at members that are guided to slide along the line. For example, the line may additionally include a plurality of third cross members slidingly coupled to each of the first and second runners. Couplings between adjacent ones of the linear actuators may be made at the third cross members.

In a still further example aspect, the first and second runners are supplied from one or more runner reels located at the first location. The runners may be unspooled from the runner reel(s) as the line is advanced along the desired path. The first and second runners may comprise flexible pipes. The carried part may comprise one of the first or second runners.

In another further example aspect, the line comprises a plurality of backstop mechanisms spaced apart along the line. The backstop mechanisms may be configurable in a first mode which resists motion of an associated ground contacting portion in a first longitudinal direction and permits free movement of the associated ground contacting portion in a second longitudinal direction opposite to the first longitudinal direction and a second mode which resists motion of an associated ground contacting portion in the second first longitudinal direction and permits free movement of the associated ground contacting portion in the first longitudinal direction. The backstop mechanisms may each comprise one or more pivotable dogs or a traction wheel positioned to engage with the ground.

In another further example aspect, the carried part comprises a fluid conduit and the system comprises a pump coupled to deliver a fluid through the fluid conduit. The conduit may comprise a plurality of nozzles spaced apart along the fluid conduit. each of the plurality of nozzles may be associated with a corresponding one of a plurality of valves that is operable to block or allow a flow of the fluid from the conduit into the nozzle.

In another further example aspect, the remote actuators may include a first set of remote actuators operable to move the carried part longitudinally relative to ground contacting portions. The remote actuators may include a second set of remote actuators operable to rotate the carried part.

Another example aspect of the invention provides a method for deploying a system to extend from a starting location along a path, the system comprising: a slender line that is elongated in a longitudinal direction and slender in a transverse direction. The line comprises a plurality of ground contacting portions distributed along a length of the line in a parallel side-by-side relationship, and a plurality of remote actuators distributed along the length of line, each of the actuators operable to move one or more of the ground contacting portions relative to other ones of the ground contacting portions in the longitudinal direction. The method comprises operating the remote actuators to advance the line along the path by moving the ground contacting parts in a sequence comprising a series of steps, wherein, in each of the steps one or more of the ground contacting parts are moved longitudinally relative to the ground while others of the ground contacting parts are stationary relative to the ground.

In a further example aspect, the system includes one or more carried part propulsion units (PPUs) distributed along the length of the line and the method includes operating the one or more PPUs to move the carried part along the path relative to the line. The method may further include operating the remote actuators and PPUs to retract the system along the path from a remote location relative to the carried part, thereby leaving the carried part deployed along the path.

In another further example aspect, the line includes a carried part and the method includes providing services on the path via the carried part. The carried part may include one or more electrical cables and the services may include power transmission. The carried part may include one or more data transmission cables and the services may include telecommunications. The carried part may include rails or tracks and the services may include cargo or personnel transportation via cars mobile on the rails or tracks.

In a still further example aspect, the carried part includes a conduit and the services include fluid transportation. The method includes steps of providing a plurality of ports in an outer surface of the conduit and distributed longitudinally along at least a portion of the conduit; providing a pressurized supply of a fluid at the accessible location in communication with the conduit; and operating the pressurized supply to introduce the fluid into the conduit, thereby dispersing the fluid around at least a portion of the desired path via the ports. The fluid may be selected from a group consisting of water, a fire retardant, and a mixture of water and a fire retardant.

Other example aspects of the invention relate to: actuation units of different types that may be disposed in a line as described herein; components that may be included in lines as described herein; methods of constructing, operating and/or applying lines as described herein; and apparatus and methods for use in launching and/or controlling the advance of lines as described herein.

It is emphasized that the invention relates to all combinations and sub-combinations of the above features with one another and with features set out in the following detailed description and drawings even if these are recited in different claims.

Further aspects of the invention and example embodiments of the invention are described in the following description and/or illustrated in the accompanying drawings.

### BRIEF DESCRIPTION OF THE DRAWINGS

The accompanying drawings illustrate non-limiting example embodiments of the invention.

FIG. 1 is a schematic illustration of a system according to an example embodiment deployed in rugged terrain to control a wildfire.

FIG. 2 is a schematic illustration showing an example system configured to commence deployment of a conduit.

FIGS. 3A to 3E illustrate steps in advancing spans of a casing of a conduit.

FIGS. 4A to 4I illustrate steps in advancing a conduit.

FIGS. 5A to 5F illustrate steps in steering a conduit.

FIGS. 6A and 6B illustrate operating a system as described herein to create a corridor.

FIGS. 7A to 7C are perspective cut away views showing an example construction for segments of a casing.

FIGS. 8A to 8F are respectively: a plan view of a pipe propulsion unit, a side elevation of a pipe propulsion unit in a retracted configuration, a side elevation of the pipe propulsion unit in an extended configuration, a perspective view of the pipe propulsion unit, a cross section of an example gripper for a pipe propulsion unit in the plane indicated by 8E-8E in FIG. 8D and a cross section of an example gripper for a pipe propulsion unit in the plane indicated by 8F-8F in FIG. 8D.

FIG. 9A to 9C are respectively: a plan view, side elevation view and cross section view of an example casing shift unit.

FIGS. 10A to 10C are respectively: a plan view, side elevation view and cross section view of an example pipe torsion unit.

FIGS. 11A and 11B are perspective cut away views showing an example construction for a casing articulation unit.

FIG. 12 is a perspective view of an example pipe steering unit.

FIG. 13 is a simplified block diagram of an example control system for apparatus like that illustrated in FIG. 2.

FIGS. 14A and 14B are flow charts illustrating example control algorithms that may be applied to advance a conduit.

FIG. 15 is a flow chart illustrating a method according to an example implementation of the present technology.

FIG. 16 is a schematic illustration showing an example system according to an alternative embodiment in which casing comprises flexible elongated sections that are joined together around a carried part.

FIGS. 17A and 17B are schematic drawings that illustrate an example method for extending a segmented part of a line.

FIG. 18 is a flow chart that illustrates an example sequence of events for extending a segmented part of a line.

FIGS. 19A and 19B are perspective views of a segment of a segmented part of a line and a portion of a carried part of the line. FIG. 19C is an end elevation view of the segment shown in FIGS. 19A and 19B.

FIGS. 20A to 20F illustrate example couplings between segments. FIGS. 20A and 20B are side elevation views that illustrate the use of a pin connection for coupling two segments. FIGS. 20C to 20F show an example of a means for coupling two segments using a sliding keyhole plate. FIGS. 20C and 20D are respectively side elevation and cross section views showing a coupling between segments in which a sliding keyhole plate is in an unlocked configuration. FIGS. 20E and 20F are respectively side elevation and cross section views showing the coupling between segments in which the sliding keyhole plate is in a locked configuration.

FIGS. 21A to 21D are side views of an example backstop mechanism which show different stages in the storage and deployment of a backstop. FIG. 21A shows the backstop in a non-deployed configuration. FIG. 21B shows the backstop in a deployed configuration. FIG. 21C shows the backstop digging in to resist reverse motion. FIG. 21C shows the backstop pivoting to provide free movement in a forward direction.

FIGS. 22A and 22B are respectively a perspective view and a cross section of an example pipe propulsion unit (PPU).

FIG. 23A is a perspective view showing an example pipe propulsion unit with a carried part such as a fluid conduit received in a channel thereof. FIGS. 23B and 23C are cross section views of the pipe propulsion unit of FIG. 23A which illustrate an example means for retaining the carried part in the channel.

FIG. 24 is a perspective view showing an example unit that combines functions for moving and rotating a carried part.

FIG. 25A is a perspective view showing an example mechanism for articulating segments relative to one another. FIG. 25B is a top view of the mechanism of FIG. 25A showing side-to-side articulation. FIG. 25C is a side view of the mechanism of FIG. 25A showing vertical articulation.

FIG. 26A is a partially schematic view of a conveyor based launching unit. FIG. 26B is an enlarged view of a portion of the conveyor of the launching unit of FIG. 26A.

FIG. 26C is an enlarged view of a drive lug of the conveyor of the launching unit of FIG. 26A.

FIG. 27A is a plan view illustrating an example arrangement of actuators for advancing a line and advancing a carried part of the line that may be applied in embodiments that include a pair of ground-contacting runners.

FIG. 27B is a plan view illustrating an example arrangement of actuators for steering a line that may be applied in embodiments that include a pair of ground-contacting runners.

FIGS. 27C and 27D illustrate an example mechanism for actuating reciprocating motion of one runner relative to another runner to advance a line.

FIG. 28A is a cross section view of a cross member of the line of FIG. 27A. FIG. 28B is a perspective view of an example bi-directional backstop mechanism. FIGS. 28C and 28D respectively show the backstop mechanism of FIG. 28B configured for forward operation and reverse operation. FIG. 28E is a cross section of a cross member that facilitates sliding with each of two ground-contacting runners.

FIG. 29 is a flow chart illustrating an example sequence for controlling actuators to advance a line of the type illustrated by FIGS. 27A and 27B.

FIG. 30 is a schematic illustration showing a line that includes distributed driver units that are operable to advance the line along a path.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Definitions

The term “line” is used herein to refer generally to an elongated structure that is extendable along a path from a starting location or base. A line may have a very small ratio of width to length (i.e. the line may be “slender”). For example, a line may be extended to have a length of tens, hundreds or thousands of meters and may have a width on the order of a few centimeters. Some embodiments have lines that do not exceed 15 cm or 20 cm or 30 cm in width. Some embodiments have lines that have length to width ratios of at least 500 or at least 1000 or at least 10,000.

Various embodiments provide lines that have certain elements “distributed” along the line. In this context distributed means spaced apart along or extending continuously along. For example, remote actuators or driver units may be distributed along a line. It is not mandatory that the distributed elements are equally spaced apart, although they may be. By providing distributed elements, the capacity of the distributed elements scales with the deployed length of the line. For example, where elements that are operable to move the line along a path are distributed, doubling the deployed length of the line may also double the number of elements that are available to be operated to move the line along the path.

The term “conduit” means any elongated element that can carry a material and/or signals and/or electrical power. Non-limiting examples of conduits include: lines for carrying fluids such as water pipes, pneumatic lines, hydraulic lines, and gas supply lines, electrical power cables, lines that include signal conductors such as electrical wires and/or optical fibres and combinations of any of these.

The term “ground” as used herein refers to any surface over which a line travels. Ground may, for example, include ground in the ordinary sense as well as road surfaces, lake, ocean, and river beds, obstacles such as rocks and logs.

The term “carried part” means something that is carried along a path as a line is moved along the path. A carried part may, for example, comprise a conduit, a track carried by a line that is operable to carry something along a path taken by a deployed line or the like. In some embodiments, a carried part is separable from a line such that the line may be withdrawn from a path to leave the carried part deployed along the path.

### Overview

The present technology provides systems and methods for advancing lines over long distances. The systems and methods may guide a free end of a line to advance along a desired path. The line may be steered to follow the desired path, for example as described herein. The line may comprise a conduit which may comprise one or more lumens for carrying fluids and/or one or more signal conductors (e.g. signaling wires or optical fibers) and/or one or more power carriers (e.g. electrical cables and/or pneumatic lines and/or hydraulic lines).

In an example application the line is extended from an accessible point (e.g. a forestry road) along a path extending over land subject to the risk of wildfire. Once deployed pressurized water and/or fire retardant may be delivered through the conduit to nozzles spaced apart along the conduit. The water and/or fire retardant may saturate trees, brush or other flammable materials along the path to create a firebreak and/or a corridor along which animals or people may more safely avoid a wildfire.

In another example application a fire accelerant such as a volatile fuel may be delivered through the conduit to create conditions for a backfire that may deprive a wildfire of fuel along the path of the line.

Advantageously the line may be steered by remote controls (e.g. from the accessible point) so that the line follows the desired path. It is not necessary for people to be deployed along the path of the line.

The present apparatus may be applied in a wide range of fire mitigation settings. In some embodiments the apparatus is applied to create a linear (including curvilinear) fire defense line. In some embodiments the apparatus is applied to encircle an area, for example to keep fire contained within the area or to keep fire from entering the area. For example, the area may be an area within which a controlled burn is to be conducted and one or more lines may be deployed to prevent the controlled burn from spreading outside of the area. As another example, one or more lines may be deployed around the area of a town, factory, farm, woodlot access road or the like to serve as a line of defense to prevent a wildfire from entering the area.

Lines may be deployed to encircle an area in different ways. One example is to cause a line to follow a path that encircles an area entirely or to a desired degree. Another example deploys a plurality of lines to follow paths that collectively encircle the area. For example each of the plurality of lines may extend along one side of the area. In one embodiment, two lines, which may have the same starting point are deployed along paths that diverge to take the lines on either side of the area and converge once they are past the area.

In some application lines are used to exclude fire from or keep fire contained within an elongated strip (e.g. a road to be protected or a line to be burned in a controlled burn to create a fire break). In such applications, one line (or two or more parallel lines) may be deployed along each side of the strip to prevent fire from entering or leaving the strip.

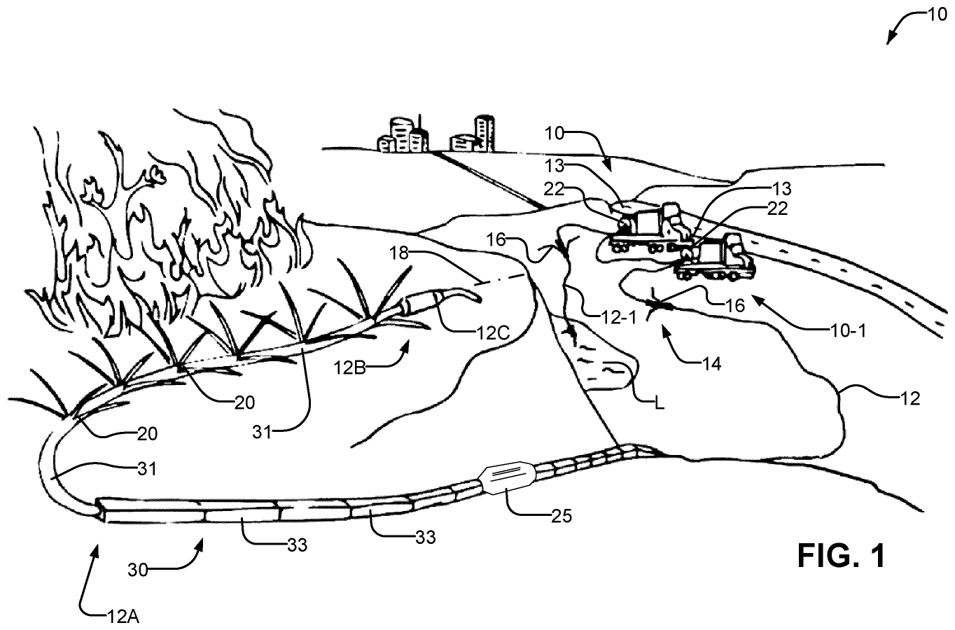

FIG. 1 schematically illustrates a system 10 according to an example embodiment which is configured for fire mitigation. System 10 comprises a line 12 that is stiff enough to be pushed but flexible enough to form curves following a path. System 10 also includes a base 14 which supports a propulsion unit 16 operative to push a part 12A of line 12 away from base 14 in a direction longitudinal to line 12 such that a free end 12B of line 12 follows a desired path 18.

In some embodiments a base is provided to assist in deployment of a line. The base may, for example, be configured to facilitate assembly of components of the line. The base may additionally include support equipment such as one or more electrical power generators, air compressors, hydraulic pumps and the like. As described in more detail below, the base can also control movements of ground contacting portions at a proximal end of the line, thereby stabilizing a path of the portion of the line closest to the base.

Deployment of line 12 can start by fixing base 14 in place at an accessible starting location. Base 14 may comprise a skid, a truck, a carrier (e.g. a tracked carrier), a barge or the like.

Line 12 may be steered to follow a desired path 18 as it is extended away from base 14. Various mechanisms may be provided to assist in steering line 12. These include:
a) Line 12 may include ribs, grooves or similar features that engage the ground and resist slipping of line 12 in a transverse direction while not impeding slipping of line 12 along the ground in a longitudinal direction;
b) The free end 12B of line 12 may comprise a steering structure 12C that can be oriented to guide free end to the left, to the right or straight ahead by rotating line 12 about its longitudinal axis. In some embodiments base 14 supports a rotator operative to selectively rotate line 12 about its longitudinal axis. In such embodiments line 12 may have sufficient torsional stiffness that rotation of the part of line 12 that passes through the rotator causes rotation of steering structure 12C to guide free end 12B in a desired direction.
c) The free end 12B of line 12 may comprise a steering structure 12C that can be oriented to guide free end to the left, to the right or straight ahead by means of a powered actuator that can be controlled remotely (e.g. by way of signal conductors extending along line 12). Power to operate the actuator may be supplied via a conduit of line 12.

Steerable structure 12C may, for example, comprise a portion of line 12 formed into a relatively tight radius curve, a curved blade, a set of fins oriented at different angles to the longitudinal axis of line 12 or the like.

Line 12 comprises spaced apart nozzles 20 or other fluid distribution devices that are in fluid connection with a conduit incorporated in line 12. The fluid distribution devices may, for example, comprise circular or shaped nozzles, sprinkler heads which may be like those common in irrigation systems, and/or impulse water cannon devices such as those manufactured by FireBozz of Nanaimo, Canada, Nelson Irrigation of Walla Walla, Washington USA or IFEX Technologies of Germany.

After line 12 has been deployed, fluid such as water and/or fire retardant may be delivered to nozzles 20 or other water distribution devices via line 12. The fluid may be supplied at high pressure such that vegetation surrounding line 12 is saturated by the fluid. Where the fluid is water, the spray of fluid may increase the humidity along line 12. Line 12 may also be operated to direct water and/or fire retardant into a flow of air that is being drawn into a fire, thereby taking away energy from the fire (e.g. by vaporizing the fluid).

It is convenient to transport, handle and store undeployed parts of line 12 in a coil. In some embodiments one or more components of line 12 are coiled for storage and/or transportation. FIG. 1 shows a reel 22 that stores a coiled part 13 of line 12.

FIG. 1 shows a second system 10-1 from which a line 12-1 has been extended to draw water from a water source (e.g. a lake L). System 10-1 may, for example include a submersible pump at its distal end that is operative to deliver water through a conduit of line 12-1. The submersible pump may be powered by cables that extend along line 12-1. Other pumps (not shown in FIG. 1) may be provided to deliver the water to a conduit of line 12 of system 10 at a desired pressure.

Any embodiments of the present technology may include any of a wide range of sensors. The selection of sensors, where present, may be based on the application for which the line 12 is designed. For example a line 12 may include means for monitoring the current configuration of the projecting part 12A of line 12 and/or the position of free end 12B of line 12 and/or other sensors. Such sensors may comprise, for example:
a) one or more position detecting sensors such as: global positioning system (GPS) receivers, one or more transmitters spaced apart along line 12 that emit signals that can be remotely detected such that positions of the transmitters may be determined by triangulation (such transmitters may, for example, transmit radio signals), and/or one or more altimeters. In some embodiments two or more position detecting sensors are spaced along line 12.
b) one or more imaging devices that are operable to provide images, detect obstacles and/or monitor ground conditions. Imaging devices may include, for example one or more cameras, radar or lidar devices spaced apart along or at one or more desired locations along line 12.
c) one or more beacons that emit detectable signals that may be used by e.g. a drone to find line 12. A drone may be controlled to fly over the location of such a beacon and to broadcast images of line 12 to personnel operating system 10.
d) one or more visible indicators that can be released from line 12 (e.g. lighter than air balloons, colored smoke, a projectile, a light beam or the like).
e) one or more direction finders (e.g. compasses, inclinometers, radio direction finders).
f) one or more sensors operable to monitor air quality and other conditions at one or more locations along line 12. Such sensors may, for example, comprise smoke detectors, CO₂ monitors, hazardous gas detectors, hygrometers, wind sensors (speed and/or direction) and/or temperature sensors.
g) one or more sensors operative to track heading direction and distance travelled.
h) one or more radiation sensors.
i) one or more seismic sensors.
j) one or more sensors operable to detect presence of persons, vehicles, livestock and/or wildlife.
k) sensors operable to monitor status of line 12 such as pressure sensors connected to monitor pressures of pneumatic lines, hydraulic lines, or fluids in one or more conduits, position sensors and/or limit switches operative to monitor positions of components of line 12 such as actuators, backstops etc.

Any of these sensors that are present may communicate outputs to a console or other control system for example by way of: signal conductors in line 12 and/or wireless data signals.

In some embodiments, outputs of sensors (e.g. sensors that process heading direction and distance travelled) are processed to determine current position of one or more points on line 12 using dead reckoning. The dead reckoning calculations may be the same as or similar to calculations used in directional drilling in the oil and gas industry to estimate the location of components of drill strings.

In some embodiments, information from sensors is processed by a control system to provide a map image that shows the path along which a line 12 is deployed and may optionally show conditions measured by the sensors at locations along the path.

In some embodiments of the present technology a line 12 comprises an elongated member which may be a tubular member that is pushed away from base 14 by a mechanism associated with base 14. However, in general there is a limit to how far one can extend an elongated member such as a tube or conduit over ground solely by pushing the elongated member. This is because an elongated member intended to extend away from base 14 by any significant distance must practically have a ratio of length to diameter that will become extremely large as the line is extended away from base 14. The farther the line is extended the more force will be required to overcome friction between the line and the ground. Any curves in the path taken by the line will increase the force required to advance the line as a result of an inverted capstan effect. In general, the force required to advance such a line by pushing the conduit from the base will increase to the point that it is not possible to further advance the line. In an extreme case the force required to further advance the line may exceed a level of force that will cause the line not to follow the desired path (e.g. due to buckling instability) or even damage the line. The buckling tendency will become greater with increased tortuosity of the path of line 12.

While embodiments which advance a line by pushing from a base 14 may be useful in applications in which the line needs to be advanced over only a relatively small distance there are many other applications in which it is necessary to extend lines over much larger distances than could be practically achieved by pushing the line from a base.

Some embodiments include actuator units that may be operated to extend a line 12 to an arbitrary length from base 14. The actuator units may be distributed along line 12. In some embodiments such actuator units may be operated to extend line 12 to an arbitrary length (for example several kilometers or several miles).

System 10 of FIG. 1 includes remote actuator units 25 located along deployed part 12A of line 12. Remote actuator units 25 may be powered by way of line 12. Remote actuator units 25 may have streamlined shapes that make them resistant to being snagged by branches, undergrowth or other obstacles as they move overland as line 12 is advanced.

In some embodiments line 12 comprises plural ground contacting portions that are movable relative to one another. The ground contacting portions may comprise longitudinally extending members that contact the ground underlying line 12. During advancement or retraction of line 12, a first group of one or more of the ground contacting portions may be held in place relative to the ground (e.g. by friction or engagement of optional teeth, anti-backsliding devices or the like) while another group of one or more other ones of the ground contacting portions is being moved (e.g. away from or toward base 14). The first group of ground contacting portions may serve as anchors against which actuators can push to move the second group of ground contacting portions. The ground contacting portions may be arranged in different ways, for example, in line with one another, side by side, etc. The ground contacting portions may be moved in a wide variety of sequences to advance or retract line 12. The ground contacting portions may themselves comprise conduits for carrying fluid etc. or may carry one or more conduits.

In systems and methods according to some embodiments of the present technology, an elongated line includes two parts that are coupled together in a way that allows segments of at least one of the parts to move longitudinally relative to the other one of the parts. In such embodiments the segments may serve as ground contacting portions. A part that includes movable segments may be called a “segmented part” the other part with respect to which the segments are moved may be called a “carried part”. With such a construction the segments of the segmented part may be moved longitudinally relative to the carried part (and relative to other ones of the segments) in sequences that result in the line being advanced or retracted. In some embodiments the segments are moved relative to ground on which the line is resting in patterns similar to locomotion patterns of earthworms. In some embodiments the segments are arranged to be side-by side in a parallel relationship and the segments are moved relative to the ground in patterns similar to Nordic skiing.

In embodiments where a line 12 comprises a segmented part and a carried part, actuation units 25 may act to move segments of the segmented part relative to one another and/or to hold or move the carried part relative to the segmented part.

The line may incorporate one or more conduits. One or both of the segmented part and the carried part may include a conduit or conduits. By extending the line, the one or more conduits may be deployed along a desired path. The conduits may provide fluids, electrical, pneumatic and/or hydraulic power and/or access to command and/or communications signals along the path for any of a wide variety of applications.

The segmented part of a line may be related to the carried part of the line in different ways. The segmented part may be continuous or interrupted and may surround the carried part or be under, over, beside or astride the carried part. For example, the segmented part may take the form of a casing that defines a longitudinal bore, channel or passage and the carried part may extend along the bore. As another example, the segmented part may define a channel and the carried part may extend along the channel. The channel may be closed or open along one side. As another example, the segmented part may extend alongside the carried part.

The carried part may, for example, comprise a pipe, tube, electrical cable, fiber optic cable, fiber rope or wire rope or a combination thereof.

FIG. 1 shows that line 12 may comprise a segmented part 30 that extends along a carried part 31 of line 12. In this example embodiment, carried part 31 comprises a tubular conduit and segmented part 30 comprises a casing that defines a bore within which carried part 31 extends. In other embodiments segmented part 30 may receive carried part 31 in a slot or may extend beside carried part 31.

Segmented part 30 may serve various functions which may include one or more of:
a) carrying remote actuator units 25;
b) providing a support against which remote actuator units 25 can push or pull to advance carried part 31;
c) providing for axial actuation of carried part 31 distributed along the length of carried part 31;
d) holding line 12 in place while individual segments or groups of segments are moved to extend or retract line 12;
e) providing a desired degree of stiffness to line 12 while allowing carried part 31 of line 12 to be flexible enough to be stored in coils of a diameter small enough for convenient transportation and handling;
f) protecting carried part 31 of line 12 from abrasion and/or high temperatures;
g) providing flotation to line 12 (e.g. to help float line 12 across bodies of water) or providing ballast to line 12 (e.g. to help line 12 to sink to the floor of a body of water);
h) accommodating actuating fluid lines and/or cables for power, control and instrumentation.

Segmented part 30 in combination with carried part 31 may be:
a) significantly stiffer than carried part 31 alone; and/or
b) have a larger minimum radius of curvature than carried part 31 alone.

In a non-limiting example embodiment carried part 31 is provided by a continuous section of pipe or a few coupled together continuous sections of pipe. For example, the pipe may have a nominal diameter in the range of 2 to 6 inches (5 to 15 cm). The pipe may, for example comprise a 4 inch nominal diameter, spoolable composite pipe. Such pipe is commercially available with working pressure ratings of 1500 to 5000 psi or more. For example, suitable composite piping is available from Strohm of Ijmuiden, Netherlands, Shawcor of Calgary, Canada, Soluforce of The Netherlands and Magma of Portsmouth, UK. Carried part 31 may have a total length of up to 5 km or 10 km, for example.

Carried part 31 may have ports to which nozzles 20 may be coupled. The ports may be spaced all along carried part 31, along a distal end portion of carried part 31, along another desired portion of carried part 31 etc. In general, ports may be provided wherever it is contemplated that a nozzle may be desired. The ports may be arranged in suitable ways such as one or any combination of:
a) a row or rows extending longitudinally along all or a portion of carried part 31.
b) circumferentially spaced apart rings.
c) a helical pattern.
d) a pattern of intersecting helixes etc.

The ports may, for example, be threaded to accept nozzles 20. The threads may, for example, comprise tapered threads such as standard pipe threads. Ports at locations where nozzles are not required may be plugged. The ports may be recessed into carried part 31 such that plugs or nozzles do not project radially past the surface of carried part 31 in a way that would adversely affect deployment of line 12. How far nozzles 20 or other components can project from carried part 31 will depend on factors such as the dimensions of segmented part 30 and the way that segmented part 30 and carried part 31 cooperate. It may be more important to minimize stick out of nozzles or other components attached to carried part 31 in cases where it is desired to withdraw segmented part 30 while leaving carried part 31 deployed.

In some embodiments ports on carried part 31 are connected to transfer fluid from a conduit in carried part 31 to a fluid manifold on segmented part 30. For example by way of passages inside grippers that extend between carried part 31 and segmented part 30. The fluid may, for example, be delivered to sprinkler heads, fluid guns or nozzles supported on segmented part 30.

In some embodiments fluid flow from some or all of the ports is controlled by a corresponding valve. The valves may be remotely actuated (e.g. the valves may comprise actuators such as solenoid actuators or rotary actuators)). The valves may, for example, comprise valves, such as ball valves, that provide very low resistance to fluid flow and low turbulence when fully opened.

Nozzles 12 may be chosen based on factors such as the desired spray pattern, available fluid pressure, achievable flow rate, etc. In some embodiments nozzles 20 have diameters in the range of about 0.2 inches (about 5 mm) to about 0.6 inches (about 15 mm). Nozzles 20 configured for delivering long range fluid jets may have long tapered bores. In some embodiments some of nozzles 20 are configured to distribute fluid through an arc or circle. For example, some or all nozzles 20 may comprise irrigation sprinkler heads of any suitable design. In some embodiments nozzles 20 are configured to generate jets of fluid that travel for relatively long distances (e.g. 20 m or farther).

### Actuator Units

Remote actuator units 25 may be coupled in line with segmented part 30 and may include functions for:
a) connecting (e.g. gripping), carried part 31 selectively or continuously and holding and/or actuating carried part 31 axially with respect to segmented part 30;
b) controllably pushing adjacent segments of segmented part 30 apart in the longitudinal direction along line 12;
c) pulling segments of segmented part 30 together in the longitudinal direction;
d) articulating segmented part 30; and/or
e) rotating a part of carried part 31 and/or a part of line 12.

These functions may be provided by different actuator units 25 or combined in actuator units 25.

Operation of the functions of remote actuator units 25 may be coordinated to:
a) Advance line 12 along a path;
b) Move a remote actuator unit 25 along carried part 31 in either direction;
c) Move segments of segmented part 30 along carried part 31 in either direction;
d) Retract segmented part 30 or a section of segmented part 30 to expose all or a portion of carried part 31;
e) Bend or flex a portion of line 12 (e.g. for steering around an obstacle or to follow a desired path) and/or
f) Twist carried part 31 (e.g. for the purpose of steering line 12 to follow a desired path and/or to adjust orientations of nozzles 20 to spray water or another fluid in desired directions).

To achieve these functions, individual remote actuator units 25 may, for example, comprise one or more of:
a) one or more attachment elements operable by way of one or more actuators to transmit axial forces and/or torques to carried part 31;
b) one or more actuators operable to longitudinally expand or contract the actuator unit 25 (e.g. so that ends of segments of segmented part 30 coupled to the actuator unit 25 are pushed apart or drawn together);
c) one or more actuators operable to twist (apply torsion) to carried part 31;
d) one or more actuators operable to bend segmented part 30 in any plane (e.g. about a substantially vertical and/or a substantially horizontal axis) e) one or more pairs of flexible member loops configured to engage a portion of the carrier and driven to advance in either the forward or rearward direction.

Attachment elements of actuator units 25 may be selectively engageable to carried part 31 or constantly engaged to carried part 31 in the deployed line 12. Examples of constantly engaged attachment elements include attachment elements that are integral to carried part 31, or are attached to carried part 31 by means such as bolts, pins, dowels, or friction clamps (e.g. strap clamps), or fittings that positively engage features of carried part 31 such as grooves, outside diameter upsets, splines, keys, keyways, notches, recesses or the like. Examples of selectively engageable attachment elements include grippers operable to selectively grip or ungrip carried part 31. Grippers may operate, for example by closing to clamp against outer surfaces of carried part 31 by mechanical action, inflating tubes or bladders, or selectively engaging features of carried part 31 such as splines teeth, keyways, grooves, outside diameter upsets or by magnetic grippers.

In some embodiments a system as described herein includes actuator units 25 of two or more different types each of which may comprise different ones of these components and/or different combinations of these components to achieve the desired operability of line 12. In some embodiments systems as described herein include actuator units 25 operable to provide two or more functions. For example, some embodiments include actuator units 25 that combine pipe propulsion and pipe rotation functions in a single unit. Such a unit may use a single gripper or pipe clamp to transmit the actuation forces/torques for both of these functions. Some examples of systems 10 that include specific types of actuator units 25 which each provide specific functionalities are described herein. However, systems as described herein may be implemented using actuator units 25 which have other specific types of actuator unit 25 that provide other selections of functionality.

In some embodiments actuator units 25 are operated by, for example compressed gas such as air, nitrogen, carbon dioxide, compressed fluid such as water, hydraulic fluid, or environmentally friendly biocompatible and/or biodegradable hydraulic fluid.

In some embodiments, a system 10 includes:
a) Remote actuator units 25A, which may be called: “pipe propulsion unit” or “PPU”, which include an attachment element (e.g. any suitable type of attachment element described herein) and a linear actuator connected to move the attachment element lengthwise (axially) along the remote actuator unit 25A. Some embodiments include one or more remote actuator units 25A that are configured to move the attachment element longitudinally without changing an overall length of the remote actuator unit 25A.
b) Remote actuator units 25B, which may be called “casing shift unit” or “CSU” which include linear actuators coupled to extend (make longer) or retract (make shorter) the remote actuator unit 25B.
c) Remote actuator units 25C, which may be called “steering units” that are operable to steer leader 41.
d) Remote actuator units 25D, which may be called “articulation units” or “CAUs” that are operable to bend segmented part 30 by angling couplings that connect adjacent components of segmented part 30 and/or coupling(s) that connect different parts of a component of segmented part 30.
e) Remote actuator units 25E (pipe torsion units or “PTUs”) that are operable to twist carried part 31.

Some embodiments include one or more actuator units 25 that combine functions of two or more of the above types of actuator units 25. In some embodiments one or more actuator units include fixed or extendable outriggers (not shown) for stability and to react actuator torque against the ground or other supporting surface. For example, actuator units 25C and/or 25E may include such outriggers.

In the following description, actuator units generally or collectively are referred to as actuator units 25. Different types of actuator unit are referred to as 25A, 25B, 25C etc. Different individual ones of actuator units 25 of any given type may be referenced by a number such as 25A-0, 25A-1, etc.

### Example System

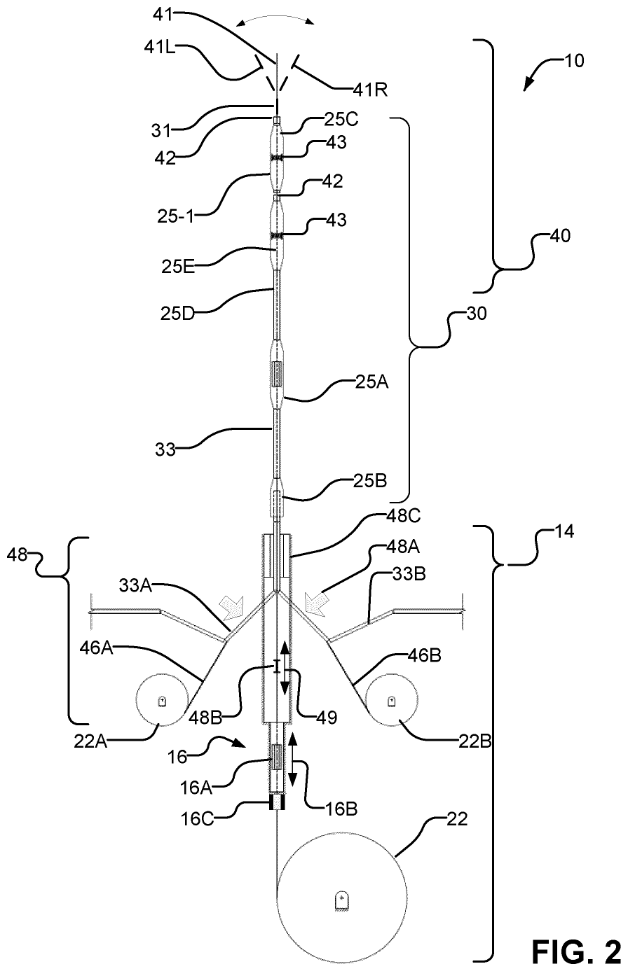

FIG. 2 is a more detailed schematic view of an example system 10 in a configuration from which deployment of a line 12 may be started. In this example embodiment, line 12 includes a leading end assembly 40 that includes a leader 41. Leader 41 is curved or bent. Leader 41 may, for example, comprise a bent member such as a bent blade or a bent section of pipe or bar.

As the distal end of line 12 is advanced, leader 41 may interact with objects (e.g. brush, trees, rocks, posts) and/or the ground to move the distal end of line 12 in a desired steering direction. Leader steering actuator unit 25C is configured to rotate leader 41 about an axis of line 12.

Leader steering unit 25C may, for example, comprise a motor powered by electrical power or compressed fluid supplied by way of carried part 31 or power from a battery. Control signals may, for example, be delivered to leader steering unit 25C by way of electrical or optical signal carriers in carried part 31 or wireless control signals.

Leader 41 may, for example, be rotated by actuator unit 25C to a position 41L in which the distal end of line 12 is steered to the left as line 12 is advanced and a position 41R in which the distal end of line 12 is steered to the right as line 12 is advanced. Leader 41 may also be oriented upward to help line 12 advance over ledges, fallen logs or other obstacles.

In the illustrated example embodiment leader 41 is attached to the distal end of carried part 31 which also carries leader steering actuator unit 25C. The rotation angle of leader 41 may be adjusted by turning leader 41 with leader steering actuator unit 25C and/or rotating the distal end of carried part 31 with PTUs 25E. A plurality of PTUs 25E distributed along carried part 31 may cooperate to create significant rotation of a distal part of carried part 31.

In addition to, or as an alternative to, steering line 12 using leader 41, steering may be accomplished using one or more articulation units as described herein (e.g. articulation units 25D or 325D). One or more such articulation units may be provided near a leading end of segmented portion 30.

It will be appreciated that line 12 may be caused to follow a desired path in various ways. These include, without limitation:
a) pushing a length of carried part 31 out from a distal end of segmented part 30 while steering carried part 31 using leader 41 as described above—the projecting distal end of carried part 31 may then serve as a track which guides advancement of segmented part 30;
b) flexing segmented part 30 using articulation units to guide the path taken as segmented part 30 is advanced;
c) pushing a portion or portions of the line laterally using one or more rollers, tracks, or friction devices (e.g. devices similar to those described elsewhere herein); and/or
d) combinations of the above.

A line 12 of the general type shown in FIG. 2 that includes a carried part 31 and a segmented part 30 may be used to spray water or other fluid as described above. In some embodiments, line 12 is configured for dispensing fluid through a distal end of carried part 31 that projects past an end or segmented part 30. In such embodiments, leader 41 and/or a PTU 25E may be used to set or vary rotational orientations of the distal end of carried part 31 (e.g. to oscillate so that sprays from nozzles 20 are swept from side to side of line 12). In such embodiments, carried part 31 optionally includes one or more swivel joints located to allow independent rotation of leader 41 and/or a portion of inner tubular 31 equipped with nozzles 20 or ports, while maintaining pressure integrity and axial connectivity. In some embodiments segmented part 30 is formed with openings and/or carries carried part 31 in such a way that nozzles or ports of carried part 31 are not obstructed by segmented part 30. In such embodiments fluid may be dispensed from portions of carried part 31 that are within or are co-extensive with segmented part 30.

FIG. 2 shows optional imaging devices such as cameras 42. Images from cameras 42 may be useful for viewing terrain and conditions around line 12. Images from cameras 42 may, for example, be used to monitor conditions at the distal end of line 12 and/or to make operational decisions for controlling line 12. For example, an operator may control operation of leader steering actuator unit 25C to steer line 12 based on images obtained by camera(s) 42. The operator may be at a location remote from cameras 42 (e.g. the operator may remain at a location at or near base 14 or may be anywhere in the world controlling system 10 by way of suitable data links).

FIG. 2 shows optional winches 43 that may be used to pull the distal end of line 12 in a desired direction in cases where personnel can safely access the distal end of line 12.

Segmented part 30 may include one or more articulation units 25D that are constructed to allow controlled articulation of segmented part 30 (e.g. to allow curvature of the portion of segmented part 30 that includes one or more articulation units 25D to be set to a desired radius of curvature). Articulation units 25D may be used to steer advancement of line 12 by setting the articulation units to form a desired curvature in segmented portion 30 and/or setting one or more of the articulation units to a maximum articulation in a desired direction for a portion of the time period during which segmented portion 30 is being advanced. By varying how long the articulation unit remains at full articulation in each period while the span of segmented portion 30 that includes the articulation unit is being advanced, the amount of steering in the desired direction may be adjusted.

One or more articulation units 25D may, for example, be located near a distal end of segmented part 30. For example, articulation units 25D may be set to be straight (no curvature) to cause segmented part 30 to advance in a straight line or may be set to curve right or left to steer segmented part 30 to extend in a desired direction. For example, an articulation unit 25D may be coupled to remote actuator unit 25-2 by a coupling that permits articulation through a desired angle (e.g. +10 degrees). In some embodiments an articulation unit 25D includes actuators operable to set the angles of articulation of articulation unit 25D and adjacent segments of segmented part 30. In some embodiments articulation unit 25D includes one or more bias elements (e.g. springs) that bias the articulation unit toward a particular curvature (e.g. straight) and the actuator or actuators may be operable to act against restoring forces of the bias elements to set other desired curvatures.

Articulation units 25D may have single-axis capability for steering only or two-axis capability which can bend segmented part 30 in a substantially vertical plane to help advance conduit 12 over or under fallen trees or other obstructions.

An articulation unit 25D may be configured to flex joints between segments (e.g. 33, 233) of segmented part 30 and/or to flex segmented part 30 over some length within its elastic limits to form an arc.

FIG. 2 illustrates how segmented part 30 may include segments 33 that are coupled end to end. Segmented part 30 may be provided by a plurality of segments 33 and actuator units 25 coupled together end to end. Carried part 31 extends through a channel or bore that extends longitudinally through the coupled segments 33 and actuator units 25.

In this example embodiment, carried part 31, if anchored to the static portion(s) of segmented part 30, maintains the path length along which the advancing segments of segmented part 30 are advanced. The established trajectory of line 12 is generally maintained by the following portions as line 12 is advanced as described herein, regardless of path tortuosity.

Segments 33 and other components of segmented part 30 (e.g. actuator units 25) may be designed to allow them to be assembled to (e.g. around, over, under or alongside) a continuous length of carried part 31 (e.g. a continuous length of flexible pipe). In general, the elements of segmented part 30 may be inside, on, under, beside or outside carried part 31.

In the example shown in FIG. 2, segmented part 30 acts as a casing for carried part 31. For example, segments 33 may have a clamshell configuration in which each segment 33 of segmented part 30 comprises parts 33A and 33B that are coupled together around carried part 31 to form the segment 33 of segmented part 30 or a U-configuration in which segments include a longitudinal slot through which carried part 31 can be received into a longitudinal channel (see e.g. segments 233 discussed below). With such constructions, segments 33 of segmented part 30 can be added as line 12 is extended and the segments 33 of segmented part 30 can be removed as line 12 is retracted.

In some embodiments where components of segmented part 30 include separate parts or halves (e.g. 33A, 33B) that are configured to be joined around carried part 31, the separate halves may be coupled together in advance and fed to a point where corresponding halves (e.g. 33A, 33B) are attached together around carried part 31. In some such embodiments corresponding halves of actuator units 25 are coupled together in line with other halves in advance. In some embodiments actuator units 25 are added to segmented part 30 in some other manner.

In some embodiments carried part 31 comprises continuous lengths of a spoolable conduit such as flexible pipe. Each length of carried part 31 may, for example, be in the range of 250 meters to over 1000 meters. Additional lengths of carried part 31 may be spliced onto the proximal end of carried part 31 as carried part 31 is deployed.

Actuator units 25 may be constructed to allow them to be assembled around a continuous length of carried part 31. For example, actuator units 25 which are included in segmented part 30 may have a clamshell configuration in which each of the actuator units 25 comprises first and second parts that are coupled together around carried part 31.

One or more umbilical cables that carry one or more of power (electrical and/or fluid), control signals for line 12 and/or signals from sensors on line 12) may be incorporated into line 12. One or more umbilicals may, for example, be incorporated into or run inside or beside carried part 31; and/or be carried by segmented part 30 (e.g. inside, or alongside or on segmented part 30).

FIG. 2 shows umbilicals 46A and 46B that are respectively extendable from reels 22A and 22B and extend along segmented part 30. Umbilicals 46A and 46B may, for example be supported by features of casing segments 33A and 33B respectively such that umbilicals 46A and 46B are protected by those segments 33 of segmented part 30 that are assembled around carried part 31. Segments 33 may be designed to accept two, three or more umbilicals. In some embodiments one or more umbilicals 46 extend inside a channel within segmented part 30. In some embodiments one or more umbilicals 46 extend along one or more protected raceway channels that extend along segmented part 30 (e.g. the raceway channels may extend along one or both sides of segments of segmented part 30).

In some embodiments one of umbilicals 46 comprises one or more fluid conduits e.g. pneumatic and/or hydraulic control and/or power conduits and/or one of umbilicals 46 comprises electrical conductors (e.g. one or more conductors that carry electrical power and/or electrical signals. In some embodiments at least one umbilical comprises one or more data lines (e.g. an electrical or optical data carrier). The data lines may carry data using a suitable protocol such as an Ethernet or Canbus or other suitable protocol. In some embodiments signals on one data line are addressable to individual controllable components of line 12.

In some embodiments remote actuator units 25 serve as connecting points for umbilicals 46. The remote actuator units 25 may receive electrical and/or fluid power by way of umbilicals 46 and may also receive and send communication signals by way of umbilicals 46. Umbilicals 46 may be connected to actuator units 46, for example using suitable quick couplings or connectors. Umbilicals 46 that carry fluids (e.g. compressed gas or hydraulic fluid) may, for example, be connected to actuator units 25 by compatible push couplings. Umbilicals 46 that carry electrical control or sensor signals may, for example, be coupled to electronics of actuator units by way of electrical connectors, T-tap connectors, inductive pickups, optoelectronic couplers, wireless or near field communication links or the like. Umbilicals 46 that carry electrical power may, for example, be connected to supply power to actuator units by way of electrical connectors, reactive power transfer systems. In some embodiments, remote actuator units 25 include first connectors that receive umbilicals 46 that extend toward base 14 and second connectors that receive umbilicals 46 that continue toward the distal end of line 12. In some embodiments umbilicals 46 have connectors for connecting to actuator units 25 at predetermined spaced apart locations. In some embodiments actuator units 25 include storage for extra length of umbilicals 46. Umbilicals 46 that cross variable length portions of segmented part 30 (e.g. umbilicals in CSUs) may comprise a festoon, energy chain (for example of a type available from Igus GmbH of Germany) or the like.

Base 14 comprises propulsion unit 16 which is operative to feed out carried part 31. In this example, carried part 31 is supplied from reel 22 into a casing management unit 48. Reel 22 may be equipped with active rotation drives and holding brakes to control feeding of carried part 31 and to resist the tendency of carried part 31 to straighten out due to its flexural stiffness and/or pressurization.

Segments (e.g. 25, 33, 233) of segmented part 30 may be mated to carried part 31 manually. In some embodiments casing management unit 48 is configured and operable to mate segmented part 30 to carried part 31 and/or to facilitate manual mating of components of segmented part 30 to carried part 31.

Propulsion unit 16 includes a pipe gripper 16A that is operable to selectively grip or engage carried part 31. Pipe gripper 16A may be operated to move carried part 31 axially and/or to hold carried part 31 against axial motion. An actuator (not shown in FIG. 2) is coupled to drive pipe gripper 16A in the directions indicated by arrow 16B. Propulsion unit 16 may also comprise a second pipe gripper 16C operative to hold carried part 31.

Casing management unit 48 includes a casing assembly mechanism 48A operable to assemble segments 33A, 33B of segments 33 around carried part 31. A casing launch shoe 48B is operable to push an assembled segment 33 of segmented part 30 or an assembled actuator unit 25 out of casing management unit 48 by way of casing guide 48C. Such actuation advances a deployed portion of segmented part 30.

An actuator (not shown in FIG. 2) is coupled to drive casing launch shoe 48B to move longitudinally (in the directions indicated by arrow 49). Casing launch shoe 48B may be driven forward to advance a segment 33 of segmented part 30 and then retracted to allow another segment 33 of segmented part 30 to be assembled around carried part 31.

Casing guide 48C is adjustable to accommodate larger and smaller cross sections of segmented part 30. For example casing guide 48C may have a wider setting to accommodate remote actuator units 25 and a narrower setting to accommodate segments 33 located between remote actuator units 25.

### Example Methods for Moving Segmented Part

It is not necessary that the entire segmented part 30 be moved at once. Moving different sections of segmented part along carried part 31 at different times facilitates extending line 12 to arbitrarily long distances away from base 14. In some embodiments actuator units 25 are operable to push and pull on sections of segmented part 30 that are in front of or behind the actuator unit 25 and the actuator units 25 are operated to advance sections of segmented part 30 that are between different pairs of actuator units 25 at different times. In such embodiments the segmented part may be moved in a progressive or alternating cyclical worm-like fashion along carried part 31.

With this mode of operation, some segments of segmented part 30 are static (not moving significantly with respect to the ground or carried part 31) while other segments of segmented part 30 are advanced by actuator units 25. In this case the portions of carried part 31 that extend between two static portions of segmented part 30 act as a guide for other segments of segmented part 30 are being moved. If the deployed part of line 12 follows a path that curves the engagement between the static portions of segmented part 30 with the ground and with carried part 31 resists departure of the line from the path (because the length of the portion of carried part 31 between two static portions of segmented part 30 is fixed due to the engagement of the static portions of segmented part 30 with the ground and with carried part 31).

Base 14 may operate to stabilize the path of the part of the deployed line 12 closest to base 14 by selectively holding carried part 31 in place so that base 14 effectively serves the role of a static portion of segmented part 30.

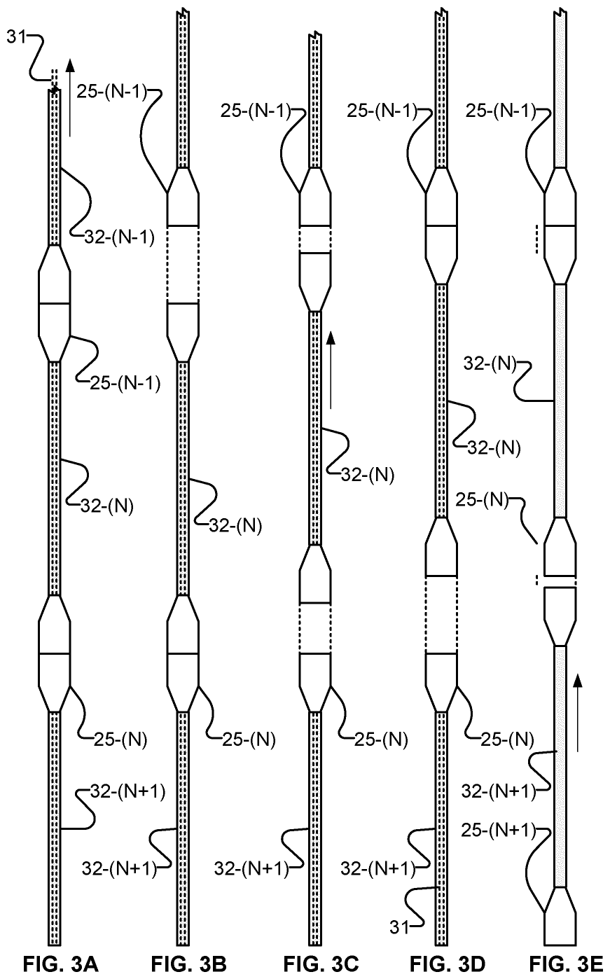

FIGS. 3A to 3E illustrate example stages of a method for operating system 10 to extend segmented part 30 and line 12. As described below, the illustrated method uses actuator units 25 that are distributed along the length of the deployed part of line 12 to advance segmented part 30 and carried part 31. As the deployed part of line 12 becomes longer, more remote actuator units 25 become available to help to advance line 12 further. As a deployed portion of segmented part 30 is advanced (e.g. as illustrated in FIG. 3A to 3E) additional segments may be added at the proximal end of segmented part 30 as explained herein.

The deployed portion of line 12 may be extended to virtually any length. The illustrated method allows different spans 32 of segmented part 30 (each span 32 comprising a plurality of segments 33 located between two remote actuator units that are operable to shift segmented part 30) to be advanced or retracted at different times.

FIGS. 3A to 3E show a section of line 12 that includes a remote actuator unit 25-(N) separated from a remote actuator unit 25-(N−1) by a first span 32-(N) of segmented part 30 and separated from a remote actuator unit 25-(N+1) by a second span 32-(N) of segmented part 30. Each span 32 of segmented part 30 comprises one or more segments 33 of segmented part 30. For example, a span may be made up of one to fifty or one to one hundred segments 33 of segmented part 30.

Each of remote actuator units 25-(N−1), 25-(N) and 25(N+1) includes a linear actuator that may be operated to extend the remote actuator unit from a retracted position (see FIG. 3A) to an extended position (see remote actuator unit 25-(N−1) in FIG. 3B). Extending the remote actuator unit causes ends of the remote actuator unit to become separated by a longer distance along line 12. The linear actuator may also be operated to retract the remote actuator unit from the extended position to the retracted position, thereby bringing opposing ends of the remote actuator unit closer together.

In FIG. 3A all of the illustrated remote actuator units 25 are in the retracted configuration. In FIG. 3B remote actuator unit 25-(N−1) has been extended and this has caused span 32-(N−1) to advance. In FIG. 3C, remote actuator 25-(N) is being extended and remote actuator unit 25-(N−1) is simultaneously being retracted. This coordinated action causes span 32-(N) to advance until the configuration of FIG. 3D is reached. In FIG. 3E remote actuator 25-(N) is being retracted and remote actuator unit 25-(N+1) is simultaneously being extended. This coordinated action causes span 32-(N+1) to advance.

It can be appreciated that the sequence illustrated by FIG. 3A to 3E may be continued to cause spans 32 of segmented part 30 which extend along the entire length of the deployed part of line 12 to be advanced one by one. The method illustrated by FIGS. 3A to 3E may be performed in reverse to retract segmented part 30.

It is also possible to perform the method illustrated by FIGS. 3A to 3C simultaneously to advance spans 32 in different parts of segmented part 30. As an example, spans 32 may be advanced in waves which start by advancing a span at a distal end of segmented part 30 of a line 12 and advancing subsequent spans 32 sequentially, working toward the proximal end of segmented part 30. When an M^{th} span from the distal end of segmented part 30 has been advanced (where M^{th} can be 2^{nd}, 3^{rd}, 4^{th} etc.) another wave may be started by further advancing the span at the distal end of segmented part 30. Many other patterns are possible. For example, it is not necessary to start different waves so that the advancement of different spans in different waves commences at the same time. The phases of advancing segments 32 in different waves may be shifted relative to one another.

### Example Apparatus and Methods for Moving Carried Part

As discussed above, remote actuator units 25 may comprise attachment elements that hold carried part 31 of line 12. Some embodiments include selectively operated grippers. Some embodiments include clamps or other attachment structures intended to maintain a continuous grip on carried part 31. Such attachment elements may be applied to hold a part of segmented part 30 to carried part 31 to serve as an anchor for moving an adjacent segment of segmented part 30 and/or to help to advance or retract carried part 31 of line 12. The length of the portion of carried part 31 between adjacent grippers is fixed. This facilitates path stability since a span being advanced along this portion of carried part 31 cannot take a path that is longer or shorter than that followed by the portion of carried part 31.

In some embodiments, remote actuator units 25 include both grippers or other attachment elements and linear actuators. In some embodiments, remote actuator units of a first type that include grippers or other attachment elements are used together with remote actuator units of a second type that include linear actuators.

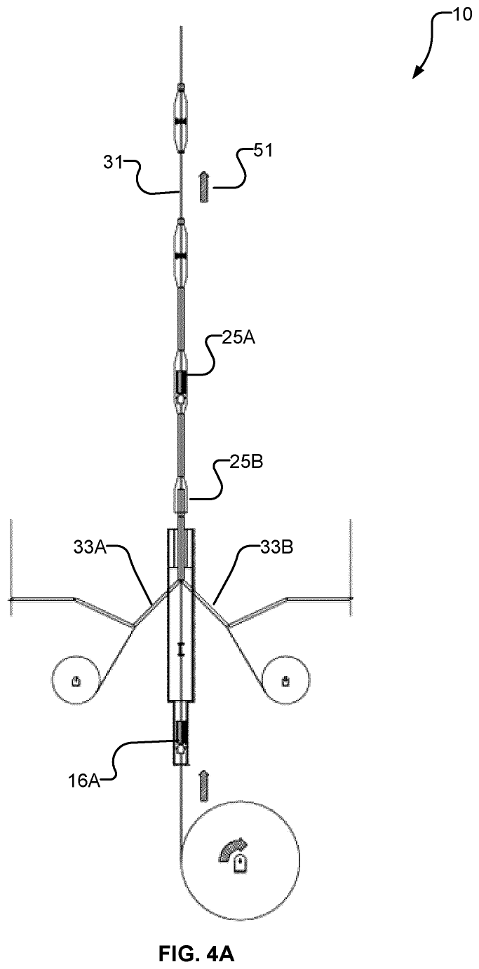

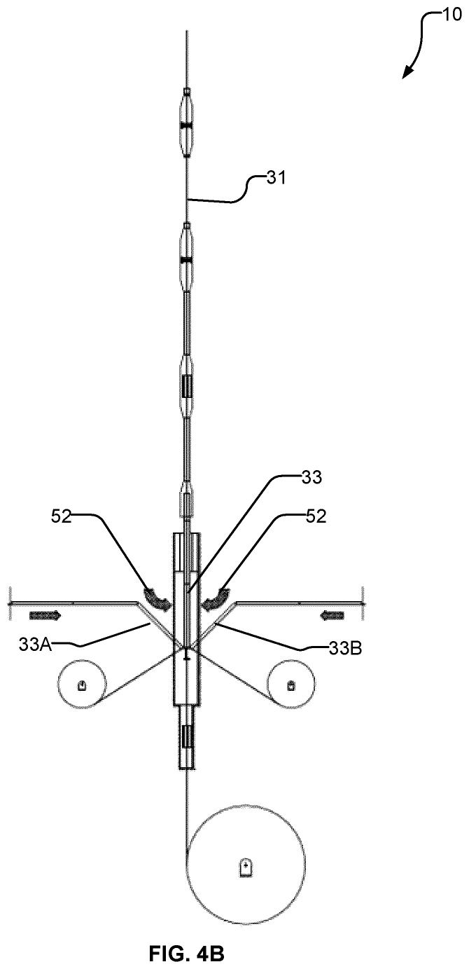

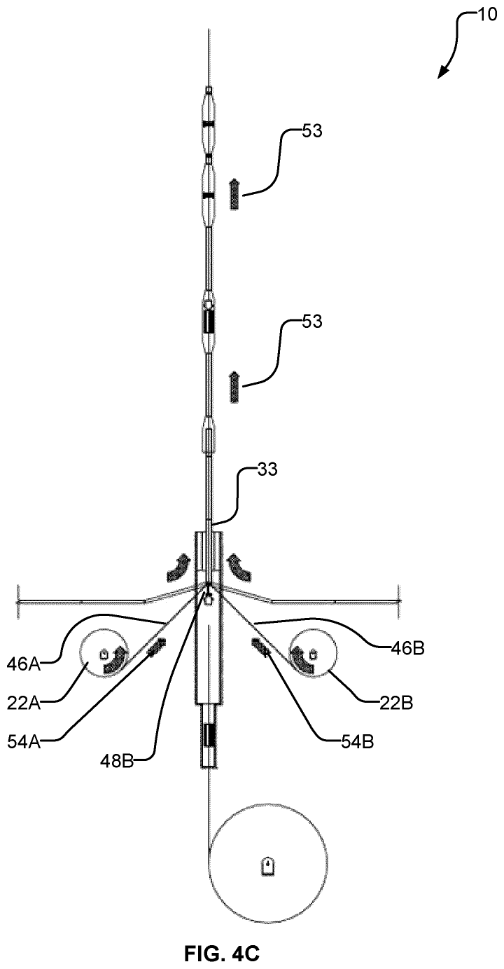

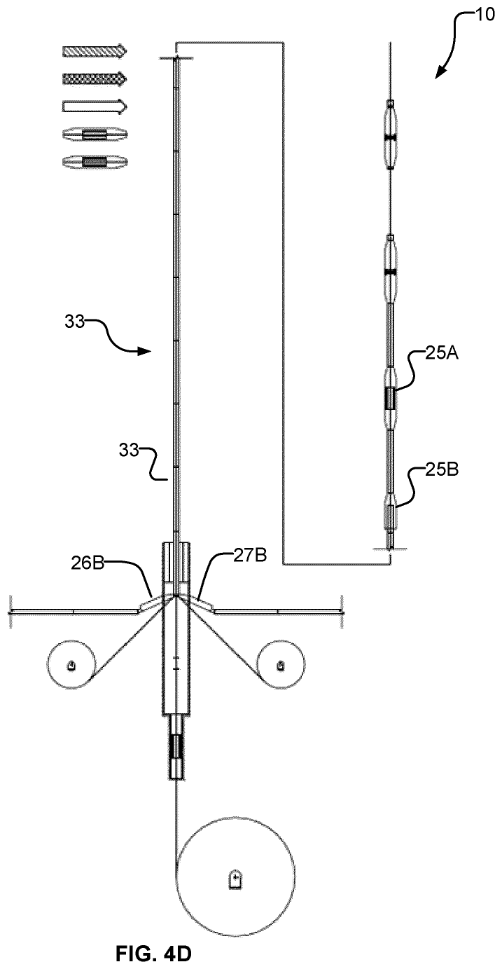

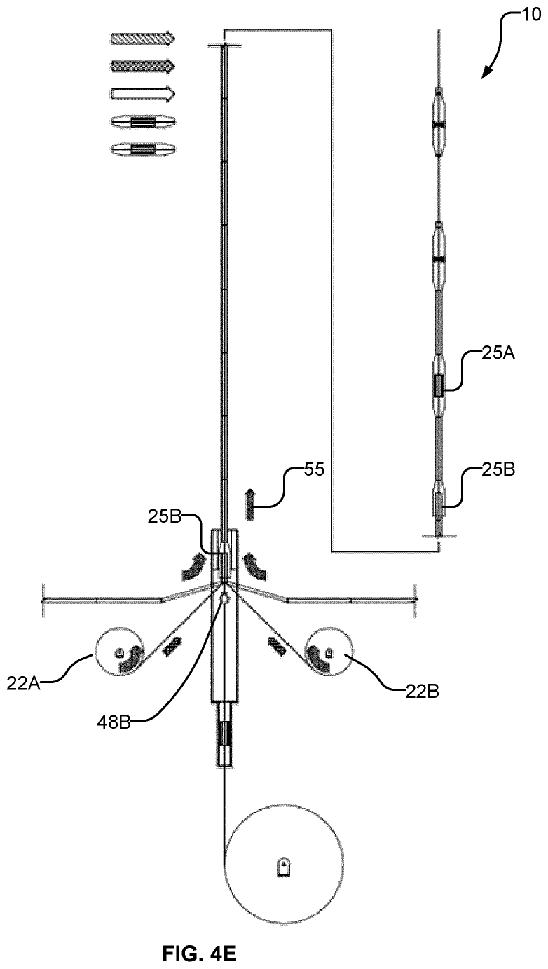

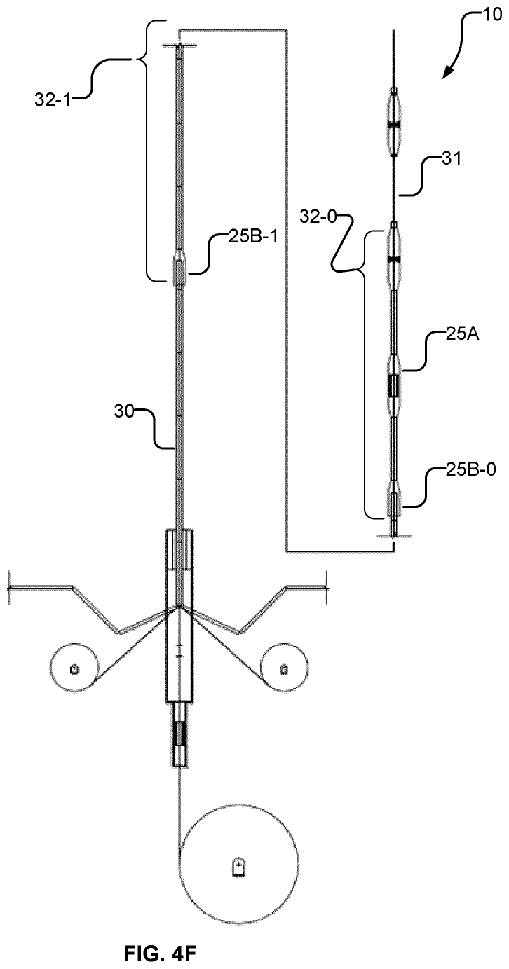

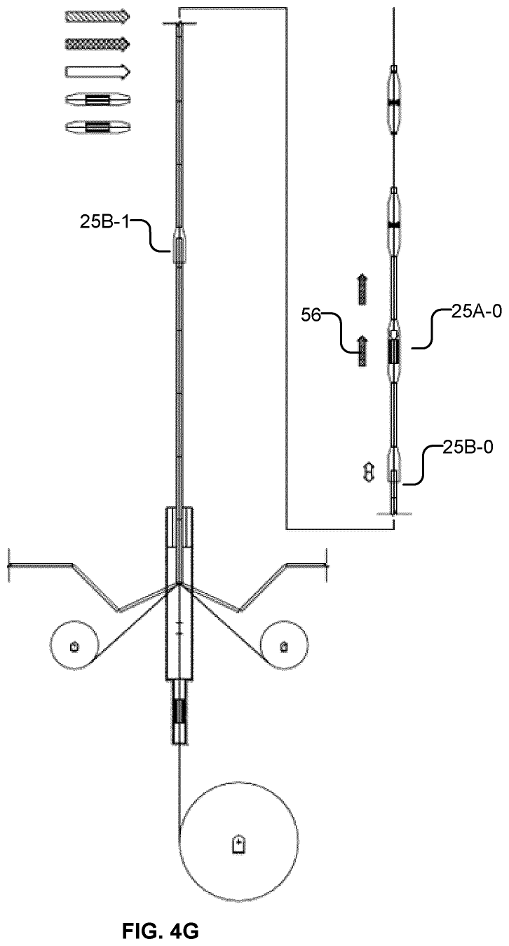

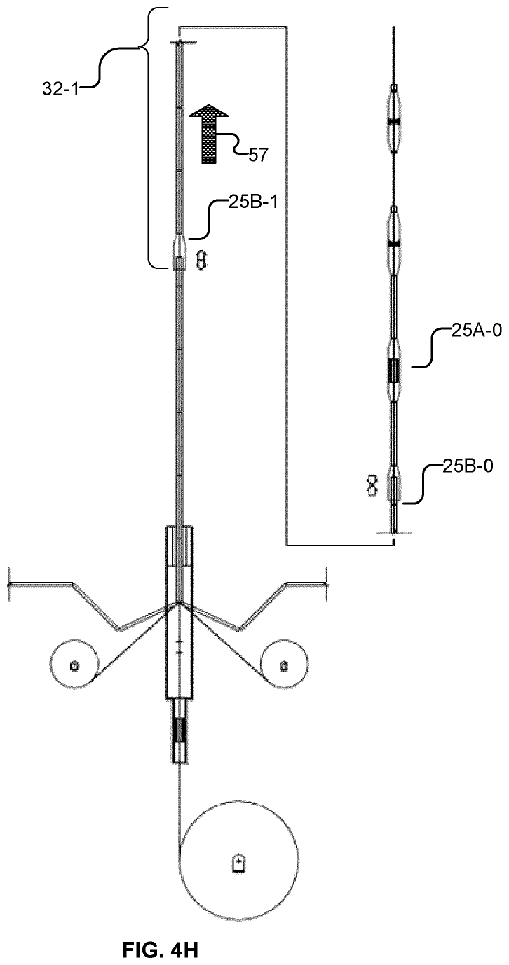

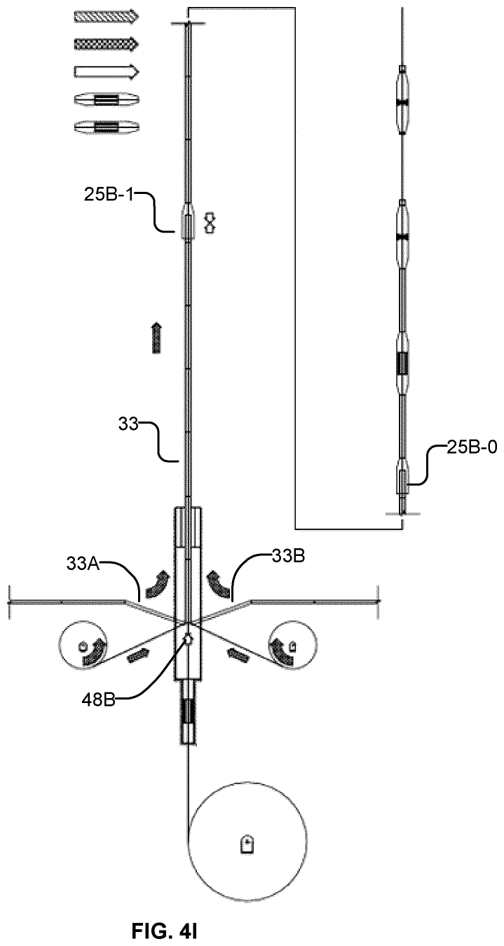

PPUs 25A spaced apart along line 12 (see e.g. FIG. 4A) may, for example be used to advance carried part 31 by extending an actuator that is coupled to an attachment element on carried part 31 from a retracted position to an extended position. The actuator may then be returned to its retracted position while the PPU 25A is being advanced together with segmented part 30 without moving carried part 31. With this movement pattern, it is not necessary for the attachment element to release carried part 31 in this process.

Where the attachment element comprises a selectively operable gripper, carried part 31 may, for example be advanced by: opening the gripper, moving the gripper in a proximal direction (toward base 14), operating the gripper to grip carried part 31, and moving the gripper in a distal direction. This may be done in unison by a plurality of or all PPUs 25A. These steps may be repeated to advance carried part 31 by an arbitrary amount without necessarily moving segmented part 30.

In some embodiments a PPU 25A includes two selectively actuated grippers that may be operated so that while one of the grippers is gripping carried part 31 and moving in a first direction to advance (or retract) carried part 31, the other gripper is not gripping carried part 31 and is moving in a second direction opposite to the first direction to a position for starting another stroke. In some such embodiments, plural PPUs 25A that have this construction may be operated cooperatively to advance or retract carried part 31. In such embodiments carried part 31 may be substantially continuously advanced (or retracted).

Multiple PPUs 25A spaced apart along a deployed part of line 12 may be operated simultaneously to advance carried part 31. Because force applied by PPUs 25A can be distributed along the length of carried part 31 the available force can automatically be scaled to match the deployed length of line 25. Also, the distributed forces can avoid or reduce problems caused by the capstan frictional effect that is well understood to impede the advancement of a flexible tensioned member following a non-linear path defined by static boundaries and/or the inverted capstan effect for compression on a semi-flexible member confined by a cylinder and/or compressive helical buckling lock. These problems are well known in relation to coiled tubing in the oil & gas industry.

PPUs 25A may be also used to retract carried part 31. Where PPUs 25A include selectively operable grippers, retraction of carried part 31 may be accomplished, for example, by: opening the grippers, moving the grippers in the distal direction, operating the grippers to grip carried part 31 and then moving the grippers in the proximal direction.

CSUs 25B may be operated as illustrated in FIGS. 3A to 3E to advance or retract segmented part 30. For example, segmented part 30 may be retracted to expose a portion of carried part 31 that will be operated to generate a fire wall (e.g. by spraying water and/or fire retardant from nozzles 20 on the exposed part of carried part 31. Segmented part 30 may also be extended or retracted relative to carried part 31 in the course of extending or retracting line 12.

### Example Method for Extending a Line

FIGS. 4A through 4I illustrate one example of initial steps that may be performed to extend line 12 in a system 10 of the type illustrated in FIG. 2. In FIG. 4A carried part 31 is advanced as indicated by arrow 51. This may be achieved, for example, by moving pipe gripper 16A to a retracted position, gripping carried part 31 with pipe gripper 16A, driving pipe gripper 16A forward, and releasing pipe gripper 16A (and optionally gripping carried part 31 with pipe gripper 16C). These steps may be repeated to feed out a desired length of carried part 31.

If one or more PPUs 25A have already been deployed in segmented part 30 then those PPUs may help to advance carried part 31, for example as described above.

Another example mechanism for advancing or retracting carried part 31 comprises feed rollers (not shown). Carried part 31 may be gripped between feed rollers and driving the feed rollers to counter rotate.

In FIG. 4B, opposing parts 33A and 33B of a segment 33 of segmented part 30 are brought together on either side of carried part 31 and coupled together as indicated by arrows 52.

In FIG. 4C segmented part 30 is advanced by pushing with launch shoe 48B as indicated by arrows 53. As segmented part 30 is being advanced, carried part 31 may be held in place (e.g. by pipe gripper 16A or pipe gripper 16C). As segmented part 30 is being advanced, umbilicals 46A, 46B may be fed out of reels 22A and 22B as indicated by arrows 54A and 54B. If one or more PPUs 25A have already been deployed then the deployed PPU(s) 25A may be actuated in reverse to assist advancement of segmented part 30.

The steps illustrated in FIGS. 4B and 4C may be repeated until carried part 31 and segmented part 30 have been advanced by a desired number of segments 33 to make up a span 32 of segmented part 30. The lengths of spans 32 may be selected based on factors such as the nature of the terrain into which line 12 is being deployed, the specifications of the components of line 12 (e.g. the force that can be delivered by CSUs, the stiffness of segments 33, the weight per unit length of line 12 etc.), the desired path, etc. After the span of segmented part 30 has been completed a CSU 25B may be inserted between the last segment 33 of the span 32 and the next segment 33 of segmented part 30.

FIG. 4D illustrates system 10 as a CSU 25B is being added. CSU 25B is made up of first and second parts 26B, 27B that are connected inline with corresponding parts 33A, 33B of segments 33 and are coupled together around carried part 31.

In FIG. 4E, CSU 25B has been assembled around carried part 31 and connected in line with segmented part 30, including the newly added CSU 25B is advanced as indicated by arrow 55 by pushing with launch shoe 48B.

After CSU 25B has been advanced, additional segments 33 of segmented part 30 may be added (e.g. by repeating the steps illustrated in FIGS. 4B and 4C). FIG. 4F illustrates a configuration of system 10 after several more segments 33 of segmented part 30 have been assembled around carried part 31.

There is a limit to how far line 12 can be extended by pushing from base 14. That limit is reduced if the path taken by line 12 is not straight. To avoid this limit, any time after a first CSU 25B has been deployed in segmented part 30 different spans 32 of segmented part 30 may be advanced in a sequence at different times as described elsewhere herein. Similarly, one or more PPUs 25A may be deployed near the distal end of segmented part 30. As soon as a PPU 25A has been deployed, that PPU may assist in advancing carried part 31.

Before the deployed length of segmented part 30 becomes too long to advance segmented part 30 effectively by pushing from base 14, system 10 may be controlled to advance segmented part 30 incrementally using CSUs 25B.

Before the deployed length of carried part 31 becomes too long to advance carried part 31 solely by pushing from base 14, carried part 31 may be advanced periodically using PPUs 25A as described above. Where terrain is suitable by extending segmented part 30 incrementally and by using PPUs 25 distributed along segmented part 30 to advance carried part 31 it may be possible to extend line 12 for long distances (e.g. one kilometer, several miles or several kilometers or more).

In the following description individual spans 32 of segmented part 30 and individual actuator units 25A, 25B etc. are numbered sequentially starting at the distal end of line 12. For example, the first PPU 25A is numbered 25A-0, the first CSU 25B is numbered 25B-0, the first span 32 of segmented part 30 is numbered 32-0 and so on.

FIG. 4F illustrates a configuration from which span 32-0 may be advanced without moving the remainder of segmented part 30. First CSU 25B-0 is retracted. As shown in FIG. 4G, span 32-0 may be moved toward the distal end of line 12 as indicated by arrows 56 by extending first CSU 25B-0. Optionally, a PPU (e.g. PPU 25A-0) located in first span 32-0 may be controlled in coordination with CSU 25B-0 to grip and pull on carried part 31 to help advance span 32-0.

Successive spans 32 may subsequently be moved toward the distal end of line 12 one at a time without moving other parts of segmented part 30. FIG. 4H illustrates movement of span 32-1 as indicated by arrows 57. The movement of span 32-1 is caused by retracting CSU 25B-0 and simultaneously extending CSU 25B-1. Optionally a PPU in span 32-0 (e.g. PPU 25A-0) is operated to grip and hold carried part 31 while span 32-1 is being moved. This movement may be repeated for subsequent spans 32-2, 32-3 etc. up to the last full span before base 14. This sequence of movements may be repeated until the deployed portion of segmented part 30 has advanced by a distance that is at least equal to the length of the next component to be added to segmented part 30. In some embodiments it may take two or more strokes of each CSU 25B to advance segmented part 30 by the length of one segment 33.

After the last full span 32 before base 14 has been shifted in the distal direction by a sufficient distance, the CSU 25B closest to base 14 will be extended as shown for CSU 25B-1 in FIG. 4I. From this configuration an additional segment 33 of segmented part 30 may be assembled around carried part 31. The portion of segmented part 30 between base 14 and the closest CSU 25B may then be moved in the distal direction by pushing the just assembled casing segment 33 forward with loading shoe 48B in coordination with retracting the closest CSU 25B. The portion of segmented part 30 distal relative to closest CSU 25B may remain stationary while the just assembled casing segment 33 is moved forward. The portion of carried part 31 between base 14 and the closest CSU 25B serves as a guide for the portion of segmented part that is proximal to closest CSU 25B.

By repeating the steps illustrated in FIGS. 4G, 4H and 4I (and, as necessary, further extending carried part 31 using PPUs 25A and/or propulsion unit 16) any desired number of segments 33 may be added to segmented part 30. This may be done while moving only one span 32 at a time or only moving a selected subset of spans 32 at the same time.

PPUs 25A may be added as line 12 is extended (e.g. one or more PPUs 25A may be provided for each span 32 or for each few spans 32). Where system 10 includes distributed PPUs 25A spaced apart along line 12 the force available for advancing carried part 31 is distributed along the deployed length of line 12, thereby reducing the risk that advancement of carried part 31 will be impeded by excessive axial forces due to any or all of: cumulative sliding friction, the capstan effect if the path is curved or buckling lock due to excessive compression even for a straight path. In addition, the available force increases with the number of PPUs. The combination of the above features allows long lengths of line 12 to be deployed without requiring assistance of any personnel or equipment away from base 14.

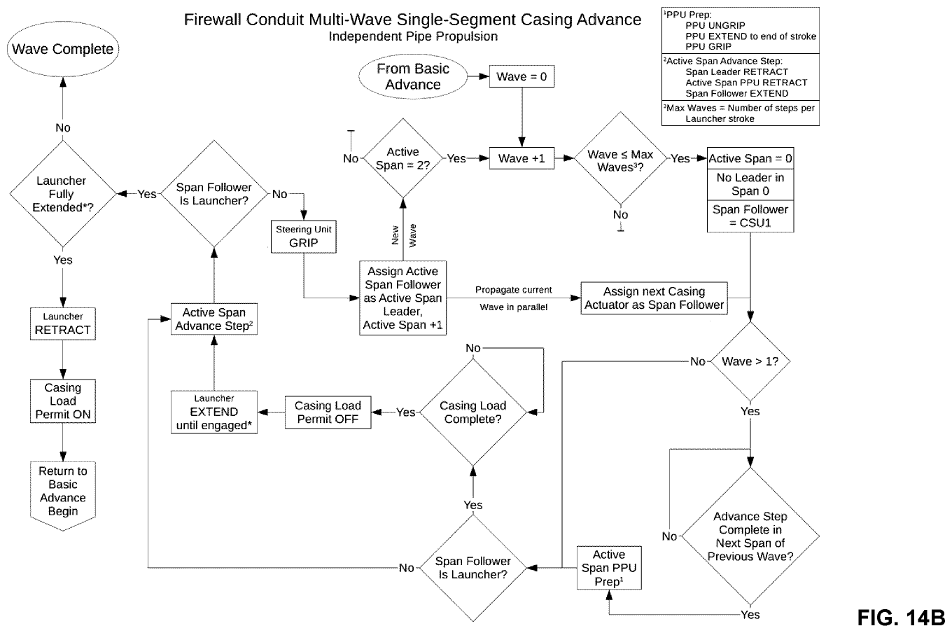

FIGS. 14A and 14B are flow charts for example control algorithms that may be executed by a controller 132 and/or by an operator to control system 10 to advance line 12.

An example process for deploying line 12 by carried part 31 advance, progressive advance of individual spans 32 of segmented part 30 and adding new segments 33 to segmented part 30 is detailed in the flowchart of FIG. 14A.

If the deployed part of line 12 includes three or more spans 32 of segmented part 30 then deployment can be expedited by simultaneously advancing plural spans 32 while maintaining at least one static (non-moving) casing span 32 between any two advancing spans 32, The static spans 32 act as anchors for actuation reaction forces.

Simultaneous advance of plural casing spans 32 may be accomplished using a progressive multi-wave advance method such as the method detailed in the flowchart of FIG. 14B.

Once casing span 32-1 has fully advanced, a second wave of casing advance can commence at casing span 32-0 and progress toward base 14. Additional casing advance waves can follow, each maintaining a 2-span separation from the preceding wave, thus maintaining at least one static anchor casing span 32 between simultaneously advancing casing spans 32.

It will be understood from the above description of the construction and operation of a line of the general type illustrated in FIG. 2 that once a leading (distal) portion of line 12 has been deployed along a path, subsequent parts of the line will tend to follow the same path. In this embodiment, carried part 31 is a flexible member that extends longitudinally and follows the path as the line 12 is deployed. The segments 33 of spans 32 contact the ground and thereby provide a plurality of ground contacting portions which are each coupled to move longitudinally along carried part 31. As line 12 is advanced one set of spans 32 is kept static and may be fixed relative to the ground and to the carried part. In this configuration carried part 31 resists being moved off of the path since the lengths of the portions of the carried part that extend between adjacent static spans 32 are fixed (the static spans 31 are held in place on the ground by friction and the carried part 31 tends not to move relative to the static spans 32 due to friction and/or gripping by a PPU 25A). Therefore, changes in the curvature of any curves in carried part 31 between the static spans 32 or between base 14 and the static span 32 nearest to base 14 are resisted. The advancing spans 32, which are located between static spans 32 are therefore guided by the carried part to follow the path.

In the embodiment of FIG. 2, CSUs 25B can be considered to be driver units that include actuators operable to move a corresponding one of the ground contacting portions longitudinally along the line relative to at least one other one of the ground contacting portions,

### Examples of Steering

As line 12 is advanced, it may be necessary to steer line 12, for example to cause line 12 to follow a desired path and/or to avoid obstacles. Steering may be accomplished by one or more of:
a) operating a steering unit 25C to turn a curved leader 41 at the distal end of line 12 to face in a desired direction of turning as carried part 31 is advanced;
b) operating one or more casing articulation units 25D to cause a portion of segmented part 30 to bend in a way selected to cause line 12 to follow a desired path;
c) providing and operating ground engaging wheels, pushers, legs or the like to displace a portion (e.g. a leading end) of line 12 in a desired direction.

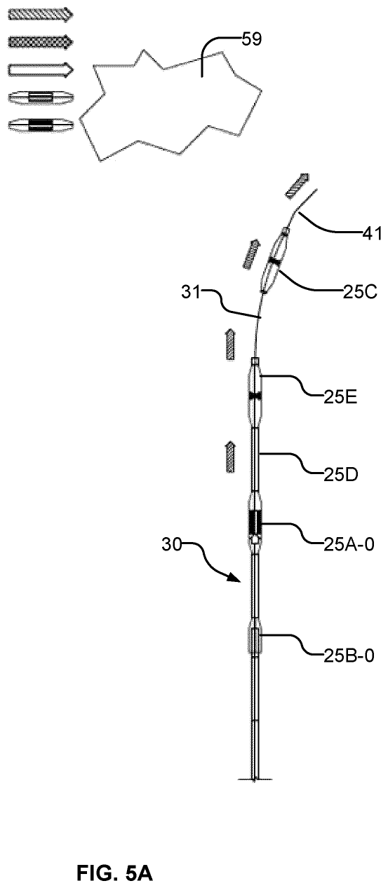

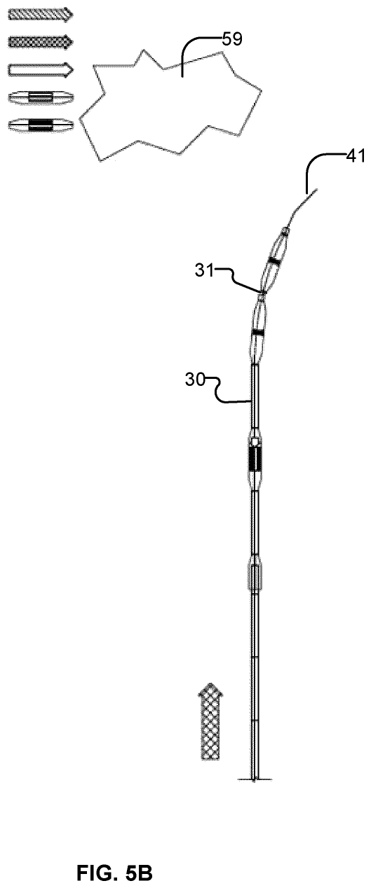

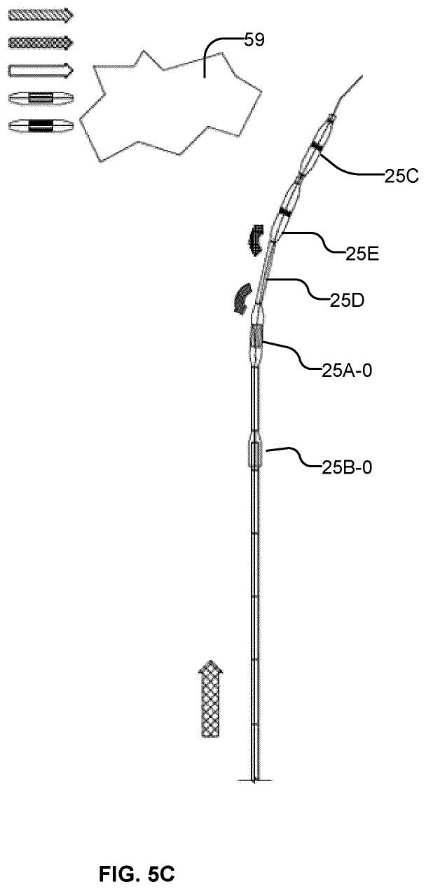

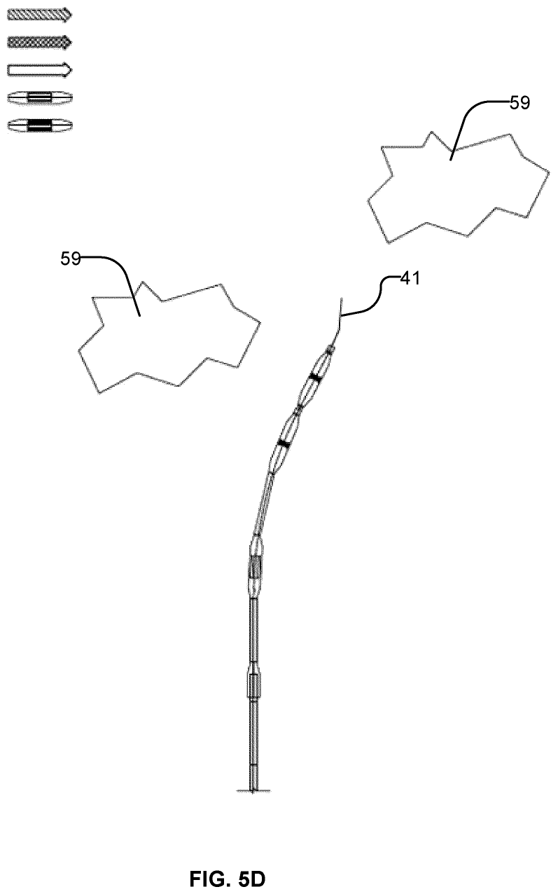

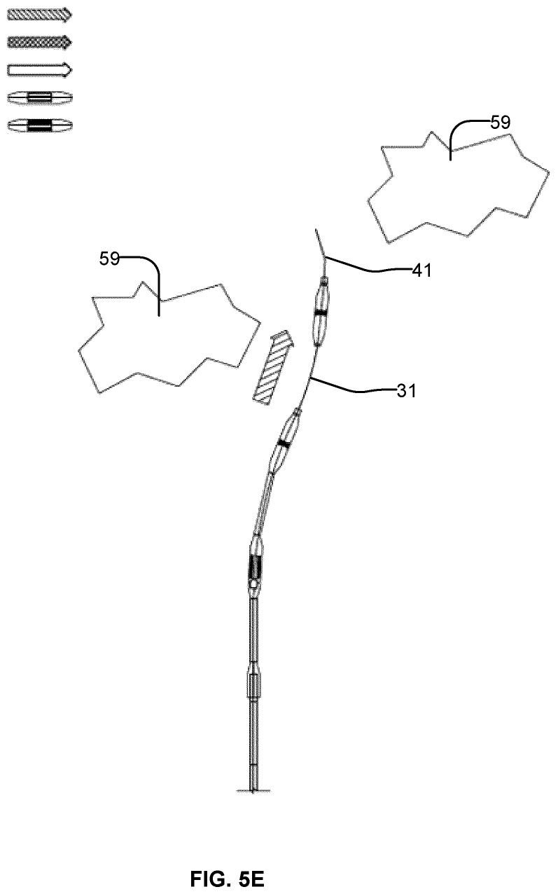

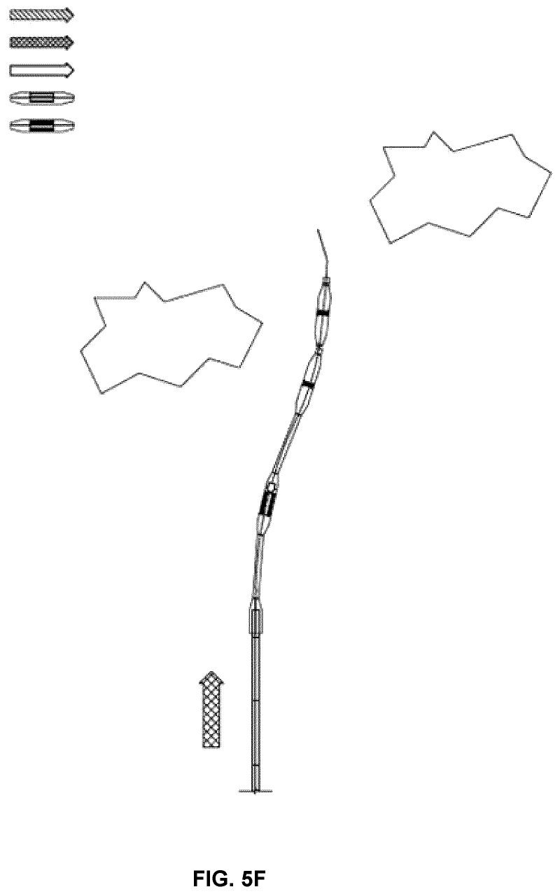

FIGS. 5A to 5F illustrate an example way to steer the distal end of line 12. In FIG. 5A line 12 has been extended to a point where the distal end of line 12 is near an obstacle 59. Leader 41 has been turned to face to the right in order to cause carried part 31 to curve to the right to avoid obstacle 59 as carried part 31 is extended. In FIG. 5A carried part 31 is being extended through segmented part 30 which remains fixed.

Leader 41 may, for example, be turned to face a desired direction by one or a combination of rotating leader 41 relative to carried part 31 by leader steering actuator 25C and rotating the distal end of carried part 31 about its longitudinal axis by actuator unit 25E.

As shown in FIG. 5B, when carried part 31 has been extended sufficiently, carried part 31 may be held fixed while segmented part 30 is advanced. Segmented part 30 follows carried part 31, fully or partially depending on factors such as the relative flexural stiffness of carried part 31 and segmented part 30. In FIG. 5C, casing articulation unit 25D is being operated to set the angles between casing articulation unit 25D and adjacent parts of segmented part 30 (in this example PPU 25A-0 and actuator unit 25E) such that segmented part 30 is curved to follow carried part 31. In some embodiments casing articulation advantageously affects more than one adjacent segmented part 30.

FIGS. 5D and 5E illustrate causing line 12 to continue from the configuration of FIG. 5C to follow an S-curve, for example to steer between two obstacles 59. In FIG. 5D leader 41 is turned to face to the left. In FIG. 5E, carried part 31 is advanced. Leader 41 causes the projecting portion of carried part 31 to curve to the left, between obstacles 59. In FIG. 5E, segmented part 30 is being advanced. In FIG. 5F, segmented part 30 is fully advanced and the distal end of line 12 is oriented to facilitate further advance of line 12 between obstacles 59.

After line 12 has been positioned to extend along a desired path, segmented part 30 may be retracted, for example as described above, to expose a distal section of carried part 31. Fluid (e.g. water and/or fire retardant) may then be pumped through carried part 31 to be sprayed through nozzles 20 that are spaced apart along at least a distal portion of carried part 31.

### Examples of Exposing Carried Part

In some applications, segmented part 30 may be partially or completely withdrawn after line 12 has been deployed while leaving carried part 31 in place. Carried part 31 may then be used, for example to deliver fluid, power, signals etc. The same components of segmented part 30 may be reused to deploy (and optionally to later retrieve) any number of carried parts 31.

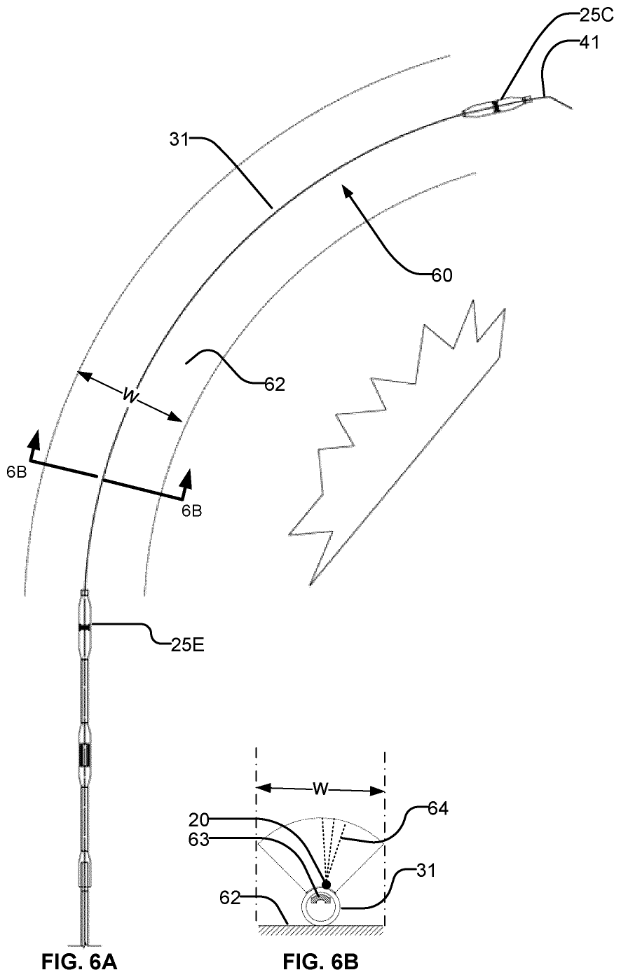

FIGS. 6A and 6B illustrate a distal end part of line 12 in which segmented part 30 has been retracted to expose a distal portion 60 of carried part 31. Nozzles 20 spray fluid over a corridor 62 having a width W. Coverage of corridor 62 may be accomplished by providing nozzles 20 that have a diverging spray pattern 64, providing nozzles 20 that are circumferentially distributed around at least a portion of the circumference of carried part 31 and/or oscillating carried part 31 (e.g. by one or more actuator units 25C, 25E) to sweep sprays 64 from side to side as indicated by arrow 63. Distal portion 60 may be of arbitrary length. Corridor 62 may provide a fire break, an escape corridor or the like.

In some embodiments a first remote actuator unit (e.g. PTU 25E) is located at or near to the distal end of segmented part 30 and a second remote actuator unit (e.g. leader steering actuator 25C) is located at or near the distal end of the exposed distal section 60 of carried part 31. The first and second remote actuator units 250, 25E may be operated in coordination to orient nozzles 20 and/or to oscillate the circumferential angle(s) of nozzles 20.

Where it is desired to deliver a large volume of fluid using nozzles spaced apart along the length of a conduit (e.g. a pipe used as carried part 31) an issue that can arise as the deployed length of the conduit is increased is that pressure at a distal portion of the conduit may be reduced to below a desired level due to factors such as exit of fluid at upstream nozzles and drag within the conduit. These factors can be at least partially offset by increasing a pressure at which the fluid is delivered at the proximal end of the conduit. However, the safe working pressure of the conduit limits the pressure.

In some embodiments valves are used to control what nozzles 20 are active at any given time. By closing some nozzles 20 and opening other nozzles 20 fluid pressure at the open nozzles 20 may be increased. For example, nozzles 20 may be held closed and groups of the nozzles 20 may be opened intermittently. A controller may control the valves which open and close nozzles 20 so that a desired volume of fluid at a desired pressure is delivered by each nozzle 20. The controller may control the opening and closing of nozzles 20 based in part on feedback from one or more pressure sensors in the conduit. For example, the controller may control nozzles 20 in two or more groups with each group of nozzles 20 turned on and off at the same time. The controller may decrease the length of time that one or more or all of the groups of nozzles is on to maintain a threshold operating pressure at a distal end of the conduit.

### Example Segment Construction

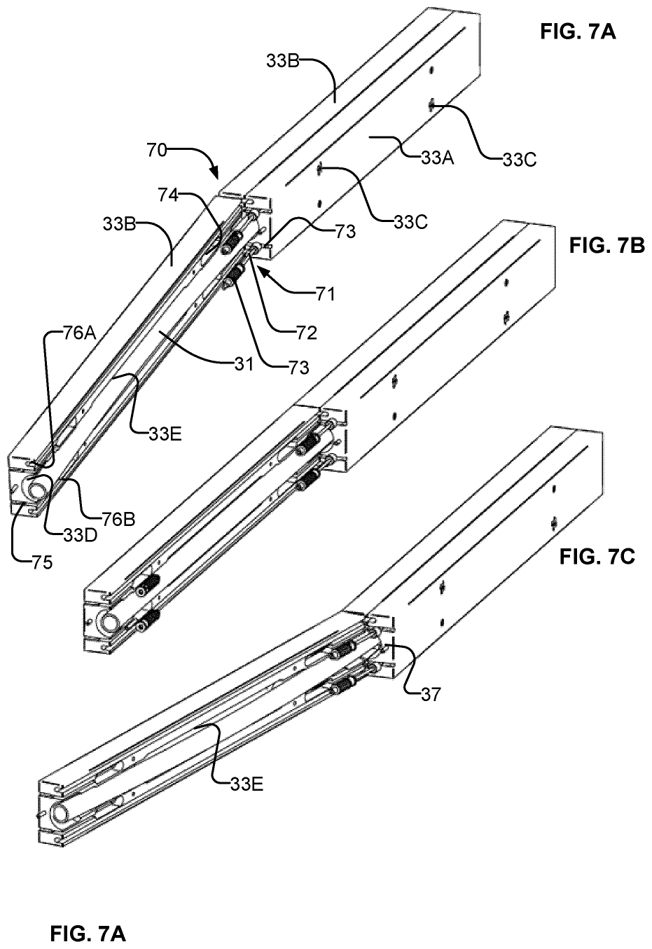

FIGS. 7A to 7C show an example structure for segments 33. In this example embodiment, segments 33 comprise elongated first and second parts 33A and 33B arranged to open as a clamshell and to be closed around carried part 31. One or more latch mechanisms 33C is provided to hold first and second parts 33A, 33B closed around carried part 31. Latch mechanisms 33C may, for example comprise fastening means such as:
a) one or more hinges and one or more latches;
b) one or more fasteners such as bolts, screws, nuts, studs, threaded openings;
c) two or more latches;
d) clamps;
e) wedges;
f) pins;
g) etc.

Grooves 33D extend along inner faces of first and second parts 33A, 33B. Grooves 33D are dimensioned to receive carried part 31 between first and second parts 33A and 33B with enough clearance to allow carried part 31 to slide along the channel defined by grooves 33D inside the closed segment 33. Grooves 33D preferably provide increased clearance around carried part 31 to allow carried part 31 to flex inside the segment 33 when segmented part 30 is curved. In some embodiments, the channel formed between grooves 33D has a double hourglass shape in cross section such that the channel is larger in width in a central portion 33E and at ends of a segment 33. Narrowed portions of the channel more tightly constrain the position of carried part 31 and thereby tend to keep carried part 31 approximately centered in the channel and/or reduce the likelihood that carried part 31 will buckle in a way that interferes with carried part 31 sliding in the channel.

Adjacent segments 33 are coupled together by couplings 70. Couplings 70 may have a wide range of constructions. Couplings 70 are constructed to hold adjacent components of segmented part 30 (e.g. adjacent segments 33, adjacent segment 33 and actuator unit 25 etc.) together.

Advantageously, couplings 70 may be constructed to allow segmented part 30 to flex by a desired amount. For example, FIG. 7A illustrates flex in an up-down direction. FIG. 7C illustrates flex in a side to side direction. Couplings 70 may also act as hinges to allow parts 33A and 33B to pivot as they are attached around or removed from carried part 31 (e.g. as described above).

In the embodiment illustrated in FIGS. 7A to 7C, coupling 70 comprises a plurality of elastically extensible elements 71. Four elements 71 are shown in each coupling 70. Elastically extensible elements 71 may, for example comprise spring loaded rods or cables.

In the illustrated embodiment the elastically extensible elements comprise tendons 72 that are maintained under tension by spring packs 73. For example, tendons 72 may extend between compression spring packs 73 located at opposing ends of tendons 72. Spring packs 73 are received in recesses 74. Tendons 72 extend into adjacent casing segments 33 through openings 75. Openings 75 are in the form of transversely extending slots which allow couplings 70 to act as hinges between adjacent segment parts 33A or 33B.

Tendons 72 may be preloaded in a neutral, non-flexed configuration of coupling 70. Flexing of coupling 70 as illustrated for example in FIGS. 7A and 7C causes at least some of tendons 72 to be placed in increased tension, thereby compressing the corresponding spring packs. This creates a restoring moment which tends to return coupling 70 to the non-flexed configuration. In some embodiments tendons 72 comprise sections of wire rope or rods (e.g. nylon rods).

Coupling 70 may be designed to limit flex between adjacent segments 33. For example, flexing may be restricted by stops (not shown) which limit travel of tendons 72. Stops may, for example, be provided by tubes through which portions of tendons 72 pass. Couplings 70 may, for example, be designed to allow flex through a small angle such as, for example, an angle up to about 7 to 10 degrees.

FIGS. 7A to 7C also show grooves 76A and 76B which may receive umbilicals 46A and 46B respectively.

An anti-rotation element is optionally provided to limit twist (relative rotation around carried part 31) of adjacent segments 33. For example, the anti-rotation element may comprise a pin 37 (see FIG. 7C) Pin 37 may, for example, engage in an arcuate groove (not shown) in the end of an adjacent segment 33. The permitted range of twisting motion is limited by a length of the groove. In some embodiments tendons 72 that couple adjacent segments serve as anti-rotation features. In such embodiments, tendons 72 may, for example, comprise semi-stiff rods such as nylon, fiberglass, acetal or steel rods.

In some embodiments a segment 33 includes one or more flex sections at which the segment 33 can flex. The flex sections may be biased toward a straight configuration. Actuators may be provided to flex the segment 33 about one or more or all of the flex sections. Flex sections may be spaced apart along the length of a segment 33, be located near one or both ends of a segment 33, and/or be located centrally in a segment 33.

In some embodiments the combination of segmented part 30 and carried part 31 has a minimum radius of curvature of about 5 to 10 m.

### Example PPU Construction

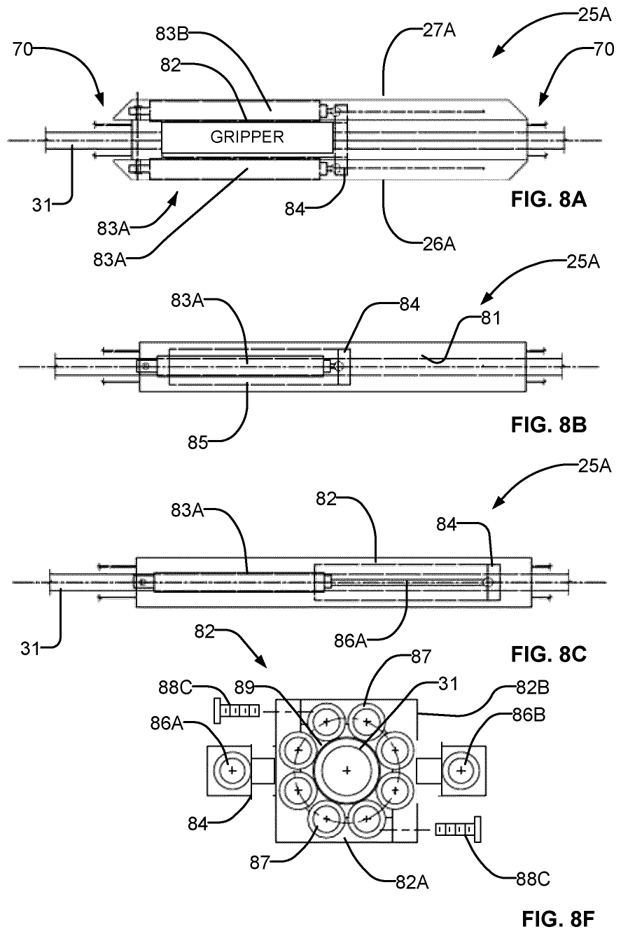

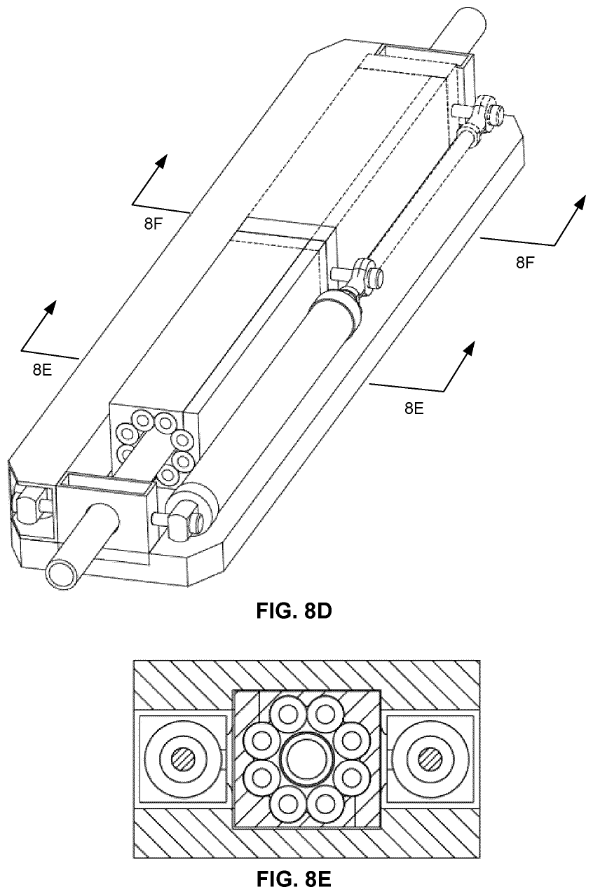

FIGS. 8A to 8F are schematic illustrations showing an example construction for a PPU 25A. PPU 25A comprises first and second parts 26A and 27A. Parts 26A and 27A may be fastened in line with other parts of segmented part 30, for example by way of couplings 70 such as those described above. Parts 26A and 27A may be closed around carried part 31 so that carried part 31 extends through a longitudinally extending passage 81 that passes through PPU 25A.

PPU 25A includes a gripper 82 operative to selectively firmly grip carried part 31. An actuator 83 is connected to move gripper 82 longitudinally along passage 81. Carried part 31 may be moved in either direction relative to PPU 25A by actuating gripper 82 to grip carried part 31 with gripper 82 at a first position along passage 81 and then operating actuator 83 to move gripper 82 in a desired direction along passage 81.

In the embodiment illustrated in FIGS. 8A to 8C, actuator 83 is provided by cylinders 83A and 83B which may, for example, be hydraulic or pneumatic cylinders. FIGS. 8A and 8B show cylinders 83A and 83B in a retracted configuration and FIG. 8C shows cylinders 83A and 83B in an extended configuration. Other types of actuator such as one or more: screw drives, linear motors, linear actuators, rack and pinion drives etc. may be provided to position gripper 82.

Gripper 82 may, for example, comprise: inflatable cuffs or bladders, gripping fingers, collets, etc.

Gripper 82 may be constructed to allow gripper 82 to engage carried part 31 without requiring an end of carried part 31 to be fed through gripper 82. For example, gripper 82 may comprise first and second parts that can be closed around carried part 31 as PPU 25A is engaged with carried part 21. In some embodiments, gripper 82 includes first and second parts 82A and 82B (see FIG. 8F) that are respectively attached to parts 26A and 27A of PPU 25A.

Parts 82A and 82B may be opened or separated to allow gripper 82 to receive carried part 31 as PPU 25A is added to segmented part 30. For example, each of parts 82A and 82B may comprise a frame or body that defines a bore that is split into two halves that may be separated to allow carried part 31 be received in the bore of gripper 82 and then fastened together. The halves may, for example be fastened by fastening means such as:
a) one or more hinges and one or more latches;
b) one or more fasteners such as bolts, nuts, studs, threaded openings;
c) two or more latches;
d) clamps;
e) pins;
f) etc.

In the illustrated embodiment, gripper 82 comprises a two-part header 84 comprising parts 84A and 84B respectively connected to cylinders 83A and 83B (in this example, rods 86A and 86B of cylinders 83A and 83B each engage a corresponding socket in parts 84A and 84B respectively).

As shown in FIG. 8D, gripper 82 may, for example, comprise elastomeric tubes 87 arranged in an annular space between a tubular outer housing 88 and carried part 31. Carried part 31 may be gripped by pressurizing tubes 87 so that tubes 87 swell and press against carried part 31. When tubes 87 are not inflated carried part 31 is free to slide through gripper 82. In some embodiments, tubes 87 are silicone tubes. Unreinforced silicone tubes advantageously can expand significantly without bursting when inflated and are reasonably durable.

In the illustrated embodiment, housing 88 comprises parts 88A and 88B that may be fastened around carried part 31 by bolts 88C. Tubes 87 are then confined in a space between the inside of housing 88 and carried part 31. Tubes 87 may be received in corresponding grooves on inner faces of parts 88A and 88B.

Tubes 87 may, be inflated to grip carried part 31 or deflated to release carried part 31. For example, tubes 87 may be connected to manifolding in header 84 by way of which a pressurized gas, water or other hydraulic fluid may be supplied to tubes 87 or allowed to escape from tubes 87. In the illustrated embodiment, a fabric liner 89 is provided between tubes 87 and carried part 31.

### Example CSU Construction

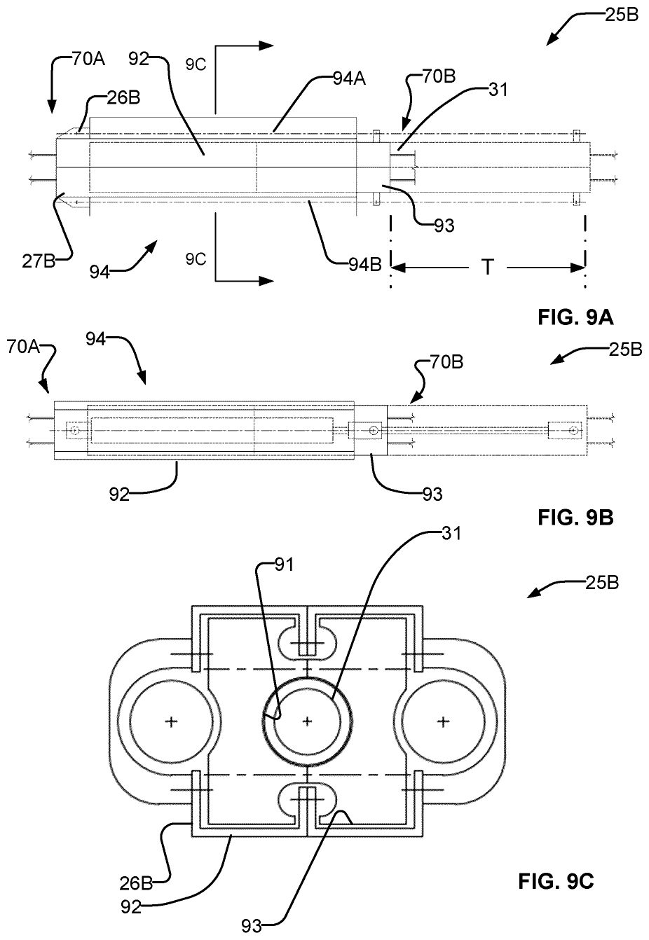

FIGS. 9A to 9C illustrate an example CSU 25B. CSU 25B includes first and second parts 26B and 27B that may be coupled together (for example as described herein with respect to segments 33 or PPU 25A). When coupled, first and second parts 26B and 27B define a passage 91 that extends longitudinally through CSU 25B and is dimensioned to accommodate carried part 31. Passage 91 is preferably oversize to accommodate curves in carried part 31. CSU 25B has couplings 70A and 70B at opposing ends for coupling CSU 25B in line with segmented part 30.

CSU 25B includes first and second segments 92 and 93 that are displaceable relative to one another in a longitudinal direction. For example, first and second segments 93, 93 may be telescopically engaged. An actuator 94 is coupled to drive relative longitudinal displacement of segments 92, 93. Actuator 94 may be able to drive CSU 25B between a retracted configuration (shown in solid lines) to an extended configuration (shown in dotted lines), thereby changing the separation of couplers 70A and 70B by a travel distance T.

Actuator 94 may comprise any suitable actuator such as those described elsewhere herein. In the illustrated embodiment actuator 94 comprises cylinders 94A and 94B which may, for example be hydraulic or pneumatic cylinders. Cylinders 94A and 94B are each coupled at a first end to segment 92 and coupled at a second end to segment 93. Cylinders 94A and 94B may be extended together to move CSU 25B toward its extended position. Cylinders 94A and 94B may be retracted together to move CSU 25B toward its retracted position.

### Example PTU Construction

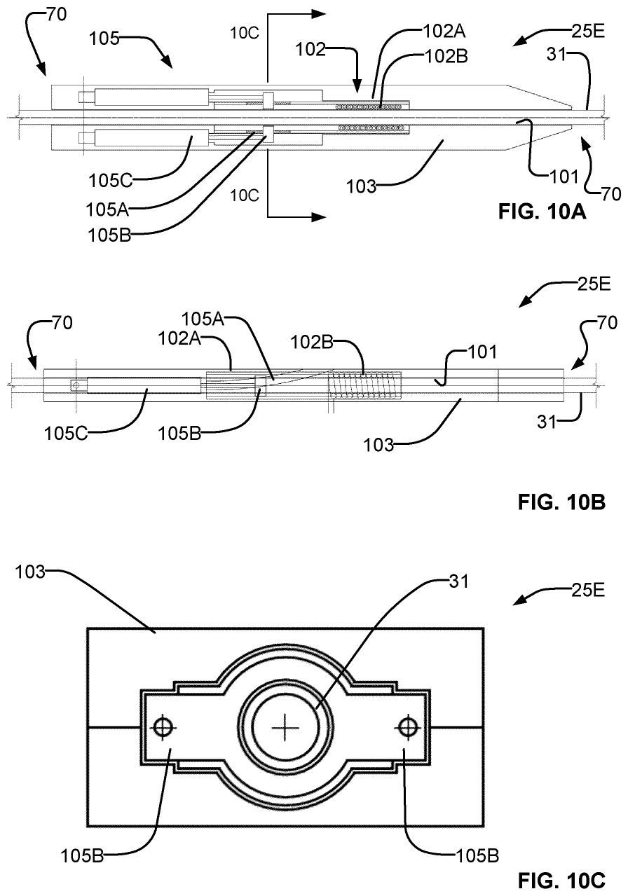

FIGS. 10A to 10C illustrate an example PTU 25E. PTU 25E that may be coupled inline with segmented part 30. A passage 101 extends longitudinally through PTU 25E and is dimensioned to accommodate carried part 31. PTU 25E has couplings 70 at opposing ends for coupling PTU 25E in line with segmented part 30.

PTU 25E includes a gripper 102 dimensioned to securely grip an outer surface of carried part 31. Gripper 102 is rotatable relative to a housing 103 of PTU 25E about a longitudinal centerline of carried part 31.

An actuator 105 is operable to alter the angle of rotation of gripper 102. Actuator 105 has an angular range of motion sufficient to rotate carried part 31 to achieve a desired twist of carried part 31. For example, actuator 105 may have a range of motion of +45 degrees or +60 degrees or +90 degrees.

By operating gripper 102 to grip carried part 31 and then operating actuator 105 to rotate carried part 31 in a desired direction about its longitudinal axis carried part 31 may be rotated to orient nozzles 20 in a desired direction and/or to steer line 12 as described above.

In the illustrated embodiment gripper 102 comprises a carrier 102A that is rotatable relative to housing 103 and carries gripping means for selectively gripping carried part 31. The gripping means may, for example, comprise inflatable cuffs or bladders, clamps, actuated gripping jaws, collets, band or strap clamps or the like. In the illustrated embodiment the gripping means comprise one or more elastic walled tubes 102B located in an annular region between carrier 102A and carried part 31. Carried part 31 may be gripped by pressurizing tubes 102B so that tubes 102B swell and press against carried part 31, thereby rotationally locking carried part 31 to carrier 102A. Tube(s) 102B may be wrapped helically around carried part 31. When tubes 102B are not inflated carried part 31 is free to slide through gripper 102.

Actuator 105 may comprise any suitable actuator for selectively rotating carrier 102A. For example, actuator 105 could comprise a worm drive, gear drive, direct drive motor, or the like.

In the embodiment illustrated in FIGS. 10A to 10C, actuator 105 comprises a helical track 105A on carrier 102A. Track 105A may, for example, comprise a helical groove, thread, ridge, or slot in carrier 102A. A linearly actuated traveler or cam follower 105B engages with track 105A. When traveler 105B moves longitudinally carrier 102 is caused to rotate. Traveler 105B is driven to move in a longitudinal direction by a linear actuator 105C. Any suitable linear actuator (including linear actuators of types described elsewhere herein) may be used to drive traveler 105B.

The embodiment illustrated in FIGS. 10A to 10C provides two linear actuators 105C which are actuated together and are each connected to drive traveler 105B. Linear actuators 105C are shown as cylinders (e.g. hydraulic or pneumatic cylinders. Retracting or extending linear actuator 105C causes carrier 102A to rotate.

PTU 25E optionally comprises outriggers operable to project outwardly from a housing of PTU 25E to resist rotation of the housing and to allow gripper 102 to apply sufficient torque to carried part 31 to turn the free end of conduit 31 through a desired angle in a desired direction. FIG. 4 shows outriggers 48 that can be extended to project outwardly from housing 44 or to be retracted against or into housing 44 by operating actuator 48A.

### Example Articulation Unit Construction

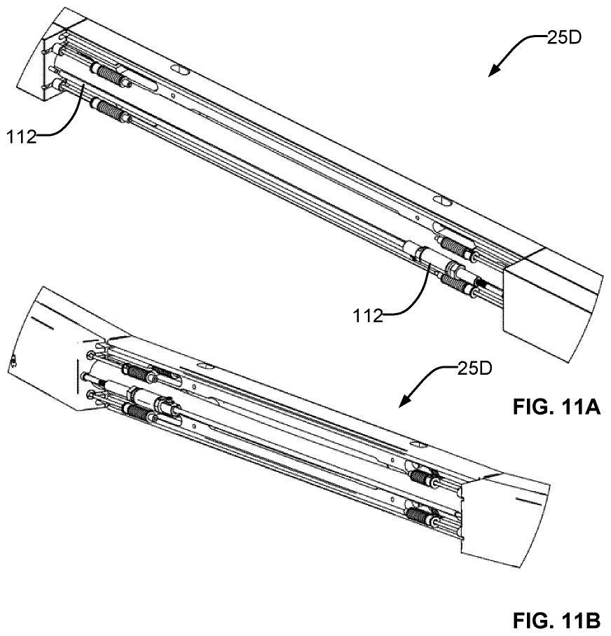

FIGS. 11A and 11B show an example articulation unit 25D. Articulation unit 25D may have a structure that is similar to or the same as segments 33 with the addition of one or more actuators 111 operable to cause coupling 70 at least one end of articulation unit 25D or a flexible coupling or element between ends of articulation unit 25D to bend in a desired direction.

In the embodiment of FIGS. 11A and 11B actuator 111 comprises a pair of actuators 112 (one of which is shown). Each actuator 112 is connected to adjacent segments of segmented part 30 by tendons 114 (e.g. cables, rods, etc.).

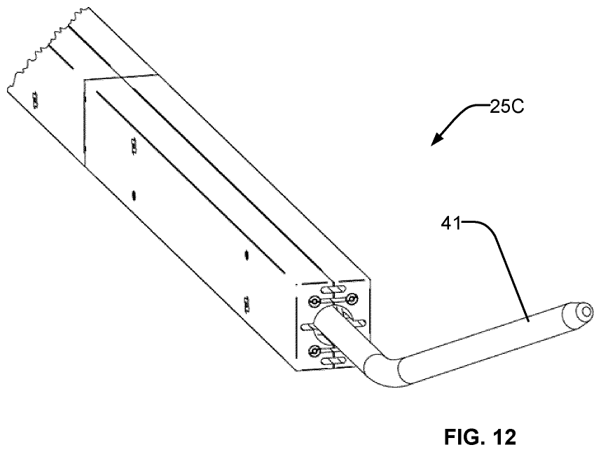

Actuator 112 is shown in a neutral state in FIG. 11A. As shown in FIG. 12A, when actuator 112 is extended, couplings 70 at either end of casing articulation unit 25D are flexed so that segmented part 30 is made convex on the side of segmented part 30 on which actuator 112 is located. The arrangement may be mirrored on the opposing side of segmented part 30.

Operation of actuators 112 on opposing sides of casing articulation unit 25D may be coordinated to cause couplings 70 to have any desired angle within a range of operation of actuators 112. When actuators 111 are not extended, flex couplings 70 may still passively flex under the influence of external forces.

In some embodiments actuators 112 are actuators that hold their position in the absence of control inputs. For example, actuators 112 may be screw actuators. Other embodiments may include actuators 112 of other types, for example as described herein.

### Example Steering Unit

FIG. 12 illustrates an example leader steering unit 25C. Leader steering unit 25C includes an actuator connected to rotate leader 41 to a desired angle.

### Example Method for Line Deployment

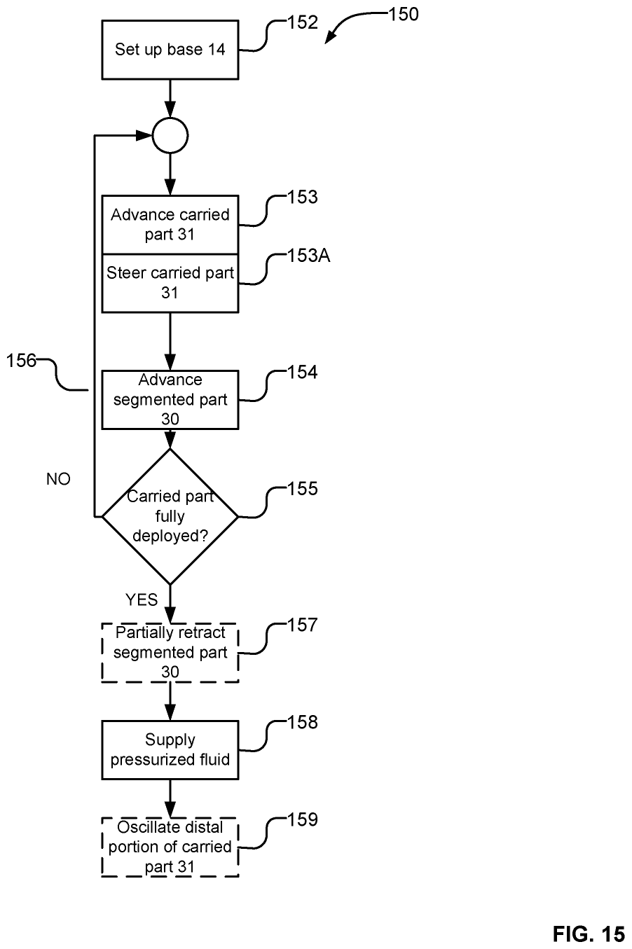

FIG. 15 is a flow chart that illustrates a general method 150 for deploying a line 12 according to an example embodiment. In block 152 a base is set up at a suitable accessible location.

In block 153 a carried part 31 is advanced from the base into an area through which it is desired to deploy the line 12 (for example to create a fire break or corridor). During block 153 carried part 31 may be steered to at least generally follow a desired path, as indicated by block 153A. If the path crosses a body of water such as a river or lake steering may be accomplished by spraying fluid from nozzles at or near the leading end of carried part 31.

In block 154 a holdback gripper is engaged to hold carried part 31 and a segmented part 30 is advanced along carried part 31 by one or more of pushing on the segmented part 30 from the base and advancing spans of the segmented part 30 between CSUs 25B.

Block 154 may include installing segments 33 onto carried part 31. Segments 33 may be installed as the segmented part 30 is advanced.

Blocks 153 and 154 may be repeated as many times as desired as indicated by loop 156 which is repeated until block 155 determines that carried part 31 is fully deployed.

It is sometimes beneficial to provide a length of carried part 31 that is exposed at a distal end of line 12. For example, in certain arrangements of nozzles 20 and segmented part 30 segmented part 30 may interfere with the free flow of fluids from nozzles 20. In such cases, exposing carried part 31 may provide for unobstructed flow of fluids from nozzles 20. As another example, once carried part 31 has been deployed it may be desired to retrieve part of or all of segmented part 30 for use in deploying another line 12 while leaving carried part 31 deployed. In optional block 157 segmented part 30 is retracted to leave a desired length of carried part 31 exposed at a distal end of line 12.

In block 158 pressurized fluid is supplied to carried part 31. The pressurized fluid may be dispensed (e.g. through nozzles) in the exposed portion of carried part 31. In optional block 159 the exposed portion of carried part 31 is oscillated to spread the dispensed fluid across a corridor of a desired width. The carried part 31 may additionally or in the alternative be reciprocated longitudinally via remote actuators 25 in order to direct nozzles 20 to either side of obstacles such as trees and rocks. This may also avoid the need to expose a portion of the carried part 31.

The technology described herein may be applied to deploy from a single accessible location a line comprising a conduit into virtually any terrain for applications such as continuous delivery of water and/or fire retardant for control of a wildfire, hydro seeding (e.g. of areas that have been affected by wildfires), delivering power or communications signals across terrain that is not readily accessible, transporting liquids or gases (e.g. fuels, industrial fluids), transporting water for power, agriculture or consumption, delivery of pesticides (e.g. to help forests affected by infestations of pine beetles or other insects that attack trees), delivery of fertilizers (e.g. to aid regrowth of deforested or burnt areas for rapid soil stabilization); deployment of sensors for measuring conditions along the line or for other purposes (e.g. seismic sensors, sensors that detect presence of persons, livestock or wildlife). Little or no human actions are required in the terrain into which the line is being deployed.

In an example case, a system as described herein may be operated to thoroughly soak a corridor >100 ft (30 m) wide, on the order of 100 ft (30 m) high and on the order of 1 km or 10 km or more long to limit the spread of fire and to increase humidity over and around the corridor, thereby limiting the spread of embers across the corridor.

The deployed line optionally includes a conduit that may be rocked or oscillated by steering systems of propulsion units as described herein in order to increase a width of the saturated corridor. The conduit is optionally reciprocated axially so that the locations of nozzles from which fluid is delivered are not fixed along the path of the deployed line. The axial reciprocation can make distribution of fluid into the corridor more uniform and avoid situations where sprays from certain nozzles are blocked by obstacles.

The skilled person reading this disclosure with a willing mind will understand that systems as described herein may be constructed in a way that solves a number of serious problems. One problem is that deploying prior art fire hoses for delivering water to a remote location requires personnel and/or vehicles to access the location to deploy the fire hoses. This risks the lives of personnel and risks loss or damage of vehicles. Systems as described herein may be operated from a base 14 which is at a safe location and which can be a long distance away from the remote location.

Another problem is that in engineering terms a deployed conduit may be viewed as a “slender column” No matter how robust the material of which the conduit is made there is a practical limit to how far a slender column can be extended across land by pushing from one end of the slender column. When a deployed length of the slender column is long enough the force required to advance the column increases to a point where the column will buckle instead of being extended further. This problem is made worse when the slender column is curved to follow a tortuous path.

Some embodiments of the present technology provide systems that overcome these limitations by a two part conduit system comprising an carried part and a segmented part which provides one or more of:
a) distributed advancement of the carried part (e.g., by PPUs spaced along the casing);
b) distributed advancement of the segmented part;
c) advancement of one or more spans of the segmented part while other portions of the segmented part are not advancing;
   thus the present technology can provide essentially indefinite deployment length even in the case of significant path tortuosity.

### Example Flexible Segments

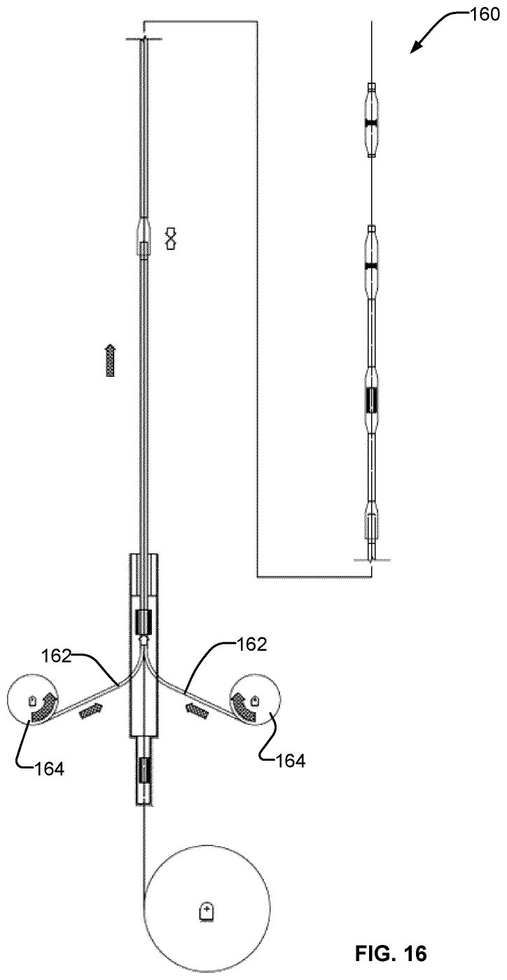

FIG. 16 illustrates a system 160 that is like system 10 except that segmented part 30 is provided in the form of elongated flexible casing halves configured to be joined around carried part 31. For example, casing halves 152 may be configured with interlocking teeth (as in a zip fastener) and/or joined around carried part 31 by fasteners, straps, bands or the like. Casing halves 152 are fed from reels 154. Casing halves 152 may be provided in lengths equal to a desired span between adjacent actuator units 25.

Another alternative form for segmented part 30 is elongated segments of closed tube that are spooled substantially concentric with carried part 31 and deployed according to the system described herein. Deployment preferably is done by actuating advancement of carried part 31 and segmented part 30 with actuators operating with relatively short strokes to accommodate the limited axial movement possible between carried part 31 and segmented part 30 on reel 22. For example, each stroke may advance a segment of segmented part 30 and/or carried part 31 by a distance on the order of 100 mm. Advance strokes may be made with relatively high frequency to reduce the time required to deploy a line 12.

### Example Methods for Extending and Retracting Segmented Part

After a few spans of a segmented part of a line have been deployed it is possible to actuate plural spans of a segmented part of a line to advance or retract at the same time. Doing so can decrease the time required to deploy or recover a line 12. There are many patterns by which plural spans may be advanced at the same time. In some embodiments, each span 32 is assigned to one of a plurality of span groups. The spans in each span group may be controlled to advance (or retract) simultaneously. Preferably, adjacent spans 32 are assigned to different span groups. For example, in the case where there are three span groups, G1, G2 and G3, the spans 32 belonging to group G1 may be advanced first, the spans 32 belonging to group G2 may be advanced next, and the spans 32 belonging to group G3 may be advanced next. This pattern may repeat.

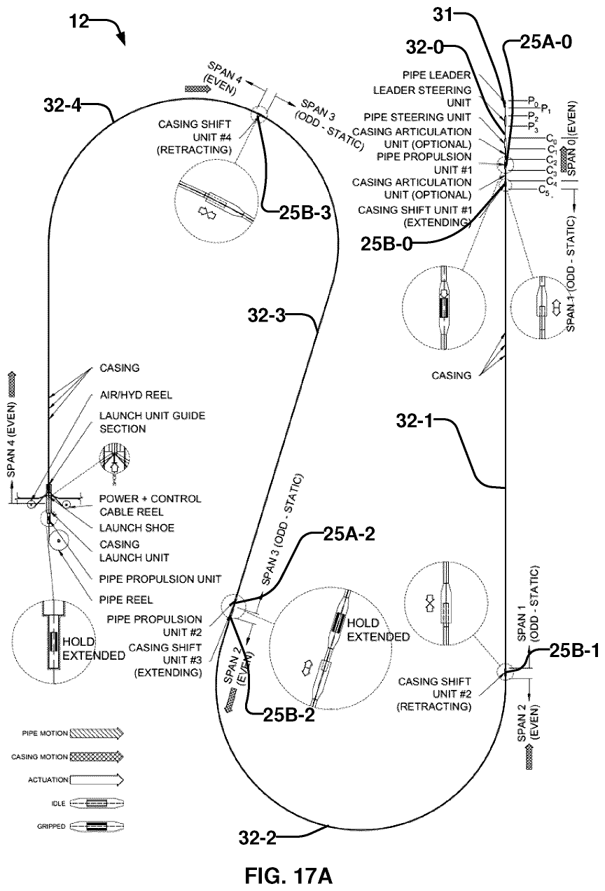

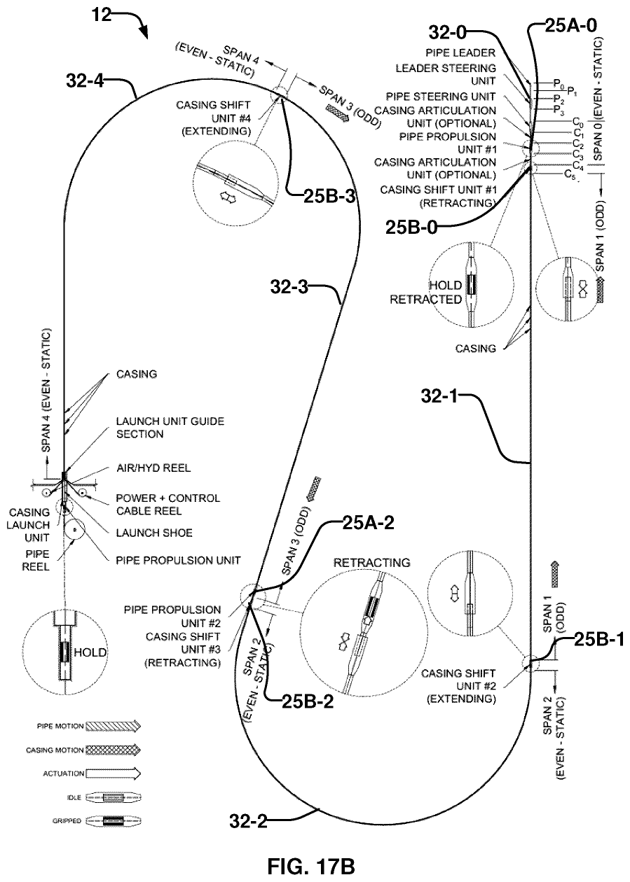

FIGS. 17A and 17B illustrate an example embodiment where separate groups of spans 32 are sequentially advanced. Specifically, the use of two casing span groups is illustrated. Span group “A” comprises all even numbered spans (32-0, 32-2, 32-4 . . . ) and casing span group “B” comprises all odd numbered spans (32-1, 32-3, 32-5 . . . ). Segmented part 30 may be advanced by first simultaneously advancing all of the group “A” spans while maintaining the position of the group “B” spans relative to the ground. Subsequently, the group “B” spans 32 may be advanced while maintaining the positions of the group “A” spans 32. This process may be repeated until line 12 has been deployed.

Each span 32 lies between two remote actuator units 25. Each remote actuator unit 25 comprises a CSU 25B.

FIG. 17A shows the advancement of even numbered casing spans (e.g. spans 32-0 and 32-2). As an example, CSUs 25B-0 and 25B-2 are being extended while, at the same time, previously extended CSUs 25B-1 and 25B-3 are being retracted to advance even numbered casing spans 32-0 and 32-2. FIG. 17B shows the advancement of odd numbered casing spans (e.g. spans 32-1 and 32-3). As an example, CSUs 25B-1 and 25B-3 are being extended while, at the same time previously extended CSUs 25B-0 and 25B-2 are being retracted to advance odd numbered spans 32-1 and 32-3.

The line 12 illustrated in FIGS. 17A and 17B also includes a number of PPUs 25A. PPUs 25A may be included in the remote actuator units 25A that are between spans 32 or may be separate.

In some embodiments, PPUs 25A are coupled to move with segment(s) 33 of one group of spans 32. In such embodiments PPUs 25A may simply comprise grippers. It is not mandatory that the grippers be actuated to move relative to segmented part 30. Each time the spans 32 of the group of spans 32 is advanced, carried part 31 of line 12 may be advanced simultaneously. An advantage of this arrangement is that the grippers of PPUs 25A may be left continuously engaged (until it is desired to allow segmented part 30 to be moved relative to carried part 31 e.g. to partially or entirely retract segmented part 30 while leaving carried part 31 deployed). This arrangement, while simple, may be less desirable than some other embodiments in cases where it is desired to deploy a line 12 over a long distance and/or over a tortuous path because with this arrangement trailing parts of line 12 have a weaker tendency to follow the same path taken by leading parts of line 12 than in other embodiments.

In the embodiment of FIGS. 17A and 17B, line 12 includes grippers that move together with the spans of span group A. For example, a gripper, may be incorporated into a part of a CSU 25B that is directly connected to a span of span group A or a gripper may be incorporated into a segment 33 of a span of span group A. In FIGS. 17A and 17B, a PPU 25A is located at the proximal end of each even numbered span (e.g. span 32-0, span 32-2 etc.). The PPU 25A may be integrated with a CSU 25B.

In some embodiments, carried part 31 is advanced by the coordinated actuation of all PPUs 25A at the start of each span group advancement cycle made up of the advancement of span group “A” followed by the advancement of span group “B”).

In cases where a line like that shown in FIGS. 17A and 17B does include PPUs 25A that are movable relative to segmented part 30 by an actuator, the PPUs may be actuated to help to advance carried part 31. For example, during the above-described cycle, PPUs 25A located within advancing spans 32 may be controlled to grip carried part 31 and to retract, thereby pulling segmented part 30 in a distal direction. PPUs 25A may be applied to help to retract spans 32 of segmented part 30 in an analogous manner.

In some embodiments, grippers of PPUs 25A located within spans 32 that are not currently being advanced (“static spans”) may be controlled to grip carried part 31 and to thereby hold the static span against moving relative to carried part 31. This can help to anchor the static spans so that they can be pushed against to advance other spans 32. Carried part 31 also constrains the path length of advancing span(s) 32. This beneficially helps to ensure path stability regardless of tortuosity.

The sequence illustrated in FIGS. 17A and 17B may be modified by dividing spans 32 into three, four, or more span groups. As in FIGS. 17A and 17B the spans in each of the groups may be advanced together relative to other spans in other span groups.

For example with three span groups, the spans 32 may be sequentially assigned to groups “A”, “B” and “C”, starting from the distal end of the line 12. In such an embodiment, the standard advance cycle may comprise sequentially advancing the following elements/groups in order: span group “A”, span group “B” and span group “C” and then advancing span group “A” etc. With three casing span groups, there can be two static spans 32 between each pair of spans 32 that are being advanced. This can help to advance the line 12 by better anchoring the static spans (with more static spans the friction between the static spans and the underlying surface is increased). A disadvantage of using a larger number of span groups is that the time required to deploy a conduit 12 is increased because fewer spans are being advanced at any given time.

Different span groups may be advanced in other suitable cyclical sequences in which spans are advanced in order, distal to proximal (or retracted in order proximal to distal).

Advancing or retracting a line 12 by controlling groups of spans to be advanced (or retracted) simultaneously can simplify control of a system 10 as the components that cooperate to advance the spans 32 in any span group (e.g. certain CSUs 25B, PPUs 25A) may be controlled together.

In some embodiments a system 10 is configurable to switch between advancement modes which use different numbers of span groups. For example, two span groups may be used to achieve rapid advancement until static span groups begin to slip too much. Then the number of span groups can be increased to three span groups to provide additional anchoring of the static spans. Such switching can be used to select a slower mode that better tolerates variability of ground friction characteristics and/or uphill/downhill actuation force differences.

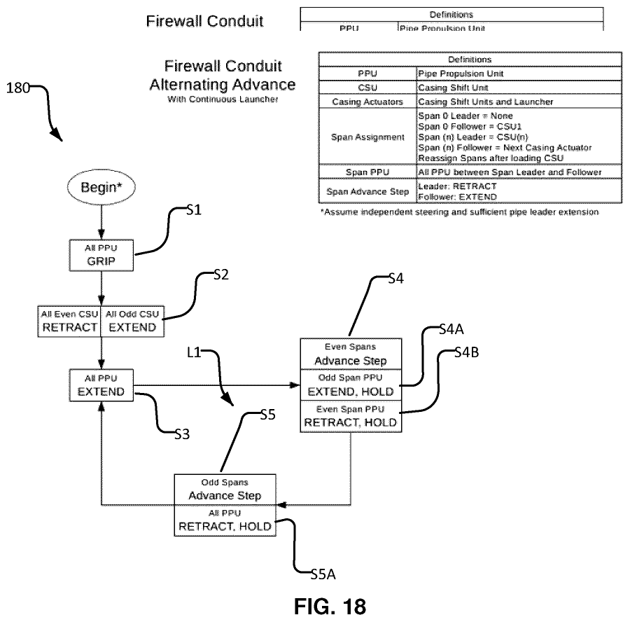

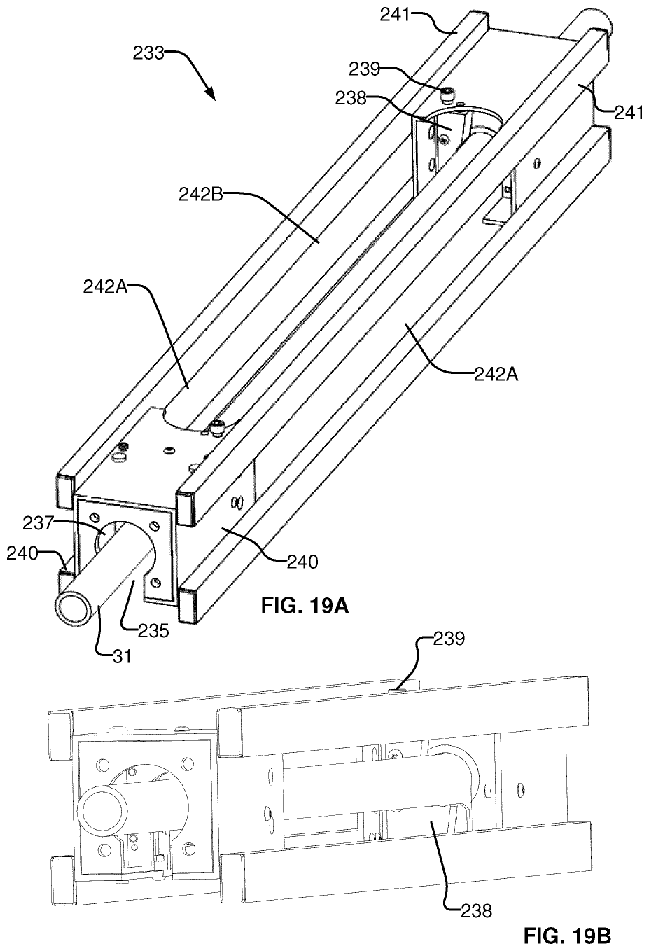

FIG. 18 is a flow chart illustrating an example control method 180 that may be applied to advance a line 12 according to the sequence illustrated in FIGS. 17A and 17B. In initialization steps S1 and S2, al PPUs are controlled to grip carried part 31 and CSUs along line 12 are set to be extended and retracted in alternation.

After the initialization is complete, loop L1 is repeated as many times as is necessary to extend line 12 by a desired amount. At step S3, all PPUs are extended to advance carried part 31. At step S4 all even spans are advanced. In steps S4A and S4B PPUs are controlled to assist with advancing segmented part 30. At step S4A, PPUs in odd spans are kept extended and holding carried part 31. At step S4B PPUs in even spans are operated to hold carried part 31 and to retract (thereby assisting in the advancement of the even spans).

In step S5, odd spans are advanced. In step S5A PPUs are controlled to assist with advancing segmented part 30. At step S5A, PPUs in even spans are kept retracted and holding carried part 31 while PPUs in odd spans are operated to hold carried part 31 and to retract (thereby assisting in the advancement of the odd spans).

Following the advance sequence shown in FIGS. 17A, 17B and 18, the active part of the PPUs can optionally remain engaged with carried part 31 throughout the advance cycle. PPUs can accordingly engage carried part 31 via fixed means, e.g. clamps, avoiding the need for active PPU grippers.

### Components of Segmented Part Having U-Configuration

As opposed to configuring segments 33 and other components of segmented part 30 (e.g. actuator units 25) with a clamshell configuration made up of separate parts which may be coupled together to receive carried part 31 as described above, it is possible to provide segments 33 in the form of single units configured to releasably receive carried part 31. Such construction can simplify assembly of segments 33 of line 12 at a base 14.

### Example Segment Construction

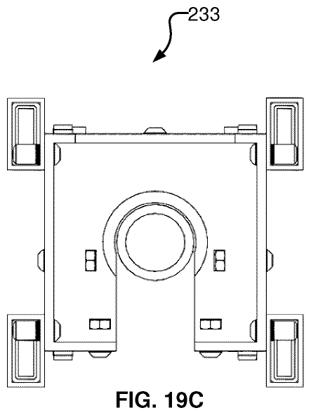

FIGS. 19A-19C show an example segment 233 that has a one-piece construction. Segment 233 may be used as a segment of a segmented part 30 of a line 12. Segment 233 is formed with a longitudinally extending slot 235 which is wide enough to receive carried part 31. In the illustrated embodiment, slot 235 widens into a channel 237. In use, carried part 31 may be introduced into channel 237 via slot 235. In some embodiments segments 233 are installed from the top over a continuous section of carried part 31. In some embodiments segments 233 are brought up from below to receive carried part 31 by way of slot 235.

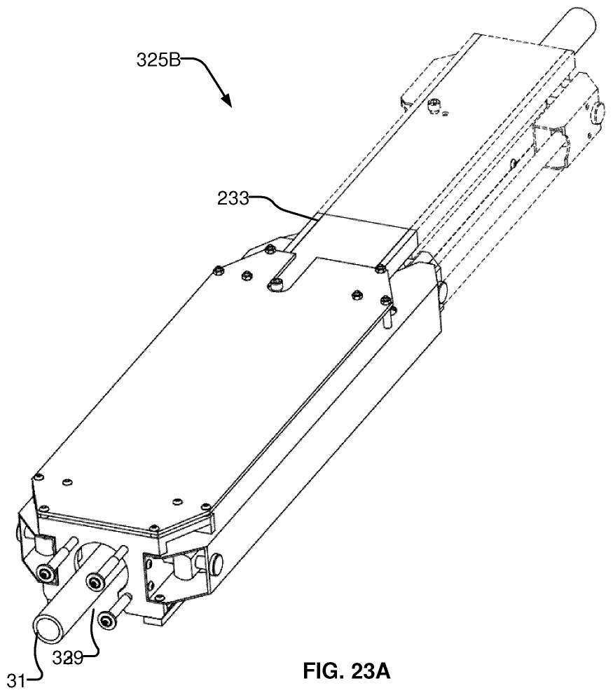

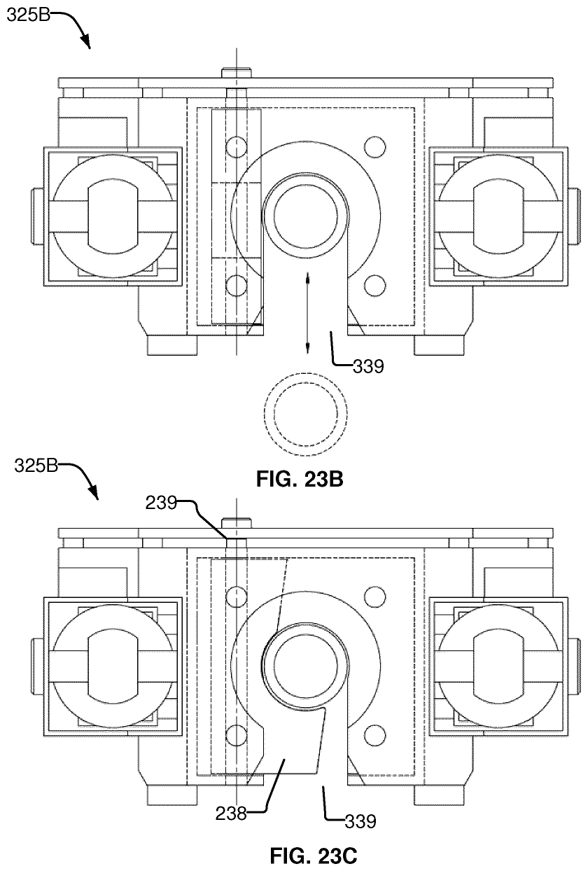

As best shown in FIG. 23C, one or more retainers 238 may be provided to keep carried part 31 from escaping from segment 233 via slot 235. Retainer 238 may, for example, comprise a gate which can swing between open and closed configurations about a pivot 239. In other example embodiments retainers may comprise pins, latches, slide gates, etc. configured to be moved into and out of a configuration in which carried part 31 is blocked from leaving slot 235.

The illustrated segment 233 comprises bottom rails 240 which may support the rest of segment 233 off the ground. Two or more rails 240 may be provided. As illustrated, rails 240 may be relatively narrow. This may help rails 240 to effectively track a desired path. The illustrated segment 233 comprises raceways 241 which may be used to carry umbilicals.

Segment 233 may comprise side openings 242A and/or one or more top openings 242B (which may collectively be referred to as openings 242). Openings 242 provide paths for accessing carried part 31. For example, openings 242 may provide routes for sprays of water from nozzles on a carried part 31 to pass out of segment 233. In some embodiments, openings 242 cover a significant proportion of the overall outside surface area of segment 233, particularly on top and side surfaces of segment 233. Openings 242 may be large enough to permit substantially unobstructed passage of fluid sprays from nozzles on carried member 31 even if orientations of the nozzles are changed by twisting of carried member 31. Openings 242 may have an axial extent sufficient to ensure that sprays from most nozzles on carried member 31 can pass out of segment 233 without obstruction.

Providing openings 242 in the walls of segments (e.g. segments 233) of a segmented part 30 can permit fluids to be dispensed anywhere along a line 12 without the need to retract segmented part 30 from the part of carried part 31 from which it is intended to dispense the fluids. In some embodiments, a plurality of PTUs 25E may be located along a length of segmented part 30 to control the orientation of nozzles (e.g. nozzles 20) on carried part 31.

### Example Segment Coupling Arrangements

Segments 33 or 233 may be selectively coupled to other segments of segmented part 30 by any appropriate means (including constructions described elsewhere herein). Such coupling means may include bolted flanges, pinned lugs, axial screws, bayonet connections, etc. Segments 233 may include spring loaded flex units adjacent to such coupling means to allow segmented part 30 to bend slightly between adjacent segments 233. Inverted U segments may be selectively connected by various means such as bolted flanges, pinned lugs, axial screws, bayonet connectors, etc.

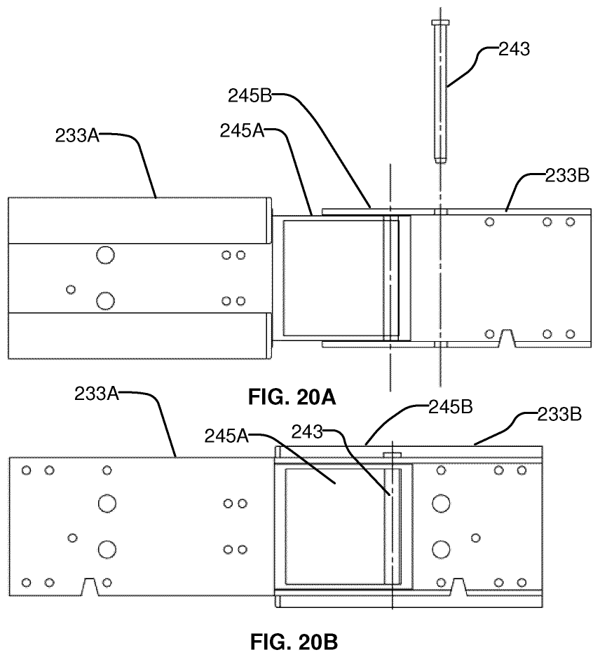

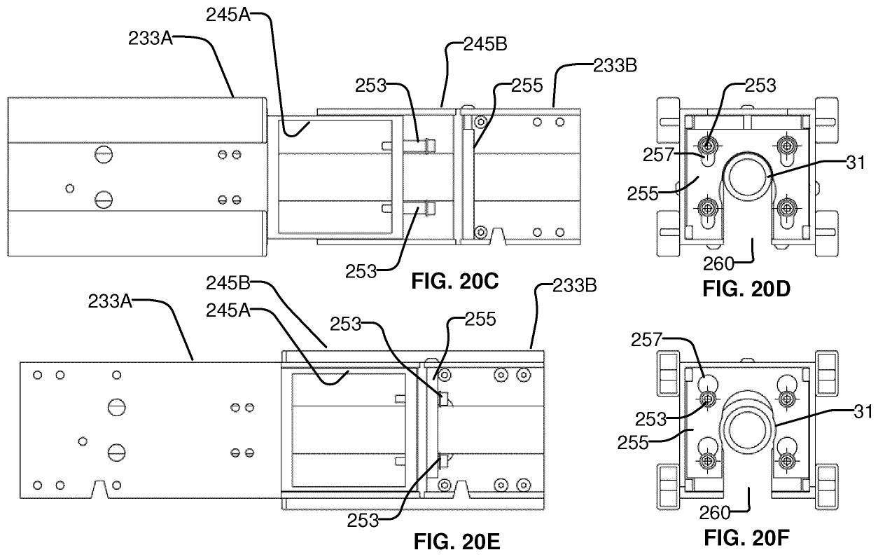

FIGS. 20A and 20B illustrate the use of a plug/socket connection for coupling segments 233A and 233B. This may be accomplished by first aligning plug protrusion 245A of segment 233A with socket 245B of segment 233B. In this example, protrusion 245A is rectangular and socket 245B has a rectangular shape that receives protrusion 245A. A pin 243 may be inserted through the aligned holes 245 to couple segments 233A and 233B.

FIGS. 20C-20F show an example means for locking two segments 233A and 233B together using a sliding keyhole plate 255. Keyhole plate 255 comprises slots 257, each slot 257 having a wider end and a narrower end such that the wider end of slot 257 is able to accept enlarged heads of pins 253 which are coupled to segment 233A (see FIGS. 20C and 20D). Pins 253 are advanced until a smaller diameter portion of pins 253 reach plate 255 at which point pins 253 slide into the narrower portions of slots 257. Locking members may be provided to keep pins 253 engaged in slots 257. The locked configuration is shown in FIGS. 20E and 20F. Plate 255 is formed with an opening 260 to accommodate installation over a carried part 31.

### Example Traction/Backstop Devices

Some embodiments include backstops that are operable to restrict motion of a portion of the line 12 relative to the ground in at least one direction. For example, backstops may be provided at segments of segmented part 30 (e.g. casing segments 33 and 233) for preventing undesired backsliding of those casing segments or casing spans 32. Backstops may, for example be useful when a line is being deployed over hilly terrain or over slippery ground. A backstop may, for example comprise a member that carries a ground engaging element (e.g. a point or claw or edge and is pivotally attached to a segment so that the ground engaging element will dig into the ground to resist movement of the segment or other part of line 12 that carries the backstop in a backward direction.

The spacing between backstops and the construction of backstops may be varied to suit conditions. For example, a line that is to be deployed on a path that includes significant grades or is very tortuous or covers ground that is very uneven may benefit by having a larger number of more closely spaced backstops than would be adequate for a line intended to be deployed along a straighter path that has only gentle grades on good ground.

Backstops may be provided, for example by mechanisms that restrict motion in one direction and allow free motion in the other direction. In order to allow bidirectional travel of line 12 the backstops may be controllable to disable the backstops and/or to reverse the direction in which the backstops restrict motion. Some embodiments provide backstops having a forward orientation and other backstops having a reverse orientation. The backstops in the forward orientation are configured to resist reverse motion and the backstops in the reverse orientation are configured to resist forward motion. The reverse orientation may be disabled when it is desired to advance the line. The forward orientation backstops may be disabled when it is desired to retract the line. The reverse and forward orientation backstops may both be enabled at the same time in one or more portions of the line or all of the line when it is desired to more positively hold the line or one or more portions of the line in place.

Some embodiments provide backstops that are selectively configurable to resist motion on the forward direction or the reverse direction (such backstops may optionally be configurable in a disabled configuration in which they do not resist motion in either direction.

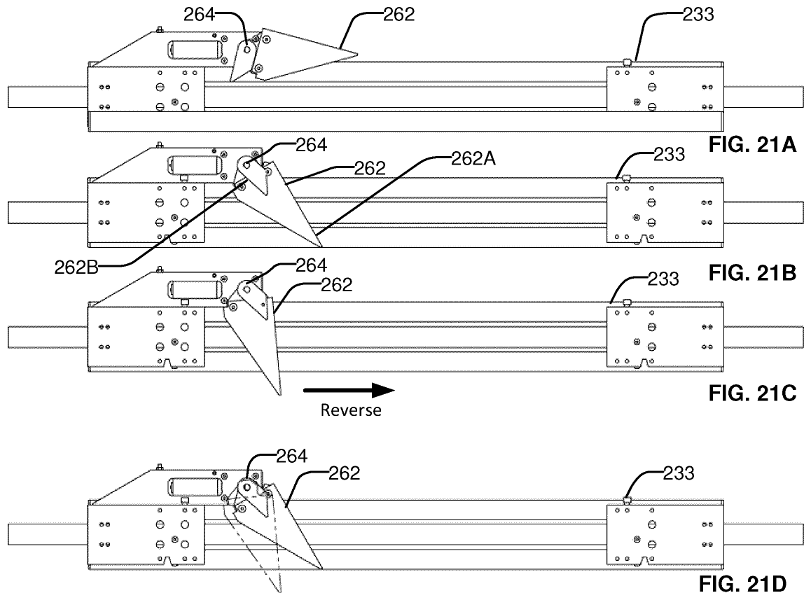

FIGS. 21A-21D illustrate operation of an example backstop 262. Backstop 262 comprises a ground engaging end 262A and is mounted to pivot at 262B. In FIG. 21A, backstop 262 is in a disengaged position in which backstop 262 does not interfere with travel of segment 233 in either direction. In FIG. 21B, backstop 262 is activated and moves towards the ground until reaching the activated configuration shown in FIG. 21C. When activated, backstop 262 prevents motion of casing segment 233 in the reverse direction (shown by the direction of the arrow) due to end 262A of backstop 262 digging into the ground. When segment 233 is moved in the forward direction backstop 262 merely drags on the ground and does not resist the forward motion of segment 233. FIG. 21D shows backstop 262 being retracted from the activated position.

In some embodiments, the position of backstop 262 is controllable by an actuator 264. In some embodiments, actuator 264 is remotely controllable to selectively retract backstop 262 to its disengaged position, hold backstop 262 in the disengaged position or release backstop 262 to assume its engaged position. The backstop 262 in FIGS. 21A to 21D is operable to resist motion of segment 233 in one direction. In some embodiments a backstop 262 is selectively configurable to resist motion in either forward or reverse direction. In some embodiments two or more backstops 262 are provided with one or more backstops 262 operable o resist motion in the reverse direction and one or more backstops 262 operable to resist motion in the forward direction.

It is not necessary to provide backstops 262 on every segment 233. In some embodiments, one backstop 262 or set of backstops 262 is provided for each casing span 32 at a location near a CSU.

A backstop may have any of a variety of constructions. In other embodiments, a backstop may be axially actuated or radially actuated or may comprise a shoe with a tread, a spiked wheel equipped with a one-way clutch or the like.

Some embodiments include backstops that comprise a traction wheel configured for unidirectional rotation via a ratchet or one-way rolling bearing. Some embodiments include backstop mechanisms that comprise a traction wheel connected to a motor by way of a worm gear reducer. The motor may be operated to deliver torque in either direction. The traction wheel is free to rotate in the direction in which the motor is attempting to drive the traction wheel and is locked by back-driving locking in the opposite direction. It is not necessary for the motor deliver enough torque to drive the traction wheel to move the line. The motor only needs to deliver enough torque to allow the traction wheel to rotate in the driven direction. The traction wheel may be locked in both directions by turning off the motor.

Example Actuator Units with U-Configurations

In some embodiments, remote actuator units are configured to receive a carried part 31 of a line 12 in a way that is similar to segments 233. For example, an actuator unit 25 may have a U cross-section which provides a slot through which a carried part 31 can be received in a channel through the actuator unit 25. Actuator units 25 of any of the types described above may be constructed with such a configuration.

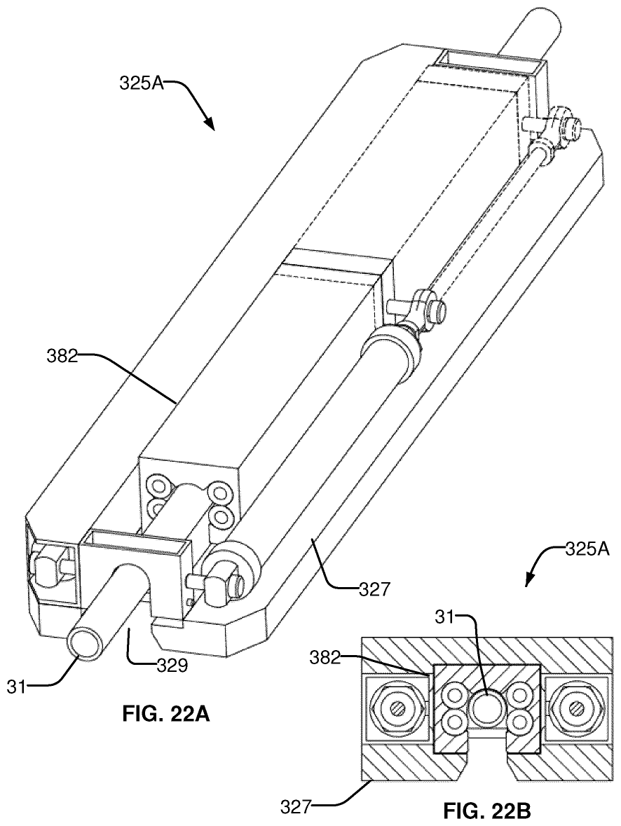

FIGS. 22A and 22B show an example PPU 325A having a U configuration. As shown, PPU 325A comprises a frame 327 and a gripper 382, both of which have an opening 329 to permit PPU 325A to receive a carried part 31 without requiring separate parts to be joined together (as in the case of PPU 25A). Gripper 382 may operate in a manner similar to gripper 82 described above.

FIGS. 23A-23C show an example CSU 325B having a U configuration. As shown, CSU 325B comprises an opening 339 which permits CSU 325B to receive a carried part 31. An actuator is operable to drive CSU 25B between a retracted configuration (shown in solid lines) to an extended configuration (shown in dotted lines). These functions may be performed in a manner similar to that described above in relation to CSU 25B.

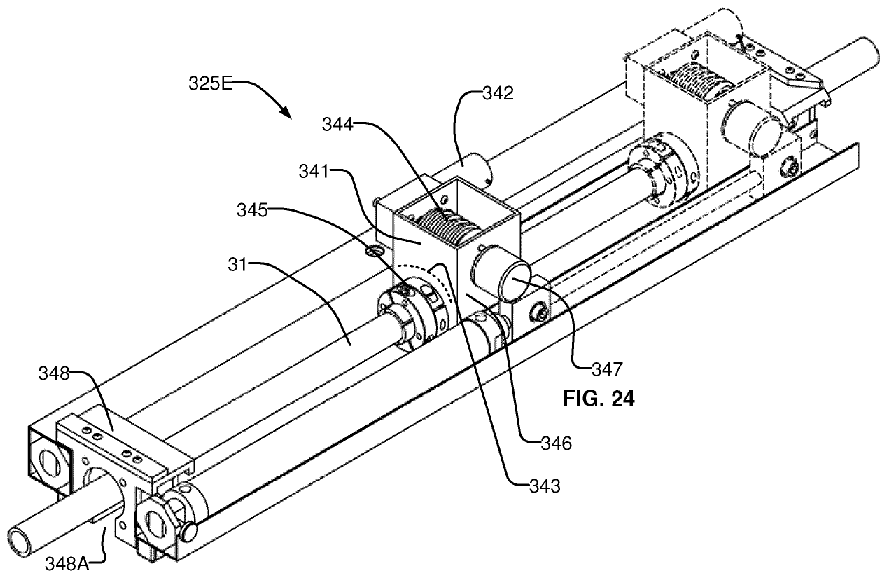

FIG. 24 shows an alternative construction for a PTU. PTU 325E includes an actuator comprising a gear drive 341. Gear drive 341 comprises a motor 342 which drives a gear 343 by way of one or more worms 344 or pinions (not shown). Motor 342 may be electric, hydraulic, pneumatic etc. and may include further gear reduction. In some embodiments gear 343 is made of a self-lubricating material (e.g. a plastic such as nylon or acetal (e.g. Delrin™)) to avoid lubrication requirements.

Gear 343 may be coupled to rotate carried part 31 about its axis for example by a pipe clamp 345 as shown in FIG. 24 or a gripper as described elsewhere herein. In the embodiment illustrated in FIG. 24, PTU 325E is designed to have carried part 31 threaded through pipe clamp 345 (or a gripper). For example, PTU 325E may be pre-staged on carried part 31 as described elsewhere herein

In some embodiments, PTU 325E may be made in a U-configuration which includes a slot through which carried part 31 may be received into central passage of PTU 325E. In such embodiments, gear 343 may include throat to accept carried part 31. Drive housing 346 and a bearing which supports gear 343 may include a throat and PTU frame 348 may include a throat 384A. These throats may be aligned to provide a slot through which carried part 31 may be introduced into a channel that extends longitudinally through PTU 325E.

Some embodiments include a support sleeve that is cantilevered from drive housing 346 and provides supplemental radial support for gear 343.

Gear drive 341 is advantageously a worm gear drive. A worm gear drive can provide rotational locking when idle, given a suitably high drive ratio. Gear 343 may be driven by a worm that is long enough to bridge a throat in gear 343 (if present). This construction may provide unlimited rotation angle.

In some embodiments PTU 325E (or PTU 25E) includes first sensors operable to monitor rotation of carried part 31. For example a rotary encoder 347 may be provided for angular position feedback. In some embodiments PTU 325E includes second sensors that monitor an actual orientation of the portion of carried part 31 that passes through PTU 325. For example, a proximity sensor, a magnetic sensor, an optical sensor or the like may be operated to detect features on carried part 31 which have angular positions that have a known relationship to the rotational orientation of carried part 31. Feedback from such sensors may be used to control PTU 325E to control orientation of carried part 31 in a specified manner (e.g. to direct sprays from nozzles 20 in desired directions). In an example embodiment carried part 31 comprises an orientation target such as an embedded or surface-mounted wire or metal strip extending along some or all of the length of carried part 31 at a fixed circumferential location relative to features such as nozzles 20. The orientation target may be used in cooperation with sensors, e.g. inductive proximity sensors, mounted in a PTU 325E or 25R or in segments of segmented part 30 to detect the rotational position of carried part 31. Feedback from detecting the orientation target may be applied for controlling rotations of carried part 31 (e.g. to orient nozzles 20 in desired directions and/or to control orientation of a leader 41.

A controller of PTU 325E may be configured to calibrate a function that converts outputs of the first sensors to an orientation of carried part 31 using signals from the second sensors.

In some embodiments drive housing 346 is mounted for longitudinal (axial) movement along a frame of PTU 325E. For example, drive housing 346 may ride on slides or rollers. Actuators may be connected between drive housing 346 and the frame and controlled to effect axial motion drive housing 346 and gear drive 341. Actuators of this design may, separately or simultaneously provide the functions of PPU 25A and PTU 25E.

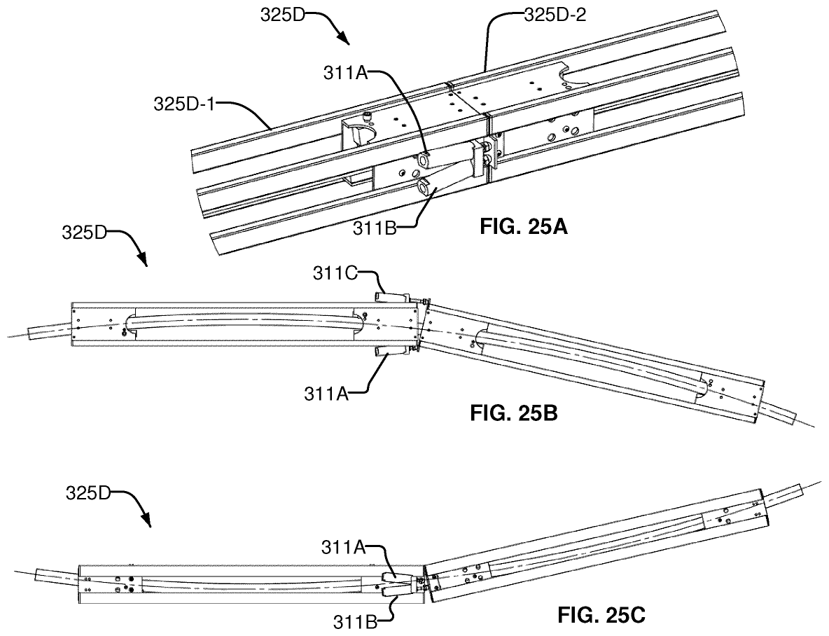

FIGS. 25A-25C show an example articulation unit 325D having a U configuration. Articulation unit 325D has two parts, 325D-1 and 325D-2 which may each be or be constructed like a segment 233. Four actuators 311, two on either side of a centerline of articulation unit 325D extend between parts 325D-1 and 325D-2. Actuators 311 are linear actuators that are each operable to push apart or bring together points at which they engage parts 325D-1 and 325D-2. Actuators 311 may, for example comprise single-acting actuators operable to selectively push parts 325D-1 and 325D-2 apart or to relax and allow springs (e.g. springs associated with tendons as described herein) to draw parts 325D-1 and 325D-2 together.

In the illustrated embodiment, the points at which each of actuators 311 engages parts 325D-1 and 325D-2 respectively are close to adjacent ends of parts 325D-1 and 325D-2.

In the embodiment of FIGS. 25A and 25C, actuators 311 are angled relative to the centerline of articulation unit 325D. The angles may be chosen to be approximately half of a maximum designed for articulation angle in each direction. This design can reduce lateral forces on actuators 311. A consequence of this design is that the points of attachment of actuators 311 on part 325D-2 are closer to the centerline of articulation unit 325D than are the points of attachment of actuators 311 on part 325D-1.

Referring to FIG. 25A, top and bottom actuators 311A and 311B which are visible may be considered to be on the “right” side of unit 325D (as viewed from the proximal end). Top and bottom actuators 311C and 311D are located on the opposite side of unit 325D and are not visible in FIG. 25A.

Actuators 311 can be controllably actuated to provide two-axis steering of segmented part 30. A two-axis control advantageously allows line 12 to be maneuvered around larger obstacles (in the horizontal plane) and also permits line 12 to be maneuvered over smaller obstacles such as fallen trees (in the vertical plane).

The actuation of actuators 311 can be coordinated to achieve a desired overall flexion of casing articulation unit 325D. For example, flexion of unit 325D in different directions may be coordinated as follows:
steer left: extend upper-right actuator 311A and lower-right actuator 311B;
steer right: extend upper-left actuator 311C and lower-left actuator 311D;
steer up: extend lower-left actuator 311D and lower-right actuator 311B; and
steer down: extend upper-left actuator 311C and upper-right actuator 311A.

In some embodiments, actuators 311 comprise pneumatic or hydraulic cylinders or electromechanical linear actuators.

### Example Side-by Side Arrangement

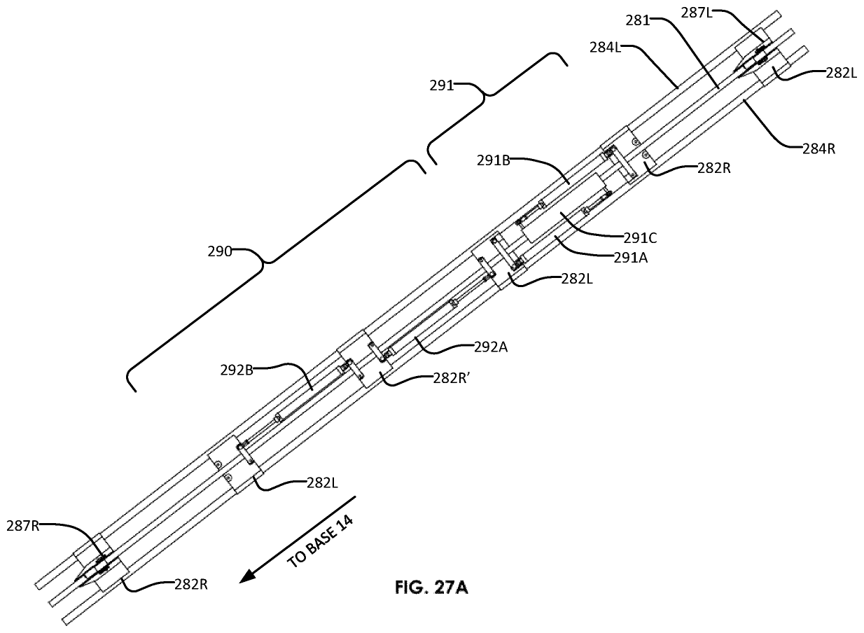

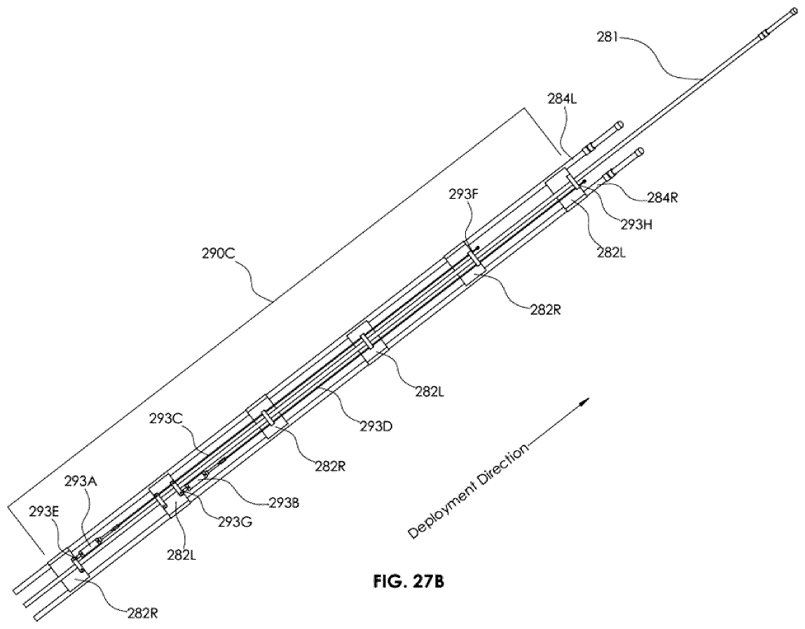

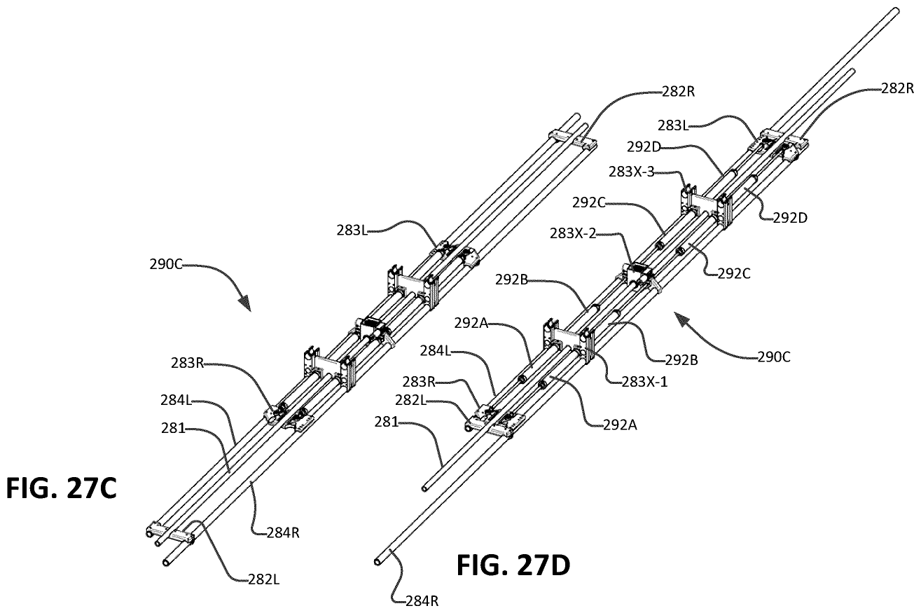

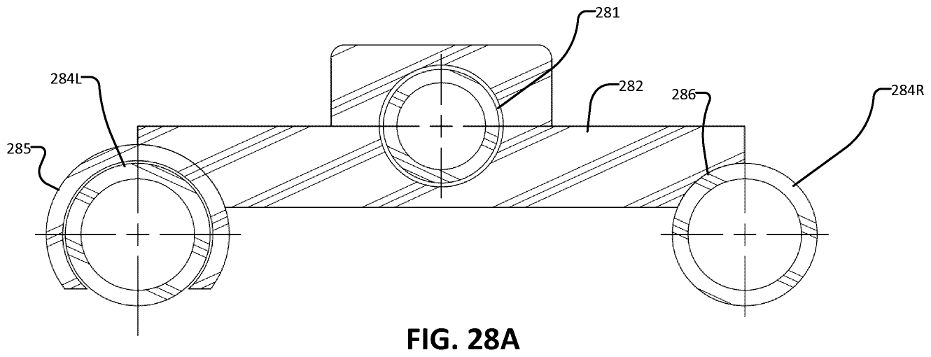

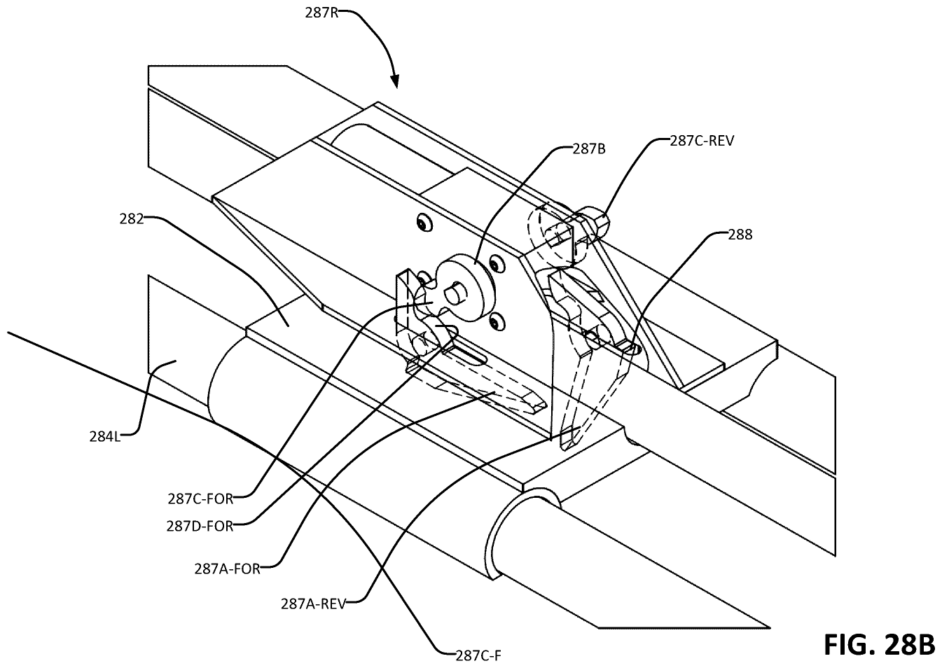

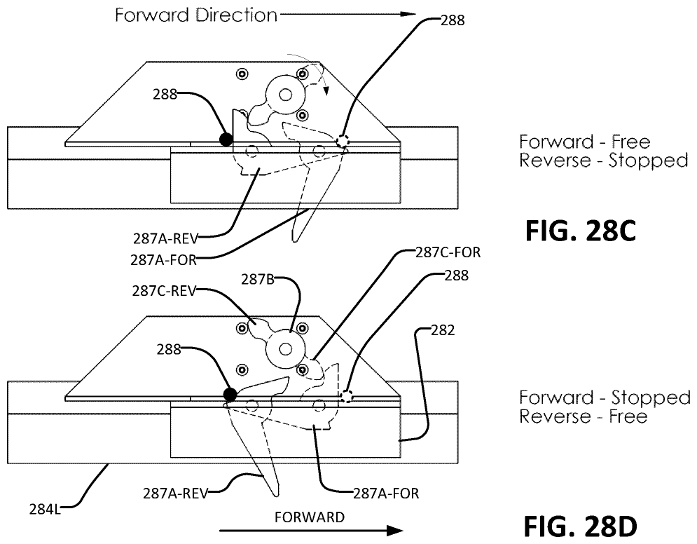

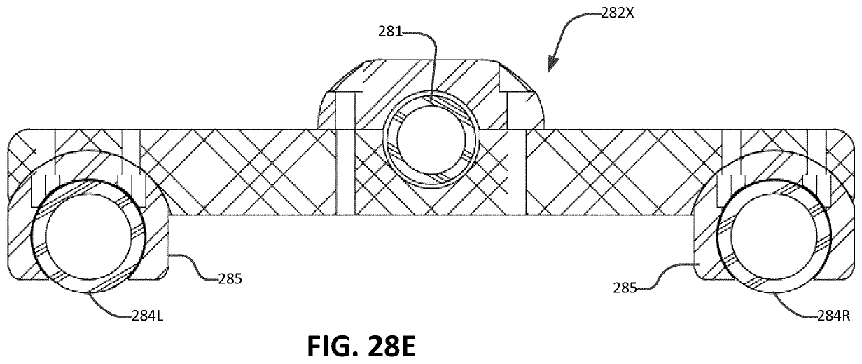

FIGS. 27A through 28B illustrate apparatus 280 that includes a line 12 according to another example embodiment. Like some other embodiments, apparatus 280 has plural ground contacting portions that are movable relative to one another. The ground contacting portions comprise longitudinally extending members that contact the ground underlying line 12. In apparatus 280 the ground contacting portions are arranged side-by side (transversely spaced apart relative to a longitudinal axis of line 12).

In apparatus 280, line 12 comprises a carried part 281 which is supported by cross-members 282. Cross members 282 are in turn coupled to ground contacting portions 284R and 284L (which may be called “runners”).

In some embodiments runners, 284L and 284R (generally or collectively runners 284) are “spoolable”. For example, runners 284 may comprise tubular members such as plastic pipes, plastic strips etc. that are flexible enough to be rolled onto a reel for storage and transportation. For example, runners 284 may comprise sections of flexible plastic pipe having a diameter in the range of ¾ inches (about 2 cm) to 6 inches (about 15 cm) or more. In some embodiments carried part 281 is spoolable.

In some embodiments, assemblies comprising runners 284 and cross members 282 are divided into sections suitable for transport and handling (e.g. sections in the range of 10-50 feet or about 3 to 15 m long). Such sections may be coupled together as they are added lo line 12, for example, by plug/socket runner splices (e.g. Spears™ model S0302 runner splices available from Spears Manufacturing Company, USA). A very wide range of other alternative splice constructions are possible. Couplings in ground contacting parts (e.g. runners 284) are preferably relatively smooth on at least a ground-contacting surface to minimize sliding resistance.

Fluids, electrical power, signals etc. may be carried in one or more of: carried part 281, runner 284L, runner 284R or one or more umbilicals that extend between cross members 282 and/or one or more raceways fixed to carried part 281 or runners 284 or cross members 282.

Runners 284R and 284L are longitudinally movable relative to one another. In some embodiments runners 284R and 284L are each movable relative to carried part 281. In some embodiments one or runners 284R and 284L is fixed relative to carried part 281 and the other one of runners 284L and 284R is movable relative to carried part 281.

Traction devices may be provided to help grip the ground to advance line 12 of apparatus 280. FIGS. 28B to 28D show example backstops 287R and 287L (collectively of generally backstops 287) that are mounted to move with runners 284R and 284L respectively. For example, each backstop 287 may be mounted on a cross member 282 that is coupled to move with the corresponding runner 284. While one runner 284 is being advanced the backstops 287 associated with the other runner 284 prevent the other runner 284 from backsliding. Backstops having features of backstops 287 may be applied in any embodiments as described herein.

Backstops 287 comprise dogs that can dig into the ground to inhibit the corresponding runner 284 from moving relative to the ground in one longitudinal direction but permit the corresponding runner 284 to move freely relative to the ground in an opposing longitudinal direction. For example, when line 12 is being advanced, backstops 287 may be set to allow runners 284 to move freely along a trajectory in a forward direction away from a base 14 and backstops 287 may dig into the ground to prevent runners 284 from sliding in a reverse direction back toward the base 14. Backstops 287 may be controllable to reverse their operation (i.e. so that runners 284 can move freely in the reverse direction and are impeded from moving in the forward direction).

FIGS. 28B through 28D show an example construction for a backstop 287. In this example, backstop 287L is mounted on a cross member 282 that is slidable relative to runner 284R and is fixed relative to runner 284L. FIGS. 28D and 28E are cross sections through cross member 282 in which runner 284R cannot be seen. In FIGS. 28B through 28D the forward direction is to the right side of the figure.

Backstop 287L includes a pair of pivotally mounted dogs 287A-FOR and 287A-REV. A mechanism is provided to selectively allow no more than one of dogs 287A-FOR and 287A-REV to be deployed at one time. When dog 287A-FOR is deployed, dog 287A-FOR allows backstop 287L to move freely relative to the ground in the forward direction but digs in and resists movement of backstop 287L relative to the ground in the reverse direction. When dog 287A-REV is deployed, dog 287A-REV allows backstop 287L to move freely relative to the ground in the reverse direction but digs in and resists movement of backstop 287L relative to the ground in the forward direction. Stops 288 are provided to limit rotation of dogs 287A. Stops 288 may, for example be provided by a mounting plate formed so that dogs 287A contact a portion of the mounting plate at the ends of their ranges of pivotal motion.

A shaft 287B is rotatably mounted to a frame of backstop 287L. Projections 287C-FOR and 287C-REV (e.g. teeth or cams) are respectively located to engage cam surfaces 287D-FOR and 287D-REV carried with dogs 287A-FOR and 287A-REV respectively. Dog 287A-FOR may be deployed and tooth 287A-REV may be retracted to a stopped position (as shown in FIG. 28C) by rotating shaft 287B in a first direction (clockwise in FIG. 28C) by an actuator (not shown) until projection 287C-REV pushes on cam surface 287D-REV to lift dog 287A-REV into its stopped (non-deployed) position. Dog 287A-REV may be deployed and dog 287A-FOR may be retracted to a stopped position (as shown in FIG. 28D) by rotating shaft 287B in a second direction opposite to the first direction (counter-clockwise in FIG. 28D).

Backstops 287 optionally includes bias springs, e.g. torsion springs mounted generally coaxially with the pivot shaft of dog 287A, which act to urge dog 287A to engage the ground.

FIG. 28A shows a portion of a line 12 of apparatus 282. Cross members 282 are spaced apart along line 12. In this embodiment, cross members 12 keep runners 284 generally equally spaced apart from one another. Some cross members (labelled 282R) 282 are fixed to runner 284R and slidable relative to runner 284L and some of cross members 282 (labelled 282L) are fixed to runner 284L and slidable relative to runner 284R. For example, cross members 282R and 282L may alternate.

FIG. 28A shows a cross section of line 12 of apparatus 280 at a location of a cross member 282. Each of runners 284 is coupled to the cross member 282. In this example, runner 284L is coupled to cross member 282 by a sliding coupling 285 which permits cross member 282 to slide longitudinally relative to runner 284L. In this example, runner 284R is coupled to cross member 282 by a fixed coupling 286 which does not permit cross member 282 to slide longitudinally relative to runner 284R.

In some embodiments cross members 282 include some cross members 282X that are slidable relative to both of runners 284L and 284R. Cross members 282X may be provided to hold runners 284L and 282L in parallel relationship to one another and to carried part 281. FIG. 28E shows an example cross member 282X that is similar to cross member 282 of FIG. 28A except that cross member 282X is slidable to both of runners 284L and 284R.

Actuators distributed along line 12 are controllable to advance and retract line 12 and/or to advance or retract carried part 281 and/or to rotate carried part 281. Such actuators may be configured in various ways. In some embodiments the actuators include:
PPU actuators operable to move carried part 281 longitudinally relative to line 12;
CSU actuators operable to move runners 284R and 284L relative to one another;
PTU actuators operable to rotate carried part 281; and
steering actuators operable to cause line 12 of apparatus 280 to curve to follow a desired trajectory.

PPU actuators may be applied in a manner analogous to PPUs 25A. For example the PPU actuators may be applied to advance carried part 281 as line 12 is advanced via cyclical advancement of runners 284 and/or may be applied while retracting runners 284 to leave a distal end, or all of, carried part 281 deployed and/or while advancing runners 284 along a deployed portion of carried part 281.

CSU actuators may be applied in a manner analogous to CSUs 25B to advance line 12 of apparatus 280 by longitudinally reciprocating runners 284 relative to one another.

PTU actuators may be applied in a manner analogous to PTUs 25E to rotate carried part 281 (e.g. to oscillate nozzles on carried part 281 from side to side).

FIG. 27A shows a PPU section 290A that includes PPU actuators 291A and 291B which operate to move carried part 281 longitudinally. PPU actuators 291A extend and PPU actuators 291B retract to move carried part 281 in the distal (from the base) direction. In the illustrated embodiment PPU actuators 291A are coupled to move a block 291C longitudinally relative to one or more cross members 282. Block 291C may take alternative forms depending on the desired functionality. For example, block 291C:
may include rotational capability by a PTU actuator, e.g. a worm gear drive like that of FIG. 24;
may be rotationally fixed or rotationally free floating;
may be fixed to carried part 281, e.g. by clamp(s) as described elsewhere and shown in FIG. 24 or may be configured to selectively engage carried part 281, e.g. by an actuatable gripper as described elsewhere herein;
may be guided along runners 284 for lateral location or reaction of axial torque or may be supported by carried part 281; and/or
may be throated for lateral installation over carried part 281 or may fully surround carried part 281.

Additional PPU sections 290A may be spaced apart along the length of line 12 of apparatus 280. Actuators 291A and 291B may have the same construction but may advantageously be controlled separately, as described herein.

FIG. 27A shows a CSU section 290B that includes actuators 292A and 292B which are operable to move runners 284 longitudinally relative to one another. In this example, actuator 292A is coupled between a cross member 282R′ and a first adjacent cross member 282L. Actuator 292B is coupled between the cross member 282R′ and a second adjacent cross member 282L. The first and second adjacent cross members 282L are ahead of and behind the cross member 282R′ to which actuators 292A and 292B are coupled.

By retracting actuator 292A and extending actuator 292B, the cross member 282R′ is moved in a distal direction (e.g. away from base 14). By extending actuator 292A and retracting actuator 292B, the cross member 282R′ is moved in a proximal direction. Since the cross member 282R′ is coupled to runner 284R the effect of these operations is to move runner 282R longitudinally relative to runner 282L.

The CSU cylinder arrangement shown in section 290B of FIG. 27A advantageously provides equal advancement forces of both runners 282 in both directions, despite the difference between active areas for extending and reacting cylinders that may be used for actuators 292A and 292B.

CSU section 290B may have various alternative constructions including:
connecting actuators 292A and 292B between two cross members 292R and a common cross member 292L;
providing only one of actuators 292A and 292B (and extending and retracting the one actuator to move runners 284L and 284R longitudinally relative to one another;
providing a plurality (2, 3, 4 or more) actuators connected in series;
providing a plurality of actuators connected in a series-parallel arrangement;
as shown in FIG. 27A except spaced apart such that connections to cross member 282R′ are separate.

Plural CSU sections 290B may be spaced apart along the length of line 12 of apparatus 280. Operation of the plural CSU sections may be coordinated to actuate relative longitudinal motion of runners 284A and 284B along the deployed length of line 12 of apparatus 280.

In these embodiments and others PPU actuators 291 may also assist with the advancement of runners 284. For example, PPU actuator 291A may retract to assist the distal advancement of runner 284L and PPU actuator 291B may hold in a retracted position to anchor carried part 281 to stationary runner 284R to assist with path stability.

In some embodiments CSU sections 290B are operated to advance or retract line 12 of apparatus 280 by repeatedly reciprocating runner 284R back and forth relative to runner 284L with a stroke length within a range of which actuators 292A and 292B are capable.

FIGS. 27C and 27D illustrate an alternative CSU section 290C that is operable to move runners 284R and 284L relative to a line. CSU section 290C has an arrangement of linear actuators 292 (e.g. cylinders) that provides an extended range of motion for runners 284R and 284L. An arrangement that includes actuators 292 extends between cross members 293L and 293R which are respectively coupled to move together with runner 284L and runner 284R. When actuators 292 are extended as shown in FIG. 27D, cross members 283L and 283R are pushed apart in a direction along line 12 and when cylinders 292 are retracted as shown in FIG. 27C, cross members 283L and 283R are drawn together.

In CSU section 290C, actuators 292 are paired to deliver more force than would be available from single actuators of the same size. Using two or more actuators in parallel is optional.

In CSU section 290C a plurality of actuators 292 (in this example, four actuators 292—other examples may have more or fewer series connected actuators 292) are connected in series, thereby facilitating an extended stroke length. In order to keep series-coupled actuators 292 aligned, it is desirable to constrain the couplings between series-connected actuators 292 to move axially relative to line 12. In the illustrated embodiment, this constraint is achieved by providing a sliding cross member 283X at each coupling between series-connected actuators 292. The constraint could also be achieved in other ways such as providing coupling that is guided by carried part 281 or a separate guide attached to line 12.

In the example embodiment illustrated in FIGS. 27C to 27D one or more actuators 292A are connected between cross member 283L and a first sliding cross member 283X-1 that is mounted to slide relative to both of runners 284A and 284B and to carried part 281. One or more actuators 292B are connected between cross member 283X-1 and a second sliding cross member 283X-2 that is mounted to slide relative to both of runners 284A and 284B and to carried part 281. One or more actuators 292C are connected between cross member 283X-2 and a third sliding cross member 283X-3 that is mounted to slide relative to both of runners 284A and 284B and to carried part 281. One or more actuators 292D are connected between cross member 283X-3 and cross member 283R. This arrangement provides a stroke length that is four times longer than the stroke length of any individual one of actuators 292.

In a line that includes a conduit or other carried part and laterally spaced apart parallel runners as ground contacting portions there are a range of options for advancing or retracting the carried part. These include: coupling the carried part to move together with the ground contacting portion(s) on one side of the line; providing separate actuators for moving the carried part longitudinally relative to the ground contacting portions (in some embodiments these actuators may be operated to keep the carried part stationary when the ground contacting portions are moving and operated to move the carried part when all of the ground contacting portions are stationary); coupling the carried part to move together with a component that moves at a reduced speed when either of the ground contacting portions are being moved (e.g. coupling the carried part to move together with a sliding cross member such as cross member 283X-2.

FIG. 27B shows an example steering section 290C. In this example, steering section 290C comprises steering actuators 293A and 293B that are respectively on left and right sides of a longitudinal centerline of apparatus 280. Actuators 293A and 293B respectively comprise tendons 293C and 293D. Actuator 293A extends along steering section 290C between corresponding connecting points 293E and 293F. Actuator 293B extends along steering section 290C between corresponding connecting points 293G and 293H.

Retracting steering actuator 293A while extending or relaxing steering actuator 293B causes steering section 290C to curve to the left while extending or relaxing steering actuator 293A and retracting steering actuator 293B causes steering section 290C to curve to the right. Actuators 293A and 293B may, for example provide screw actuators or other actuators that are operable to provide fine control over the curvature of steering section 290C.

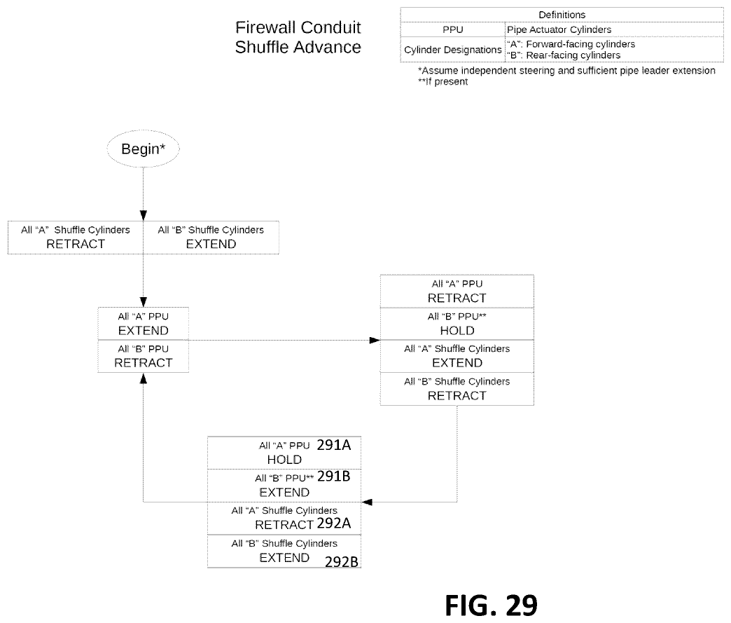

FIG. 29 shows an example control scheme for advancing line 12 of apparatus 280. The scheme of FIG. 29 may, for example, be applied to control apparatus 280 by a control system that is connected by suitable control paths to control actuators of apparatus 280. In some embodiments the control system comprises a programmed data processor. In FIG. 28A: “A” PPU cylinders means actuators 291A, “B” PPU cylinders means actuators 291B, “A” shuffle cylinders means actuators 292A, and “B” shuffle cylinders means actuators 292B.

The spacing between runners 284 is a design choice that may be based on a tradeoff between a wider spacing which helps to make line 12 more stable against rolling over and a narrower spacing which allows line 12 to fit between more closely spaced obstacles and also may permit a greater net curvature of line 12.

When apparatus 280 is deployed along a curved path, the distance measured along runners 284L and 284R can differ due to the spacing between runners 284L and 284R. The difference between the lengths measured along runner 284R and 284L along a portion of or all of the path on which apparatus 280 is deployed may be described by the equation A=Rθ, where A is the length difference, R is the spacing between runners 284L and 284R, and θ is the net angle of curvature in radians between endpoints of the path or portion of the path.

For a sinuous or serpentine path, arc length differences due to curvatures to the left cancel arc length differences due to curvatures to the right. Therefore, θ may be zero over a portion of the path that is sinuous. A depends only on net curvature.

If actuators 292A and 292B are coupled to runners 284L and 284R at fixed locations then the available stroke (relative motion of runners 284R and 284L) is reduced as A increases. The actuators that provide relative motion of runners 284R and 284L may be designed to provide a stroke length long enough to accommodate some reduction in stroke due to net curvature of line 12. In some embodiments apparatus 280 is configured to allow for a net curvature of the deployed part of line 12 that is at least 180 degrees or at least 270 degrees (1.5π radians) without running out of stroke. A net curvature of at least 270 degrees would allow line 12 of apparatus 280 to substantially encircle a region of interest (e.g. a wildfire, town, etc.).

In apparatus 280 it is not mandatory that runners 284 are continuous. In some embodiments one or both of runners 284 may include breaks gaps or discontinuities located along the length of line 12 of apparatus 280. In such embodiments path length differences accumulate only in the parts of 284R and 284L between the breaks.

The skilled person will understand from this disclosure that the path of a line such as apparatus 280 that includes a pair of runners may be stabilized according to the same principle as described above in relation to lines that are of the general type illustrated in FIG. 2 so that once a leading (distal) portion of line 12 has been deployed along a path, subsequent parts of the line will tend to follow the same path. In apparatus 280, as line 12 is advanced one runner 284 is kept static and may be fixed relative to the ground (e.g. by backstops as well as friction). Because the static runner is prevented from moving axially, changes in the curvature of any curves in the static runner 284 are resisted. The advancing runner is therefore guided by the static runner to follow the path.

It can be seen from the above that in line 12 of apparatus 180, each of runners 284L and 284R is a flexible member that extends longitudinally and follows the path as the line is deployed. Each of runners 284L and 284R also constitutes a ground contacting portion. Further, when runner 284L is being advanced runner 284R is stationary with respect to the ground and vice versa. In each phase of movement the stationary runner is anchored to the ground (e.g. by friction and/or engagement of the corresponding backstops 287) and the stationary runner serves as a guide which resists deviation of the runner that is being moved from the path on which line 12 is deployed.

In apparatus 280, CSU sections constitute driver units which comprise actuators 292 that are operable to move a corresponding one of the ground contacting portions (e.g. runner 284L or 284R) longitudinally along the line relative to at least one other one of the ground contacting portions (e.g. runner 284R or runner 284L).

Apparatus 280 may be deployed from a base 14 as described above. The base 14 may be operated to stabilize a path of a deployed part of a line 12 by selectively holding in place the runner 284 that is the stationary runner at any phase of deployment or retraction of the line 12. This helps to resist any departure from the established path of the deployed part of line 12 since the length of the stationary runner 284 between the base 14 and the closest location at which the stationary runner is fixed to the ground (e.g. by a backstop) is fixed. The proximal portion of the stationary runner 284 thereby resists being moved off of the established path and acts as a guide while the other runner 284 is moved.

In some embodiments a base 14 for use with a line 12 having a construction which includes side by side ground contacting portions includes mechanisms for selectively holding either one of the ground contacting portions. The mechanisms may, for example, comprise first and second parallel conveyors that are respectively configured to engage a corresponding one of the ground contacting portions. For example, each of the conveyors may include members that positively engage cross members (e.g., 283L, 283R) that are to fixed to the corresponding ground contacting portion. Either ground contacting portion may be held in place on the base 14 by locking the corresponding conveyor, The other conveyor may be driven or allowed to rotate freely. Each of the conveyors may, for example comprise a chain loop with protrusions that positively engage the cross members attached to the corresponding ground contacting portion.

Apparatus 280 may be used for any of the applications described herein. Apparatus 280 or any base that may be used in conjunction with apparatus 280 may be modified to include features of any of the other embodiments described herein.

### Example Conveyor Type Base Equipment

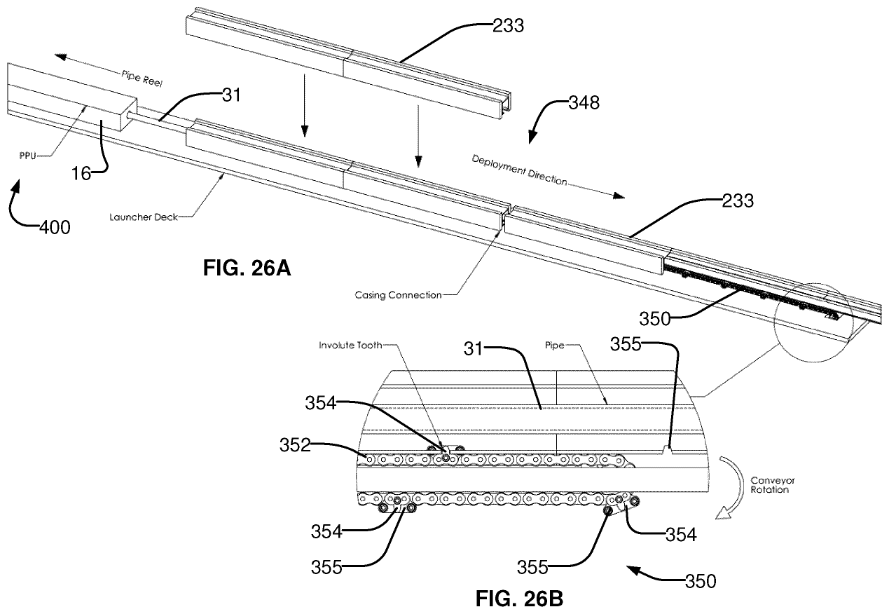

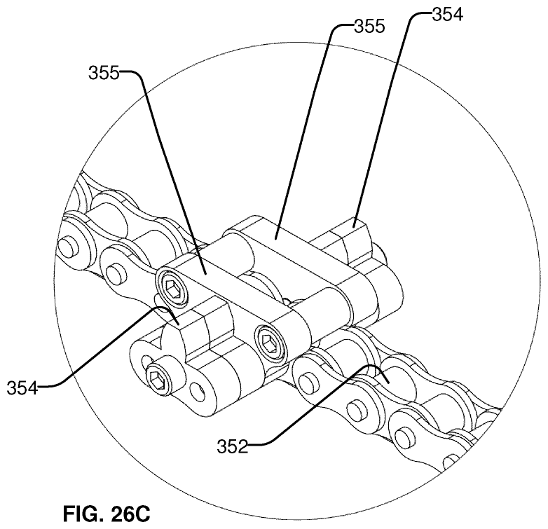

FIGS. 26A and 26B show an example casing management unit 348. Casing management unit 348 is operable to mate segments having a U configuration (like segments 233 or remote actuator units 325, for example) to a carried member 31 such as a pipe or other conduit. Casing management unit 348 includes a casing launch conveyor which extends along a path of carried part 31. In the illustrated embodiment, casing launch conveyor 350 is long enough to accommodate a plurality of segments 233.

Casing launch conveyor 350 comprises a drive for advancing segments 233. In the embodiment of FIGS. 26A and 26B the drive comprises a circulating chain 352 which includes spaced apart drive lugs 354. Drive lugs 354 are configured to engage corresponding recesses 355 in segments 233 or other components of segmented part 30 which are being carried by casing launch conveyor 350. Drive lugs 354 may, for example, have involute tooth profiles.

FIG. 26C is an expanded view of a portion of chain 352 which carries an example drive lug 354. In the illustrated embodiment, drive lugs 354 are located on opposing sides of a pair of guide plates 355. Plates 355 engage longitudinal grooves in segments 233. For example plates 355 may protrude into throats of segments 233. This engagement aligns segments 233 to receive drive lugs 354. In some embodiments a hold down (not shown) is provided to hold segments 233 in engagement with drive lugs 354.

In casing management unit 348, segments 233 or other components with U configurations may be placed onto carried part 31 so that carried part 31 is received into channels of the segments 233 or other components. This can occur while carried part 31 is being advanced. Segments 233 and other components of segmented part 30 may be coupled together end-to end at casing management unit 348. The coupling may, for example, be made as segments 233 are brought onto casing launch conveyor 350 or while they are being carried by casing launch conveyor 350.

In some embodiments in which a line 12 has a side-by-side construction as described herein, two casing launch conveyors 350 may be arranged side-by-side with drive lugs 354 configured to engage cross members 282L and 282R.

Advantageously, casing launch conveyor 350 allows components of segmented part 30 to be added to while segmented part 30 undergoes unidirectional and semi continuous advancement (advancement may start and stop in an advance cycle as described elsewhere herein). Casing launch conveyor 350 may be long enough to simultaneously support plural casing segments. In some embodiments, stands made up of two, three or more pre-coupled components of segmented part 30 (e.g. segments 233) may be added to segmented part 30 using casing launch conveyor 350.

In some embodiments, actuators for launching casing and actuator units (e.g. casing launch conveyor 350) operate to advance segmented part 30 intermittently with individual advance strokes that are approximately equal in length to strokes of CSUs 25B. Some embodiments include an encoder arranged to monitor casing launch conveyor 350 (e.g. the encoder may be mounted on a conveyor drive or idler shaft of conveyor 350). The encoder may provide position control feedback to a controller.

Casing management unit 348 may be operated in reverse to retract a deployed line 12 or a segmented part 30 of a deployed line 12.

Casing management unit 348 may be varied in various ways. For example, casing launch conveyer 350 may employ a belt or belts for advancing components of segmented part 30 in place of or in addition to a chain.

Variations are possible in the general approach to engaging components of segmented part 30 with carried part 31. For example, a base 14 may be constructed to include an extended deck or other storage area on which a plurality of components of segmented part 30 may be pre-assembled onto carried part 31. Those components may, for example, attach around carried part 31 using a clamshell configuration (e.g. as described for segments 33) or a U shaped configuration (e.g. as described for segments 233) or a configuration having a channel through which a leading end of carried part 31 is threaded through or a combination of the above.

In some embodiments, pre-assembled parts of line 12 which include one or more segments of segmented part 30 may be stored in straight or curved lines, on large reels etc. In some embodiments, a span 32 of segmented part 30 is pre-assembled.

### Pre-Staging of Components

In some embodiments, actuator units and/or other components of segmented part 30 (e.g. PPU 25A, CSU 25B and/or PTU 25E) are pre-staged and mated to carried part 31 on an extended launch conveyer deck. FIG. 26A shows apparatus that includes an extended deck area 400 located upstream from conveyor 350. Various components (e.g. a PPU 16 is shown) may be pre-staged on deck area 400.

The pre-staged components may be brought forward to be connected in line with segmented part 30 as needed. Carried part 31 may be fed through channels of the pre-staged actuator units. This arrangement can allow use of simpler actuator units (e.g. actuator units which are not designed to allow assembly onto a section of carried part 31 away from the ends of carried part 31) and/or reduce the time required to add actuator units into segmented part 30 of a line being deployed. The supply of pre-staged components may be refreshed each time a new section (e.g. a new reel of pipe) is added to carried part 31.

In some embodiments lines as described herein may be applied to deliver equipment or other physical items to remote locations. For example, an item placed in a conduit of a line 12 may be delivered through the conduit to an end of line 12 by propelling the item using a compressed fluid. The item may, for example, be propelled inside or in front of or trailing behind a plug that is slidably inserted into the conduit (in some applications such plugs are called “pigs”).

This principle may be used to deploy a line 12 that includes two or more branches using the systems as described herein. One approach to doing so is to deploy a line as described in any of the above embodiments along a path desired for a first branch. A branch conduit which will provide the first branch may then be delivered through the line 12 (e.g. through a conduit of carried part 31). The branch conduit is smaller in diameter than the conduit of line 12. The branch conduit may be pushed into the conduit of line 12 (for example using a PPU at base 14). Subsequently the branch conduit may be propelled along the conduit of line 12 using a pig until the end of the branch conduit is at an end of the first branch. Line 12 may then be retracted to a branch point and extended along a path desired for a second branch. A second branch conduit may be deployed along the second branch as described above. This may be repeated for any desired number of branches. Line 12 may then be retracted to the branch location where a crew may couple the branches to a conduit of line 12.

It is not mandatory that segments of segmented part 30 be connected to one another. For example, in an alternative construction, segmented part 30 comprises PPUs as described herein that are spaced apart from one another along carried part 31. Carried part 31 may be advanced by simultaneously extending all of the PPUs. The PPUs may then be retracted one at a time or a few at a time or in a sequence such that PPUs that have already been retracted and/or PPUs that are not currently being retracted hold carried part 31 in place while other PPUs are retracted. The PPUs may be powered, for example, by batteries, one or more umbilicals or by way of carried part 31. In some embodiments the PPUs are powered by compressed fluid delivered by carried part 31 and accessed through ports at the locations of the PPUs.

Three non-limiting example configurations of systems as described herein are:
1. Spray-thru-casing with external water distribution (e.g. irrigation heads, water cannons or the like), no pipe rotation capability, PPU pipe clamps (not grippers), alternating casing advance, steering only by casing articulation.
2. Spray-thru-casing with nozzles in the pipe, PPU pipe clamps (not grippers), alternating casing advance, no casing withdrawal capability, no leader steering unit, limited pipe steering capability, steering primarily by casing articulation, pipe swivel included.
3. Casing withdrawal capable, for example to deploy & leave a carried member, such as a pipe, in place, with leader steering unit, pipe steering capability after sufficient deployed length, can arbitrarily change the leader pipe protrusion length from the casing, grippers in PPUs, alternating or multi-wave progressive casing advance, optionally add a pipe rotator and a pipe swivel at the base when you take the casing & deployment system away.

In addition to application in fire mitigation and prevention, the present technology may be applied for applications such as:
deploying cables under bodies of water such as oceans, lakes and rivers;
deploying surface or buried utilities;
deploying conduits carrying water, power, and/or communications signals over terrain that is sensitive and/or relatively inaccessible;
deploying from a single point any semi-flexible member over a surface;
deploying a track which facilitates movement of cars, carriages, machinery or the like along line 12;
etc.

### Example Control System[GNM1]

Controls for any of the systems herein may be simpler or more complicated. Simple controls may, for example comprise manually operable valves or switches that control operation of actuators of a line 12. As described herein, in many embodiments, a method for advancing or retracting a line 12 involves applying a repeating sequence of a few steps. A certain set of actuators is operated in each step. Manual controls may be configured so that each step can be executed by operating a single control. For example, controls for apparatus 280 may include a control which, when actuated, advances runner 284L relative to runner 284L and another control which, when actuated advances runner 284L relative to runner 284R. A single lever or switch could be supplied to selectively actuate both of these controls (e.g. by moving the lever or switch in one direction to advance runner 284L relative to runner 284L and in another direction to advance runner 284L relative to runner 284R.

Manual controls may, for example be provided on a base from which the line 12 is extended and/or on a remote control unit which is connected by a cable or wireless connection to operate valves or other mechanisms to achieve the desired functioning of the line 12 being controlled. In some embodiments a display is provided at a location such that a person controlling line 12 by the controls can see images (e.g. from cameras 42 or other imaging devices) possibly together with other information such as a map showing the path taken by a deployed part of the line 12 (optionally together with an indication of a desired path for the line 12) and/or information from other sensors associated with line 12. A person may use information provided on the display to steer and otherwise control the operation of line 12.

Manual controls may be provided for controlling any functions of a line 12. For example, manual controls may be provided to control any or all of:
actuators that are operable move ground contacting parts to advance or retract the line 12;
configuration of backstops;
configuration(s) of one or more steering units;
actuators that are operable to rotate a conduit or portion of a conduit;
valves that enable, disable and/or change a spray pattern of nozzles;
etc.

In some embodiments, control of one or more functions of a line 12 is automated or semi-operated by provision of a suitable controller. A controller may be simple or more complicated. For example, a very simple controller may comprise a mechanical, electrical or electromechanical timer that, when actuated controls actuators of the line 12 to applying a repeating sequence of a few steps at a desired rate. The steps may, for example:
cause line 12 to advance or retract;
oscillate all or a portion of a conduit through a selected angular range; or
reciprocate a conduit axially through a desired range of motion.

In some embodiments a system as described herein includes a more advanced control system which may provide greater automation of the operation of a line 12. For example, such a system may include image processing components that are configured to detect obstacles in the way of line 12 and a controller that is configured to automatically control advance of the line 12, to select a path that avoids the obstacles, and to control one or more steering units of the line 12 to follow the selected path.

In some embodiments (e.g. apparatus 280) which include transversely spaced apart ground contacting portions (e.g. runners 284) a controller is configured to calculate a net curvature of all or a portion of line 12 and to limit the stroke of the actuators that move the ground contacting portions relative to one another based on the calculated net curvature.

In some embodiments a controller is configured to coordinate operation of a line 12 for a particular application. For example, in a fire mitigation application the controller may be configured to control valves to release fluid from selected nozzles, control movement of the conduit and/or the line to move the spray nozzles axially and/or with rotational movements in order to achieve a desired distribution of fluid. The controller may include different canned cycles such as, for example: a cycle for distributing fluid to soak at a lower level (e.g. to soak shrubs and other lower level vegetation); a cycle to distribute fluid at a higher level (e.g. to soak taller trees); a cycle to maximize humidity increase local to line 12; a cycle to de-energize fires; etc.

Canned cycles may include user settable parameters that may be used to adjust the canned cycles to account for local conditions. The controller may be configured to automatically control the line and/or pumps to maintain desired pressure distribution in a conduit. The controller may be configured to automatically control the line and/or pumps to adjust the operation of the line in response to characteristics of a fire.

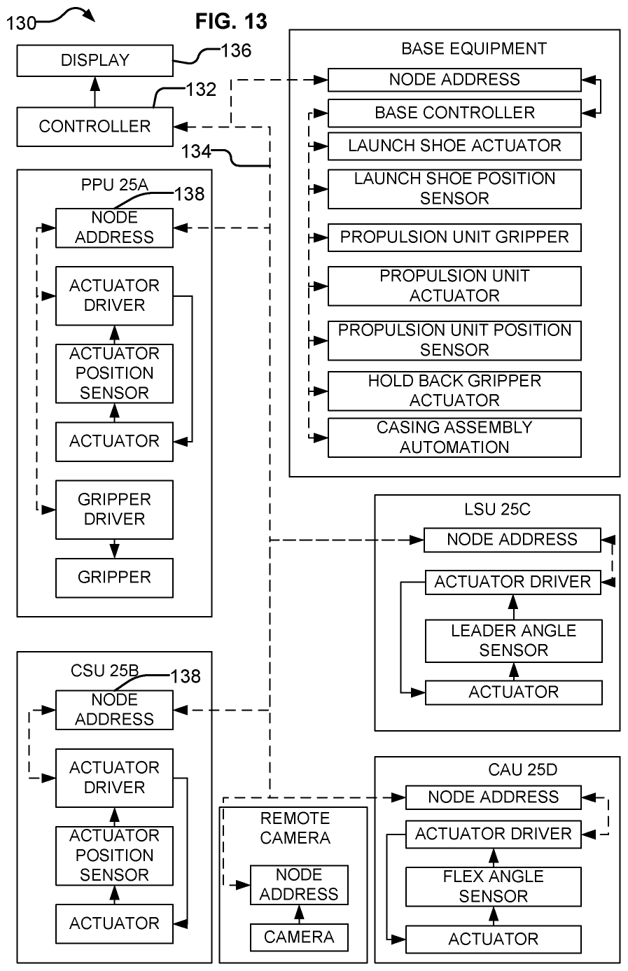

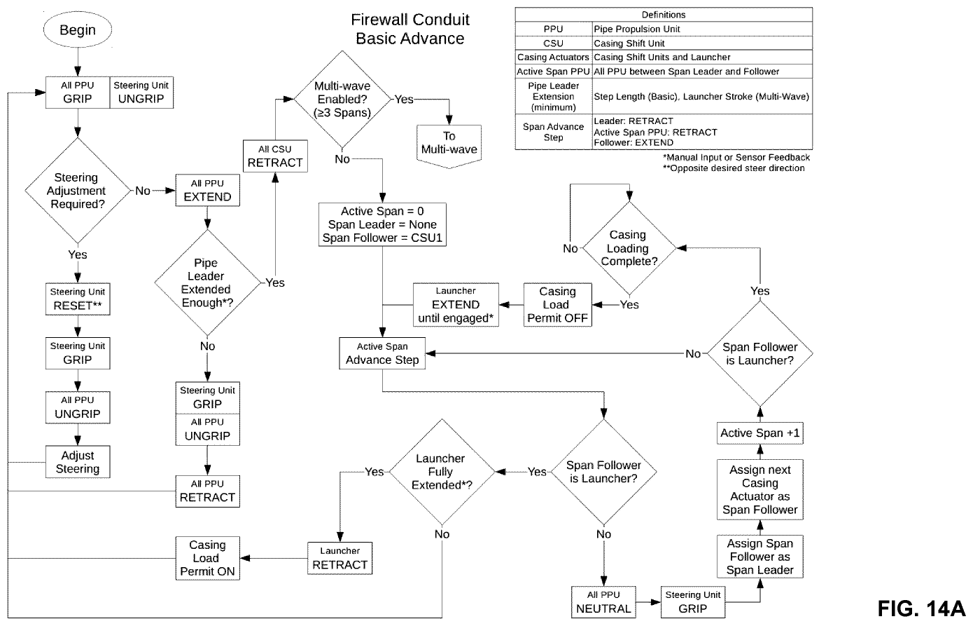

FIG. 13 is a block diagram showing an example control system 130 that may be used to control a system 10 as described herein. Control system 130 includes a controller 132 that is connected to communicate with all parts of system 10 by a data bus 134. Controller 132 is connected to a display 136. An operator may view on display 136 one or more of:
a) video or still images from remote cameras 42;
b) status information regarding system 10;
c) data from remote sensors on line 12 such as temperature sensors, humidity sensors, air quality sensors.

In the embodiment illustrated in FIG. 13, each remote actuator unit 25 comprises a node of data bus 134 that has one or more unique addresses. System controller 132 may send commands to individual remote actuator units 25 using the corresponding unique addresses. The commands may, for example control line 12 to advance or retract. Controller 132 may be configured and connected to control all actuators of a line 12 to perform any of the methods described herein.

Control systems for a system 10 may be implemented in any of a wide variety of ways. For example commercially available process automation controllers may be connected and programmed to coordinate the operation of actuators of system 10 to advance or retract a segmented part or a span of a segmented part, steer a conduit, advance or retract an carried part etc.

In general, control systems may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit in system 10 may implement methods as described herein by executing software instructions in a program memory accessible to the processors.

### Example Application for Fluid Delivery

After a line 12 has been deployed, for example as described in any of the examples provided above, a pump 19 may be operated to deliver a fluid such as water or water mixed with fire retardant or fire retardant through line 12 to nozzles 20. Nozzles 20 may be located all along carried part 31 or in a desired section of sections of carried part 31 such as a portion extending a desired distance (e.g. 500 m or 1 km) from the distal end of carried part 31).

Fluid may be supplied to a conduit in carried part 32 from a high capacity high pressure mobile pumping unit. For example, pumps used for fracturing subterranean formations in developing gas and oil wells (“frac pumps”) are commercially available and may be used to supply fluid to carried part 32. In some embodiments the pumping unit comprises one or more relatively low pressure pumps that feed fluid to one or more high pressure pumps. Such pumps in suitable combinations have example capacities exceeding 1000 GPM @ 5000 psi. In some embodiments fluid is delivered to a conduit of line 12 at a pressure of at least 1000 psi or at least 2000 psi or at least 2500 psi or at least 3000 psi or at least 5000 psi. In some embodiments fluid is delivered to a conduit of line 12 at a rate of at least 200 GPM (about 760 liters/min) or at least 500 GPM (about 1900 liters/min) or at least 900 GPM (about 3400 liters/min).

The pumping unit may be sized to take into account pressure drop along the length of the conduit. For example, with a carried part 31 comprising a 4 inch diameter (nominal) tubular one would expect a pressure drop in the range of about 200-500 psi (about 1400 to 3500 kPa) per km length at a flow rate of 1000 GPM (about 3750 liters per minute).

In some embodiments carried part 31 includes one or more booster pumps coupled inline with a conduit. Such pumps may boost the pressure of fluid carried by carried part 31. The booster pumps may for example be electric submersible pumps (ESPs) as commonly used downhole for petroleum production. An ESP may be installed inside carried part 31 and powered by umbilical cables inside carried part 31.

### Other Applications

As mentioned above, the present technology may be applied in any of a wide variety of fields where it could be beneficial to extend an elongated line to deliver services or materials, deploy sensors of a wide variety of types etc. Apparatus and methods as described herein may be customized for any particular application. The customizations may include scaling the size of the apparatus up (e.g. to increase capacity) or down (e.g. to fit in small spaces). The customizations may also include modifications to suit the application. For example, for military applications a line may be configured to include certain types of sensors and/or to carry weapons systems that may be triggered by way of control signals delivered by signal conductors of the line. As another example, a line may be configured to carry a rail or track which supports travel of a cart, tram, car or the like. Many other examples are possible.

### Example Variations

Many variations are possible in the practice of the present technology. For example, any embodiment described herein that includes a fluid conduit (e.g. a pipe for carrying water) may include one or more drain valves to drain fluid out of the conduit. For example, after a system as described herein has been used to establish a fire corridor a drain valve at a distal end of the conduit may be opened to drain remaining fluid out of the conduit before the conduit is withdrawn. One or more other drain valves may be spaced apart along the conduit.

In some embodiments, one or more taps are provided along the length of line 12. The taps may be used, for example, to:
deliver water, fire retardant or the like to a pickup point to decrease travel time for helicopters in wildfire fighting applications;
provide connection points for hoses for traditional firefighting; and/or
provide locations for connecting water cannons.

The concept of a conduit or other carried part that can be advanced from a base or other starting location along a desired trajectory without the need for personnel to be deployed along the trajectory may be achieved by providing a carried part with driver units that are spaced along the carried part. The driver units may comprise wheels, tracks, walking feet or other ground contacting portions that are operable to advance the drive units to deploy the carried part along a desired trajectory. Power for the drive units may be provided by way of the carried part as described herein. In some embodiments some or all of the drive units are controlled to keep the carried part on the desired trajectory by steering (e.g. with steering members such as wheels or skis and/or by differential steering).

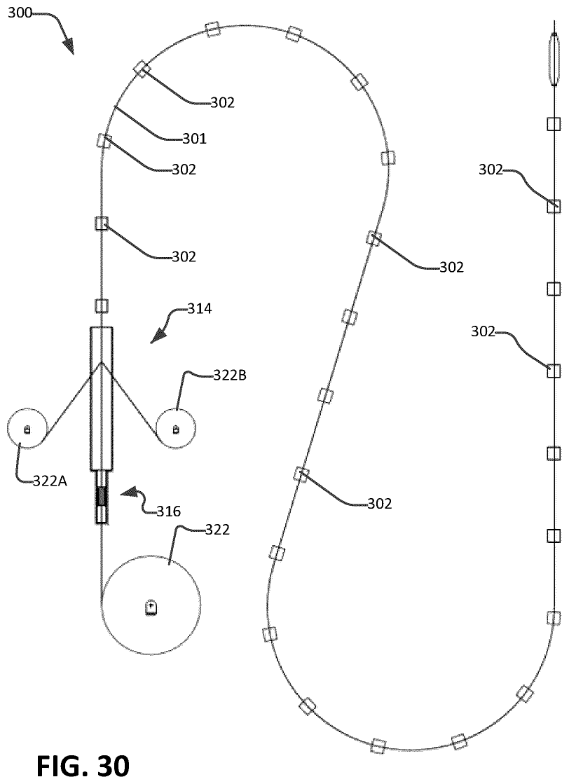

FIG. 30 shows an example system 300 that includes a line 301 that may be deployed along a path. Line 301 is long and slender and has driver units 302 distributed along it. In this example, drive units 302 are regularly spaced apart such that as the deployed length of line 301 is increased the number of deployed drive units 302 is also increased in proportion to the deployed length of line 301.

Driver units 302 may have any construction that makes them each operable to advance the portion of line 301 in which they are located (including any of the examples described herein). For example, driver units 302 may each comprise driven tracks, wheels, walking feet, or the like.

FIG. 30 includes an optional base 314 that includes a reel 322 from which line 301 or a conduit or other elongated member that forms part of line 301 may be drawn as line 301 is advanced. Base 314 also includes reels 322A and 322B from which cables, hydraulic hoses, pneumatic hoses or the like that are deployed with line 301 may be fed as line 301 is advanced. The cables, hydraulic hoses, pneumatic hoses or the like may comprise paths for controlling and powering drive units 302 and other parts of system 300 and/or signal carriers.

System 300 also includes an optional propulsion unit that advances line 301 away from base 314.

Systems according to any of the embodiments described herein may be provided in the form of assemblies that are of transportable length (e.g. up to about 60 or 80 feet) that can be coupled end to end to form a line. For example, runner and cross member assemblies of the general type illustrated in FIGS. 27A to 27D may be supplied in coupled sections of transportable length that may be coupled together at a starting point.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A fire mitigation system deployable from a starting location to extend along a path, the system comprising:
a slender line comprising at least one fluid conduit, the line elongated in a longitudinal direction and slender in a transverse direction;
a plurality of fluid distribution devices spaced apart along the fluid conduit;
a plurality of driver units distributed along a length of the line, each of the driver units operable to move a respective portion of the line relative to the ground in a direction that is substantially along the path by actuating one or more ground contacting portions of the line; and
controls operable to control the driver units to move the line along the path by actuating the respective ground contacting portions of the line.

2. A system according to claim 1, the line including a steering unit operable to flex a respective local portion of the line laterally and/or in an up and down direction.

3. (canceled)

4. A system according to claim 2, wherein the steering unit is a lead steer unit disposed on an end of the line distal to the starting location, the lead steer unit operable to direct the distal end of the line along the path as the driver units advance the line.

5.-7. (canceled)

8. A system according to claim 1 wherein:
the line includes at least one flexible non-extensible member that extends longitudinally and follows the path as the line is deployed;
the line comprises a plurality of the ground contacting portions, each of the ground contacting portions being coupled to move longitudinally along a corresponding one of the at least one flexible-non-extensible member; and
each of the driver units comprises at least one actuator operable to move a corresponding one of the ground contacting portions longitudinally along the line relative to at least one other one of the ground contacting portions.

9. (canceled)

10. A system according to claim 8 wherein the at least one flexible member is provided by one of the ground contacting portions.

11. A system according to claim 8 wherein the driver units and ground contacting portions are arranged so that the driver units are operable to:
hold one or more of the ground contacting portions stationary relative to the ground and one of the at least one flexible member, thereby resisting deviation from the path by the one of the at least one flexible member; and
move one or more other ones of the ground contacting portions longitudinally along the line,
wherein the one or more other ones of the ground contacting portions are guided to follow the path by the one of the at least one flexible member.

12. A system according to claim 11, wherein the controls are configured to operate the driver units in a sequence, the sequence including steps of:
operating the driver units to hold a first set of one or more of the ground contacting portions stationary relative to the ground and to hold the conduit stationary relative to the first set of ground contacting portions while moving a second set of one or more of the ground contacting portions along the line.

13.-16. (canceled)

17. A system according to claim 8 wherein the plurality of ground contacting portions are arranged in a parallel side-by-side relationship along the line, each ground contacting portion movable longitudinally relative to a respective laterally adjacent one of the ground contacting portions.

18. A system according to claim 17 wherein each of the ground contacting portions serves as the corresponding at least one flexible member for the laterally adjacent one of the ground contacting portions.

19. A system according to claim 18 wherein the driver units are operable to, in alternation:
move a first one of the laterally adjacent ground contacting portions in an axial direction while holding a second one of the laterally adjacent ground contacting portions stationary; and
move the second one of the laterally adjacent ground contacting portions in the axial direction while holding the first one of the laterally adjacent ground contacting portions stationary.

20. A system according to claim 17 comprising a base positionable at the starting location from which the line is extendable, the base comprising a holding mechanism operable to selectively hold a first one of the parallel side-by-side ground contacting portions against axial movement or to hold a second one of the parallel side-by-side ground contacting portions that is laterally adjacent to the first one of the parallel side-by-side ground contacting portions against axial movement.

21. (canceled)

22. A system according to claim 20 wherein the base includes a launcher operable to advance or retract the proximal end of the line along the path.

23. A system according to claim 22 wherein the launcher comprises a first conveyor configured to engage the first one of the parallel side-by-side ground contacting portions and a second conveyor configured to engage the second one of the parallel side-by-side ground contacting portions as the line is extended or retracted.

24. A system according to claim 20 wherein the system is configured to operate the holding mechanism to hold the first one of the parallel side-by-side ground contacting portions against axial movement while the driver units are moving the second one of the parallel side-by-side ground contacting portions and to operate the holding mechanism to hold the second one of the parallel side-by-side ground contacting portions against axial movement while the driver units are moving the first one of the parallel side-by-side ground contacting portions.

25. (canceled)

26. A system according to claim 17 wherein each driver unit includes a remote actuator operable to longitudinally move at least one of the ground contacting portions relative to the respective laterally adjacent one of the ground contacting portions.

27. (canceled)

28. A system according to claim 17 wherein the line comprises a plurality of first cross members fixedly coupled to the first ground contacting portion and slidingly coupled to the second ground contacting portion, and a plurality of second cross members fixedly coupled to the second ground contacting portion and slidingly coupled to the first ground contacting portion.

29. (canceled)

30. A system according to claim 26 including one or more cross members, each of the cross members slidingly coupled to each of the first and second ground contacting portions.

31.-33. (canceled)

34. A system according to claim 26 wherein each of the driver units comprises a plurality of remote actuator units that are pivotally connected longitudinally in series and are coupled between attachment points that are fixed relative to the first and second ground contacting portions, wherein the pivotal connections between the plurality of remote actuator units are slidingly guided relative to the line.

35.-38. (canceled)

39. A system according to claim 1 comprising a controller configured to operate the driver units in a sequence comprising a series of steps, wherein, in each of the steps one or more ground contacting portions is moved longitudinally relative to the ground by one or more of the driver units while one or more others of the ground contacting portions is held stationary relative to the ground.

40.-43. (canceled)

44. A system according to claim 1 comprising a controller configured to control movement of the fluid conduit and/or the line to move the fluid distribution devices axially and/or with rotational movements while controlling valves to release fluid from selected ones of the fluid distribution devices.

45.-52. (canceled)

53. A system according to claim 1 wherein the fluid conduit is supplied from a reel at the starting location.

54.-58. (canceled)

59. A system according to claim 1 comprising a plurality of backstop mechanisms spaced apart along the line wherein the backstop mechanisms are each operable to resist motion of an associated ground contacting portion in a first longitudinal direction and permit movement of the associated ground contacting portion in in a second longitudinal direction opposite to the first longitudinal direction.

60. A system according to claim 59 wherein the backstop mechanisms are configurable in a first mode which resists motion of an associated ground contacting portion in a reverse direction and permits free movement of the associated ground contacting portion in a forward direction and a second mode which resists motion of the associated ground contacting portion in the forward direction and permits free movement of the associated ground contacting portion in the reverse direction.

61.-68. (canceled)

69. A system according to claim 1 wherein the line includes one or more pipe torsion units distributed along the length of the line and operable to rotate a portion of the fluid conduit about a longitudinal axis o.

70.-71. (canceled)

72. A system according to claim 1, comprising a plurality of valves, each of the valves operable to block or allow flow of a fluid to a respective one or more of the plurality of spaced apart fluid distribution devices.

73. A system according to claim 72 wherein the controls are operable to control the valves to vary which ones of the fluid distribution devices allow flow of the fluid at any given time.

74. A system according to claim 72 wherein the controls comprise an automated controller configured to control the valves to deliver fluid to each of plural groups of the fluid distribution devices intermittently.

75. A system according to claim 74 comprising one or more pressure sensors connected to measure a fluid pressure within the conduit wherein the automated controller is configured to control the valves based in part on feedback from the one or more pressure sensors to deliver a desired volume of fluid at a desired pressure by one or more of the fluid distribution devices.

76.-85. (canceled)

86. A system according to claim 1 wherein the line includes a plurality of fire detection sensor units distributed along the line, each fire detection sensor unit comprising one or more of a camera, an infrared camera, and a thermal sensor.

87.-139. (canceled)

140. A system according to claim 1 wherein:
the plurality of ground contacting portions comprise first and second ground contacting portions arranged to extend along at least a portion of the line in a parallel side-by-side relationship, the first and second ground contacting portions being movable longitudinally relative to one another; and
the system comprises a plurality of backstop mechanisms spaced apart along each of the first and second ground contacting portions, the backstop mechanisms each operable to engage with the ground to resist motion of a respective one of the first and second ground contacting portions in at least a reverse longitudinal direction.

141. A system according to claim 140 wherein the backstop mechanisms each comprise a member that carries a ground engaging element and is axially actuated to move between an engaged position and a disengaged position.

142. A system according to claim 1 comprising one or more actuators operable to set orientations of one or more of the fluid distribution devices.

143. A system according to claim 30 wherein the remote actuators comprise:
at least one linear actuator coupled between the one of the ground contacting portions and one of the cross members; and
at least one linear actuator coupled between the respective laterally adjacent one of the ground contacting portions and the one of the cross members.
